(19) United States
(12) Patent Application Publication
(10) Pub. No.: US 2011/0320375 A1
(43) Pub. Date: Dec. 29, 2011

(54) Sports Matchmaker Systems

(76) Inventors: Kenneth L. Zrike, Sedona, AZ (US); Christopher A. Zrike, Sedona, AZ (US)

(21) Appl. No.: 13/207,242

(22) Filed: Aug. 10, 2011

Related U.S. Application Data
(63) Continuation-in-part of application No. 12/540,313, filed on Aug. 12, 2009.
Application No. 12/540,313 is a continuation-in-part of application No. 12/047,299, filed on Mar. 12, 2008.
Application No. 12/047,299 is a continuation-in-part of application No. 11/463,574, filed on Aug. 9, 2006.
(60) Provisional application No. 61/372,833, filed on Aug. 11, 2010.
(60) Provisional application No. 61/088,650, filed on Aug. 13, 2008.
(60) Provisional application No. 60/894,668, filed on Mar. 13, 2007.
(60) Provisional application No. 60/942,432, filed on Jun. 6, 2007.
(60) Provisional application No. 60/707,889, filed on Aug. 12, 2005.
(60) Provisional application No. 60/775,920, filed on Feb. 22, 2006.

(51) Int. Cl. G06Q 99/00

(52) U.S. Cl. 705/319

(57) ABSTRACT

The Sports Matchmaker System provides an improved method for arranging sporting events and non-sporting events between unacquainted people. It provides a system for matching persons publicly offering to participate in particular sporting or social events with other persons desiring to participate in similar sporting or social events. The system also provides various means for communicating between the offering party and the accepting party to complete the event. The system also provides methods for arranging event venues for sporting and social events.

### CROSS-REFERENCE TO RELATED APPLICATION

The present application is related to and claims priority to prior provisional patent application Ser. No. 61/372,833, filed Aug. 11, 2010, entitled “SPORTS MATCHMAKER SYSTEMS”. The present application is also a continuation-in-part of non-provisional utility patent application Ser. No. 12/540,313 filed Aug. 12, 2009, entitled “SPORTS MATCHMAKER SYSTEMS” which is related to and claims priority from prior provisional patent application Ser. No. 61/088,650, filed Aug. 13, 2008, entitled “SPORTS MATCHMAKER SYSTEMS”. Further, prior non-provisional patent application Ser. No. 12/540,313, referenced above, is also a continuation-in-part of non-provisional utility patent application Ser. No. 12/047,299 filed Mar. 12, 2008, entitled “SPORTS MATCHMAKER SYSTEMS” which is related to and claims priority from prior provisional patent application Ser. No. 60/894,668, filed Mar. 13, 2007, entitled “SPORTS MATCHMAKER SYSTEMS”, and prior provisional patent application Ser. No. 60/942,432, filed Jun. 6, 2007, entitled “SPORTS MATCHMAKER SYSTEMS”. Further, prior non-provisional patent application Ser. No. 12/047,299, referenced above, is a continuation-in-part of prior non-provisional patent application Ser. No. 11/463,574, filed Aug. 9, 2006, entitled “SPORTS MATCHMAKER SYSTEMS”, which is related to and claims priority to prior provisional patent application Ser. No. 60/707,889, filed Aug. 12, 2005, entitled “SPORTS MATCHMAKER SYSTEMS”, and prior provisional patent application Ser. No. 60/775,920, filed Feb. 22, 2006, entitled “SPORTS MATCHMAKER SYSTEMS”, the contents all of which are incorporated herein by this reference and are not admitted to be prior art with respect to the present invention by the mention in this cross-reference section.

### BACKGROUND

This invention relates to providing systems for arranging meetings between unacquainted people as well as between people in a social network. More particularly, this invention relates to providing systems for matching persons, teams and/or groups offering to participate in particular sporting, social, business, political, gaming, cooking, medical, training, or other activities with persons, groups, organizations, clubs, seminars, teams, etc., desiring to participate in similar activities

The explosive diffusion of the Internet into countries such as the United States has been accompanied by the proliferation of Internet-based singles—as in unmarried or unattached people—matchmaking systems. These matchmaking systems are predominantly oriented toward single, meaning unmarried or unattached, men and women wishing to meet other single men and women, generally for the purpose of establishing a romantic relationship. The success of these matchmaking systems is demonstrated by the large number of Internet Web sites devoted to matchmaking available on the Internet today. Examples of Internet-based dating systems include Match.com, eHarmony.com, and Kiss.com.

Typically, these matchmaking systems focus exclusively on unmarried and unattached people and their desire to meet each other. In other words, these matchmaking systems ignore the social networking needs of the remainder of the population desiring to meet or jointly participate in something other than a “date”. While it is possible to find someone interested in golf or tennis using these sites, it is not possible to search and find a person with whom to play a specific, or particular, game of golf or tennis on these “dating” Web sites. As a result, a very large group of people are not able to socially network effectively through the Internet. For example, couples, children, and teams have no means to identify others wishing to participate in activities that are event oriented, i.e., events that are location, time, and date dependent. For instance, a traveler wishing to play golf on a Saturday while away from home must rely on calling golf courses in the area to determine if there are any opportunities to join a group of golfers in a golf game. Conversely, this traveler must rely on the same methods to make an offer to play golf. Additionally, the traveler has no opportunity to get to know the other participants in advance.

Thus, a great need exists for a system capable of effectively permitting social networking for people by facilitating identification of others who desire to offer and accept participation in activities that are event (especially sporting) oriented using computer networks.

### OBJECTS AND FEATURES OF THE INVENTION

A primary object and feature of the present invention is to provide a system for matching persons making specific sporting and social activity participation offers with persons desiring to participate in a specific sporting and social activity.

It is a further object and feature of the present invention to provide such a system for permitting participants to post offers to participate in a particular sporting or social activity.

It is a further object and feature of the present invention to provide such a system for permitting participants to search for individuals making an offer to participate in a particular sporting or social activity.

It is a further object and feature of the present invention to provide such a system for permitting participants to search profiles of participants' sporting and social interests and related skill levels.

It is a further object and feature of the present invention to provide such a system for permitting participants to communicate with each other through a computer network.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a computer system, relating to integrating at least one social-network website-service into at least one website providing at least one social network website as a portion of the at least one website permitting social interactions between users of the at least one website, comprising: at least one central social-network computer server structured and arranged to serve, by at least one computer, the at least one social-network website-service to the at least one website; at least one service integrator computer processor structured and arranged to integrate the at least one social-network website-service into the at least one website as the at least one social network website; at least one cross social-network interaction computer interface structured and arranged to interface social-interactions between users across a plurality of the at least one social network websites of a plurality of the at least one websites; wherein, when integrated, the at least one website comprises the at least one social network website permitting such social interactions between the users at the at least one website.

Moreover, it provides such a computer system wherein such at least one service integrator computer processor comprises at least one website-theme matcher structured and arranged to match at least one website-theme of the at least one social network website to at least one website-theme of the at least one website. Additionally, it provides such a computer system wherein such at least one website-theme matcher comprises at least one logo common to both the at least one social network website and the at least one website. Also, it provides such a computer system wherein such at least one website-theme matcher comprises at least one navigation feature to navigate between the at least one social network website and the at least one website. In addition, it provides such a computer system wherein such at least one website-theme matcher comprises at least one color-scheme common to both the at least one social network website and the at least one website. And, it provides such a computer system further comprising at least one user-to-network associator computer processor structured and arranged to associate each of the users with at least one specific social network website of such plurality of the at least one social network websites.

Further, it provides such a computer system further comprising at least one user-authentication computer interface structured and arranged to permit user-authentication from each of such plurality of the at least one social network websites, by any of the users, to such at least one specific social network website. Even further, it provides such a computer system further comprising: at least one user redirector computer processor structured and arranged to redirect the users from any of such plurality of the at least one social network websites to such at least one specific social network website; wherein each of the users, upon authentication, is automatically directed to such at least one specific social network website, with which each of the users is respectively associated, regardless of which of such plurality of the at least one social network websites the users authenticated through.

Moreover, it provides such a computer system further comprises: at least one user registration computer interface structured and arranged to permit registration of the users through each of such plurality of the at least one social network websites; wherein such user-to-network associator computer processor associates the users to such at least one specific social network website through which the users register. Additionally, it provides such a computer system further comprising at least one administrator computer interface structured and arranged to permit administration of such at least one specific social network website; wherein such at least one administrator computer interface comprises at least one user-data accessor computer interface structured and arranged to access user-data of the users associated with such at least one specific social network website.

In accordance with another preferred embodiment hereof, this invention provides a computer system, relating to integrating at least one social-network website-service into at least one website providing at least one social network website as a portion of the at least one website permitting social interactions between users of the at least one website, comprising: central social-network computer server means for serving, by at least one computer, the at least one social-network website-service to the at least one website; service integrator computer processor means for integrating the at least one social-network website-service into the at least one website as the at least one social network website; cross social-network interaction computer interface means for interfacing social-interaction between users across a plurality of the at least one social network websites of a plurality of the at least one websites; wherein, when integrated, the at least one website comprises the at least one social network website permitting social interactions between the users at the at least one website.

Also, it provides such a computer system wherein such service integrator computer processor means comprises website-theme matcher means for matching at least one website-theme of the at least one social network website to at least one website-theme of the at least one website. In addition, it provides such a computer system further comprising user-to-network associator computer processor means for associating each of the users with at least one specific social network website of such plurality of the at least one social network websites. And, it provides such a computer system further comprising user-authentication computer interface means for permitting user-authentication from each of such plurality of the at least one social network websites, by any of the users, to such at least one specific social network website.

Further, it provides such a computer system further comprising: user redirector computer processor means for redirecting the users from any of such plurality of the at least one social network websites to such at least one specific social network website; wherein each of the users, upon authentication, is automatically directed to such at least one specific social network website, with which each of the users is respectively associated, regardless of which of such plurality of the at least one social network websites the users authenticated through. Even further, it provides such a computer system further comprising: user registration computer interface means for permitting registration of the users through each of such plurality of the at least one social network websites; wherein such user-to-network associator computer processor means associates the users to such at least one specific social network website through which the users register. Even further, it provides such a computer system further comprising: administrator computer interface means for permitting administration of such at least one specific social network website; wherein such administrator computer interface means comprises user-data accessor computer interface means for accessing user-data of the users associated with such at least one specific social network website.

In accordance with another preferred embodiment hereof, this invention provides a computer method, relating to integrating at least one social-network website-service into at least one website providing at least one social network website as a portion of the at least one website permitting social interactions between users of the at least one website, comprising: serving, by at least one computer, the at least one social-network website-service to the at least one website; integrating the at least one social-network website-service into the at least one website as the at least one social network website; interfacing social-interaction between users across a plurality of the at least one social network websites of a plurality of the at least one websites; wherein, when integrated, the at least one website comprises the at least one social network website permitting social interactions between the users at the at least one website.

Even further, it provides such a computer method wherein such step of integrating comprises matching at least one website-theme of the at least one social network website to at least one website-theme of the at least one website. Even further, it provides such a computer method further comprising the step of associating each of the users with at least one specific social network website of such plurality of the at least one social network websites. Even further, it provides such a computer method further comprising the step of permitting user-authentication from each of such plurality of the at least one social network websites, by any of the users. Even further, it provides such a computer method further comprising the step of: redirecting the users from any of such plurality of the at least one social network websites to such at least one specific social network website; wherein each of the users, upon authentication, is automatically directed to such at least one specific social network website, with which each of the users is respectively associated, regardless of which of such plurality of the at least one social network websites the users authenticated through.

Even further, it provides such a computer method further comprising the step of: permitting registration of the users through each of such plurality of the at least one social network websites; wherein such step of associating associates the users to such at least one specific social network website through which the users register. Even further, it provides such a computer method further comprising: permitting administration of such at least one specific social network website; wherein such step of permitting administration comprises accessing user-data of the users associated with such at least one specific social network website.

In accordance with another preferred embodiment hereof, this invention provides a computer program system for an Internet computer system, relating to finding at least one proposed joint event for assisting displaying participant personal profile information of at least one first participant by at least one second participant with, comprising the steps of: searchably storing proposed-event information wherein such proposed-event information comprises at least at least one type of proposed joint event, at least one proposed geographic area for such proposed joint event, and at least one proposed time criterion for such at least one proposed joint event; permitting input on behalf of such at least one first participant of such at least one proposed joint event; searchably storing such participant personal profile information wherein such participant personal profile information comprises at least at least one unique identifier, such at least one type of such proposed joint event, such of at least one first skill level of such at least one type of proposed joint event, demographic information, and contact information; permitting input on behalf of such at least one first participant such participant personal profile information; permitting associating such entered proposed joint event with such entered participant personal profile information; permitting input on behalf of such at least one second participant first searchable criteria for proposed matching of such at least one proposed joint event; retrieving from such computer database such stored proposed-event information matching such first searchable criteria; and displaying such entered participant profile information associated with such retrieved proposed-event information.

Moreover, it provides such a computer program system wherein such at least one type of proposed joint event comprises at least one sporting event. Additionally, it provides such a computer program system wherein at least one of such at least one first participant and such at least one second participant comprises at least one team. Also, it provides such a computer program system wherein at least one of such at least one first participant and such at least one second participant comprises at least one couple. In addition, it provides such a computer program system further comprising the steps of: permitting input, on behalf of such at least one first participant, of at least one first skill level of such at least one type of proposed joint event; permitting input on behalf of such at least one second participant at least one second searchable criterion for proposed matching with such at least one skill level of such at least one type of proposed joint event; retrieving from such computer database such proposed-event information matching such second searchable criterion; and displaying such entered participant profile information associated with such retrieved proposed-event information.

And, it provides such a computer program system further comprising the step of retrieving on behalf of such at least one first participant such proposed-event information from such computer database. Further, it provides such a computer program system further comprising the steps of: permitting input on behalf of such at least one second participant at least one third searchable criteria for proposed matching of such personal profile information; and retrieving from such computer database such personal profile information matching such third searchable criteria. Even further, it provides such a computer program system wherein such personal profile information further comprises at least two of the following: children information, participant background information, personality traits information; favorite foods information; preferred music information; and at least one image. Moreover, it provides such a computer program system further comprising the steps of: searchably storing at least one bulletin board posting; permitting entry on behalf of such at least one first participant of such at least one bulletin board posting; associating such at least one such bulletin board posting with such at least one first participant; permitting input on behalf of such at least one second participant at least one fourth searchable criteria for proposed matching with such personal profile information; retrieving such at least one bulletin board posting associated with such personal profile information matching such fourth search criteria.

Additionally, it provides such a computer program system wherein such fourth search criteria comprises: at least one type of proposed joint event, at least one proposed geographic area for such proposed joint event; and at least one proposed time criterion for such at least one proposed joint event. Also, it provides such a computer program system further comprising the step of assisting such at least one second participant to communicate with such at least one first participant. In addition, it provides such a computer program system wherein the step of assisting such at least one second participant to communicate with such at least one first participant comprises the steps of: assisting non-disclosure of first contact information of such first participant to such second participant; and assisting non-disclosure of second contact information of such second participant to such first participant. And, it provides such a computer program system wherein the step of assisting such at least one second participant to communicate with such at least one first participant is accomplished with text messaging on digital mobile phones.

In accordance with another preferred embodiment hereof, this invention provides a system relating to conducting business utilizing an Internet web site comprising the steps of: providing at least one first searchable database adapted to contain proposed sporting event information; and receiving such proposed sporting event information from at least one first participant; providing at least one second searchable database adapted to contain participant personal profile information; receiving such participant personal profile information from such at least one first participant; permitting at least one second participant to describe first search criteria related to searching such at least one first searchable database; wherein such first search criteria comprise at least at least one type of proposed sporting event, at least one proposed geographic area related to such at least one proposed sporting event, and at least one proposed time frame related to such at least one proposed sporting event; retrieving such proposed sporting event information matching such first search criteria; and presenting to such at least one second participant such participant personal profile information from such at least one first participant. Further, it provides such a system further comprising the step of receiving web site advertising revenue.

Even further, it provides such a system wherein the step of receiving web site advertising revenue comprises the steps of: offering web site advertising to at least one advertiser; receiving at least one web site advertisement from such at least one advertiser; receiving payment from such at least one advertiser; after such step of receiving payment, approving such at least one web site advertisement; and displaying such approved such at least one web site advertisement. Moreover, it provides such a system further comprising the step of permitting at least one of such at least one first participant and such at least one second participant to select at least one link to such at least one advertiser. Additionally, it provides such a system wherein such at least one advertiser comprises at least one sporting venue. Also, it provides such a system further comprising the step of receiving membership fees. In addition, it provides such a system wherein the step of receiving membership fees comprises the step of receiving payment from at one of such at least one first participant and such at least one second participant. And, it provides such a system further comprising the steps of: offering at least one product for sale to at least one of such at least one first participant and such at least one second participant; and receiving payment from at least one of such at least one first participant and such at least one second participant.

Further, it provides such a system further comprising the step of: promoting at least one group event for at least one of such at least one first participant and such at least one second participant with at least one event provider; charging each attending at least one of such at least one first participant and such at least one second participant at least one fee; and paying such at least one event provider. Even further, it provides such a system further comprising the steps of: permitting at least one of such at least one first participant and such at least one second participant to select at least one link to such at least one travel provider; and receiving referral payments from such at least one travel provider. Moreover, it provides such a system further comprising the steps of: promoting at least one reality television program with at least one reality television program provider; and accepting at least one offer to participate in such at least one reality television program from at one of such at least one first participant and such at least one second participant. Additionally, it provides such a system further comprising the step of assisting communication between such at least one first participant and such at least one second participant.

Also, it provides such a system further comprising the step of offering payment to least one affiliate for referral of at least one new participant. In addition, it provides such a system further comprising the steps of: permitting such at least one second participant to describe second search criteria related to searching such at least one second searchable database; and permitting such at least one second participant to view such personal profile information matching such second search criteria. And, it provides such a system further comprising the steps of: providing at least one third searchable database adapted to contain bulletin board message information; receiving such bulletin board message information from such at least one first participant; permitting such at least one second participant to describe third search criteria related to searching such at least one third searchable database in combination with such at least one second searchable database; permitting such at least one second participant to view such bulletin board message information matching such third search criteria; and permitting such at least one second participant to view such participant personal profile information related to such at least one first participant.

In accordance with another preferred embodiment hereof, this invention provides a computer program system for an Internet computer system, relating to assisting finding at least one first participant by at least one second participant, comprising the steps of: searchably storing participant personal profile information wherein such participant personal profile information comprises at least at least one unique identifier, demographic information, contact information, permitting input on behalf of such at least one first participant such personal profile information; searchably storing at least one bulletin board posting; permitting entry on behalf of such at least one first participant of such at least one bulletin board posting; and associating such at least one such bulletin board posting with such at least one first participant. Further, it provides such a computer program system further comprising the steps of: permitting input on behalf of such at least one second participant at least one first searchable criteria for proposed matching with such personal profile information in combination with such bulletin board posting; and retrieving such at least one bulletin board posting associated with such personal profile information matching such search criteria. Even further, it provides such a computer program system further comprising the steps of: permitting input on behalf of such at least one second participant at least one second searchable criteria for proposed matching of such personal profile information; and retrieving from such computer database such first personal profile information matching such third searchable criteria. Even further, it provides such a computer program system wherein at least one of such at least one first participant and such at least one second participant comprises at least one team.

Even further, it provides such a computer program system wherein at least one of such at least one first participant and such at least one second participant comprises at least one couple. Even further, it provides such a computer program system wherein such personal profile information further comprises at least two of the following: marital status information children information, participant background information, personality traits information; favorite foods information; preferred music information; and at least one image. Even further, it provides such a computer program system further comprising the step of assisting such at least one second participant to communicate with such at least one first participant. Even further, it provides such a computer program system wherein the step of assisting such at least one second participant to communicate with such at least one first participant comprises the steps of: assisting non-disclosure of first contact information of such first participant to such second participant; and assisting non-disclosure of second contact information of such second participant to such first participant. Even further, it provides such a computer program system wherein the step of assisting such at least one second participant to communicate with such at least one first participant is accomplished with text messaging on digital mobile phones.

In accordance with a preferred embodiment hereof, this invention provides an Internet computer system, relating to assisting finding of at least one proposed joint event by at least one second participant with at least one first participant, comprising: computer database means for searchably storing proposed-event information wherein such proposed-event information comprises at least at least one type of proposed joint event, at least one proposed geographic area for such proposed joint event, and at least one proposed time frame for such at least one proposed joint event; computer interface means for permitting database entry on behalf of such at least one first participant of such at least one proposed joint event; computer interface means for permitting entry on behalf of such at least one second participant first searchable criteria for proposed matching of such at least one proposed joint event; and computer processing means for retrieving from such computer database means such proposed-event information matching such first searchable criteria. Moreover, it provides such an internet computer system wherein such at least one type of proposed joint event comprises at least one sporting event. Additionally, it provides such an Internet computer system wherein at least one of such at least one first participant and such at least one second participant comprises at least one team. Also, it provides such an Internet computer system wherein at least one of such at least one first participant and such at least one second participant comprises at least one couple.

In addition, it provides such an Internet computer system further comprising: computer interface means for permitting database entry, on behalf of such at least one first participant, of at least one first skill level of such at least one type of proposed joint event; computer interface means for permitting entry on behalf of such at least one second participant at least one second searchable criterion for proposed matching with such at least one skill level of such at least one type of proposed joint event; computer processing means for retrieving from such computer database means such proposed-event information matching such second searchable criterion. And, it provides such an Internet computer system further comprising computer processing means for retrieving on behalf of such at least one first participant such proposed-event information from such computer database means. Further, it provides such an Internet computer system further comprising: computer database means for searchably storing participant personal profile information wherein such participant personal profile information comprises at least at least one unique identifier, such at least one type of such proposed joint event, such of at least one first skill level of such at least one type of proposed joint event, demographic information, contact information, computer interface means for database entry on behalf of such at least one first participant such personal profile information; computer interface means for permitting entry on behalf of such at least one second participant at least one third searchable criteria for proposed matching of such personal profile information; and computer processing means for retrieving from such computer database means such first personal profile information matching such third searchable criteria.

Even further, it provides such an Internet computer system wherein such personal profile information further comprises at least two of the following: children information, participant background information, personality traits information; favorite foods information; preferred music information; and at least one image. Moreover, it provides such an Internet computer system further comprising: computer database means for searchably storing at least one bulletin board posting; computer interface means for entry on behalf of such at least one first participant of such at least one bulletin board posting; computer processing means for associating such at least one such bulletin board posting with such at least one first participant; computer interface means for permitting entry on behalf of such at least one second participant at least one fourth searchable criteria for proposed matching with such personal profile information; computer processing means for retrieving such at least one bulletin board posting associated with such personal profile information matching such fourth search criteria. Internet computer system wherein such fourth search criteria comprise: at least one type of proposed joint event, at least one proposed geographic area for such proposed joint event, and at least one proposed time criterion for such at least one proposed joint event.

Additionally, it provides such an Internet computer system further comprising computer processing means for assisting such at least one second participant to communicate with such at least one first participant. Also, it provides such an Internet computer system wherein such computer processing means for assisting such at least one second participant to communicate with such at least one first participant comprises: computer processing means for assisting non-disclosure of first contact information of such first participant to such second participant; and computer processing means for assisting non-disclosure of second contact information of such second participant to such first participant.

In accordance with another preferred embodiment hereof, this invention provides a computer system for an Internet computer system, relating to finding at least one proposed joint event for assisting displaying participant personal profile information of at least one first participant by at least one second participant with, comprising: at least one computer process structured and arranged to assist searchably storing proposed-event information wherein such proposed-event information comprises at least at least one type of proposed joint event, at least one proposed geographic area for such proposed joint event, and at least one proposed time criterion for such at least one proposed joint event; at least one computer process structured and arranged to assist permitting input on behalf of such at least one first participant of such at least one proposed joint event; at least one computer process structured and arranged to assist searchably storing such participant personal profile information wherein such participant personal profile information comprises at least at least one unique identifier, such at least one type of such proposed joint event, such of at least one first skill level of such at least one type of proposed joint event, demographic information, and contact information; at least one computer process structured and arranged to assist permitting input on behalf of such at least one first participant such participant personal profile information; at least one computer process structured and arranged to assist permitting associating such entered proposed joint event with such entered participant personal profile information; at least one computer process structured and arranged to assist permitting input on behalf of such at least one second participant first searchable criteria for proposed matching of such at least one proposed joint event; at least one computer process structured and arranged to assist retrieving from such computer database such stored proposed-event information matching such first searchable criteria; and at least one computer process structured and arranged to assist displaying such entered participant profile information associated with such retrieved proposed-event information.

Even further, it provides such a computer system wherein such at least one type of proposed joint event comprises at least one sporting event. Even further, it provides such a computer system wherein at least one of such at least one first participant and such at least one second participant comprises at least one team. Even further, it provides such a computer system wherein at least one of such at least one first participant and such at least one second participant comprises at least one couple. Even further, it provides such a computer system further comprising: at least one computer process structured and arranged to assist permitting input, on behalf of such at least one first participant, of at least one first skill level of such at least one type of proposed joint event; at least one computer process structured and arranged to assist permitting input on behalf of such at least one second participant at least one second searchable criterion for proposed matching with such at least one skill level of such at least one type of proposed joint event; at least one computer process structured and arranged to assist retrieving from such computer database such proposed-event information matching such second searchable criterion; and at least one computer process structured and arranged to assist displaying such entered participant profile information associated with such retrieved proposed-event information.

Even further, it provides such a computer system further comprising at least one computer process structured and arranged to assist retrieving on behalf of such at least one first participant such proposed-event information from such computer database. Even further, it provides such a computer system further comprising: at least one computer process structured and arranged to assist permitting input on behalf of such at least one second participant at least one third searchable criteria for proposed matching of such personal profile information; and at least one computer process structured and arranged to assist retrieving from such computer database such personal profile information matching such third searchable criteria. Even further, it provides such a computer system wherein such personal profile information further comprises at least two of the following: children information, participant background information, personality traits information; favorite foods information; preferred music information; and at least one image. Even further, it provides such a computer system further comprising: at least one computer process structured and arranged to assist searchably storing at least one bulletin board posting; at least one computer process structured and arranged to assist permitting entry on behalf of such at least one first participant of such at least one bulletin board posting; at least one computer process structured and arranged to assist associating such at least one such bulletin board posting with such at least one first participant; at least one computer process structured and arranged to assist permitting input on behalf of such at least one second participant at least one fourth searchable criteria for proposed matching with such personal profile information; at least one computer process structured and arranged to assist retrieving such at least one bulletin board posting associated with such personal profile information matching such fourth search criteria.

Even further, it provides such a computer system wherein such fourth search criteria comprises: at least one type of proposed joint event, at least one proposed geographic area for such proposed joint event; and at least one proposed time criterion for such at least one proposed joint event. Even further, it provides such a computer system further comprising at least one computer process structured and arranged to assist assisting such at least one second participant to communicate with such at least one first participant. Even further, it provides such a computer system wherein such at least one computer process structured and arranged to assist assisting such at least one second participant to communicate with such at least one first participant comprises: at least one computer process structured and arranged to assist assisting non-disclosure of first contact information of such first participant to such second participant; and at least one computer process structured and arranged to assist assisting non-disclosure of second contact information of such second participant to such first participant.

In accordance with a preferred embodiment hereof, this invention provides a method, relating to providing at least one unconfirmed, unscheduled proposed-event preference of at least one registered user, among a network of registered users of at least one Internet web site resulting in at least one confirmed, scheduled event, such method comprising the steps of: providing storage of personal contact information of a plurality of registered users of the Internet web site; providing storage of at least one unconfirmed, unscheduled proposed-event preference for at least one first registered user of the Internet web site; providing communicating such at least one unconfirmed, unscheduled proposed-event preference to at least one first registered-user-selected set of the plurality of registered users of the Internet web site; providing communicating participation interest in the at least one preferred, unconfirmed, and unscheduled proposed-event by at least one member of the at least one first registered-user-selected set to at least one other member of the at least one registered-user-selected set; providing approving interest by the at least one other member in participating in the at least one preferred, unconfirmed, unscheduled proposed-event; providing automatically scheduling and storing the at least one now-approved, confirmed, scheduled event; and providing automatically communicating details of such now confirmed, scheduled event to the at least one other member approving participation, the “approved participants”.

Moreover, it provides such a method, wherein such step of communicating details of such now confirmed, scheduled event to approved participants comprises the step of displaying, for the benefit of at least one of the approved participants, details of the now confirmed, scheduled event. Additionally, it provides such a method, wherein such step of providing approving interest in participating in the at least one preferred, unconfirmed, unscheduled proposed-event by the communicating registered users comprises the step of providing notifying approval among registered users by way of at least one email message delivered by way of the Internet. Also, it provides such a method, wherein such step of providing approving interest in participating in the at least one preferred, unconfirmed, unscheduled proposed-event by the communicating registered users comprises the step of providing notifying approval among registered users by way of at least SMS message delivered over at least one telecommunications network. In addition, it provides such a method, wherein such step of automatically communicating details of such now confirmed, scheduled event to approved participants comprises providing communicating such details by way of at least one email message delivered by way of the Internet. And, it provides such a method, wherein such step of communicating details of such now confirmed, scheduled event to approved participants comprises the step of providing communicating such details by way of at least SMS message over at least one telecommunications network.

Further, it provides such a method, further comprising the step of providing displaying elapsed confirmed, scheduled event after a date when such confirmed, scheduled event was intended to occur, the method, further comprising the step of providing limiting a number of approved participants that may participate in the at least one preferred, unconfirmed, unscheduled proposed-event. Even further, it provides such a method, further comprising the step of providing displaying, for the benefit of at least one registered user, at least one quantity of remaining approved participant openings relating to a particular registered-user proposed limit of a number of approved participants that may participate in the at least one preferred, unconfirmed, unscheduled proposed-event.

Moreover, it provides such a method further comprising the step of providing displaying—for the benefit of at least one registered user—approved personal contact information of at least one confirmed participant that may participate in the now confirmed, scheduled event so that the confirmed registered users may further communicate regarding the now confirmed, scheduled event. Additionally, it provides such a method, further comprising the step of providing assisting non-disclosure of contact information of at least one first participant to another participant; and providing assisting non-disclosure of contact information of such at least one second participant to such first participant. Also, it provides such a method further comprising the step of providing gathering data relating to the confirmed, scheduled event from participants of the confirmed, schedule event after the date when such confirmed, scheduled event was intended to occur has elapsed. In addition, it provides such a computer program system, wherein such SMS messaging is assisted by coupling through at least one Internet Web site. And, it provides such a computer program system, wherein such SMS messaging is assisted by coupling through at least one Internet Web site.

Further, it provides such a computer program system, wherein the step of providing approving interest by the at least one other member in participating in the at least one preferred, unconfirmed, unscheduled proposed-event comprises providing displaying at least one clickable hyperlink that when clicked once communicates approved interest to registered users of the at least one Internet web site. Even further, it provides such a computer program system, wherein the step of providing gathering data relating to the confirmed, scheduled event from participants of the confirmed, schedule event after the date when such confirmed, scheduled event was intended to occur has elapsed comprises the step of providing assisting input from participants of the confirmed, schedule event concerning behavioral profiling of at least one of the participants. Even further, it provides such a computer program system, further comprising the step of assisting compiling statistical data concerning such behavioral profiling of each of at least one of the participants. Even further, it provides such a computer program system, further comprising the step of assisting anonymous display of such statistical data. Even further, it provides such a computer program system, further comprising the step of providing displaying of such statistical data coupled to each participants profile page data.

In accordance with another preferred embodiment hereof, this invention provides a method, relating to providing at least one unconfirmed, unscheduled proposed-event preference of at least one registered user, among a network of registered users of at least one Internet web site resulting in at least one confirmed, scheduled event, such method comprising the steps of: providing storage of personal contact information of a plurality of registered users of the Internet web site; providing storage of at least one unconfirmed, unscheduled proposed-event preference for at least one first registered user of the Internet web site; providing communicating such at least one unconfirmed, unscheduled proposed-event preference to at least one first registered-user-selected set of the plurality of registered users of the Internet web site; providing communicating participation interest in the at least one preferred, unconfirmed, and unscheduled proposed-event by at least one member of the at least one first registered-user-selected set to at least one other member of the at least one registered-user-selected set; providing approving interest by the at least one other member in participating in the at least one preferred, unconfirmed, unscheduled proposed-event; providing automatically scheduling and storing the at least one now-approved, confirmed, scheduled event; and providing automatically communicating details of such now confirmed, scheduled event to the at least one other member approving participation, the “approved participants”; wherein such unscheduled proposed-event preference is sports related. Even further, it provides such a method, wherein such unscheduled proposed-event preference is sports team related.

In accordance with a preferred embodiment hereof, this invention provides a computer system comprising: computer personal-profile database means for searchably storing personal profile data relating to at least one plurality of registered users of at least one computer network; and computer proposed-activity database means for searchably storing activity data, relating to at least one proposed multiple-person activity of at least one activity type, relating to at least one registered user of the at least one computer network; wherein such at least one proposed multiple-person activity requires attendance of at least one minimum number of the multiple persons relating to such at least one proposed multiple-person activity; and wherein such activity data relating to such at least one proposed multiple-person activity comprises at least one such activity type, at least one profile description of the multiple persons required, at least one geographic area, and at least one time frame; and computer activity-participation-request interface means for assisting receiving at least one request from at least one such registered user to participate in such at least one multiple-person proposed activity; computer participation-request database means for automatically searchably storing such at least one request from such at least one registered user to participate in such at least one multiple-person proposed activity; computer activity manager processor means for managing such at least one proposed multiple-person activity; wherein such computer activity manager processor means comprises computer activity-participation-response-manager processor means for managing at least one response, responsive to such at least one request, to participate in such at least one multiple-person proposed activity, computer activity-participation-manager processor means for assisting confirming sufficient participation in such at least one multiple-person proposed activity to form at least one scheduled activity, and computer scheduled-activity-communicator processor means for automatically communicating information relating to such at least one scheduled activity to registered users scheduled to participate in such at least one scheduled activity.

Moreover, it provides such a computer system, wherein such computer activity-participation-manager processor means comprises computer activity-participation-sub-network processor means for assisting limiting participation in at least one such proposed multiple-person activity to specified users of such at least one plurality of registered users of at least one computer network. Additionally, it provides such a computer system, wherein such computer activity-participation-manager processor means comprises computer activity-participation-sub-network processor means for assisting limiting participation in at least one such proposed multiple-person activity relating to personal profile data of such at least one plurality of registered users of at least one computer network. Also, it provides such a computer system, further comprising: computer user-associating interface means for assisting associating at least one registered user of the at least one computer network with at least one other registered user of the at least one computer network, to form at least one registered user sub-network; and computer user-sub-network database means for assisting storage of such at least one registered user sub-network; wherein such computer activity-participation-manager processor means comprises computer activity-participation-sub-network processor means for assisting limiting participation in at least one such proposed multiple-person activity to those in at least one specified at least one registered user sub-network.

In addition, it provides such a computer system further comprising computer attendance-number-setting interface means for setting a number of attendees desired to participate in such at least one proposed multiple-person activity; wherein such computer activity-participation-manager processor means comprises computer activity-participation-closing processor means for preventing additional registered users from confirming participation in such at least one proposed multiple-person activity when the number of registered users scheduled to participate in such at least one scheduled activity is equal to the number of attendees desired to participate in such at least one proposed multiple-person activity. And, it provides such a computer system further comprising computer participation-status-communication processor means for automatically communicating participation status information to such registered users prevented from confirming participation in such at least one proposed multiple-person activity. Further, it provides such a computer system wherein such computer activity-participation-manager processor means comprises computer hyperlink-generation-interface means for assisting generating at least one clickable hyperlink which, when clicked by at least one registered user, confirms that registered user's participation in such at least one multiple-person proposed activity.

Even further, it provides such a computer system further comprising computer interface means for assisting receiving at least one telephone-transmitted signal relating to such at least one proposed multiple-person activity; computer telephone-transmitted-signal-to-user processor means for associating such at least telephone-transmitted signal with at least one registered user; computer telephone-transmitted-signal-interpreter processor means for interpreting such at least one telephone-transmitted signal as a denial to participate or confirmation to participate in such at least one proposed multiple-person activity responsive to such at least one request from at least one such registered user to participate in such at least one multiple-person proposed activity. Moreover, it provides such a computer system further comprises computer participation-approval processor means for approving of at least one request to participate in at least one multiple-person proposed activity. Additionally, it provides such a computer system wherein such computer activity-manager processor means further comprises computer activity-cancellation processor means for cancelling of at least one request to participate in at least one multiple-person proposed activity. Also, it provides such a computer system wherein such computer activity-manager processor means further comprises computer activity-closing processor means for closing at least one multiple-person proposed activity to prevent participation request acceptance when closing conditions are met.

In addition, it provides such a computer system wherein such computer activity-manager processor means further comprises computer activity-re-opening processor means for re-opening participation request acceptance in at least one multiple-person proposed activity when re-opening conditions are satisfied. And, it provides such a computer system wherein such computer activity-manager processor means further comprises computer re-opening-communicator processor means to automatically communicate such reopening of such at least one multiple-person proposed activity to the multiple persons relating to such at least one multiple-person proposed activity. Further, it provides such a computer system wherein such closing conditions comprise at least one temporal condition and/or at least one attendance condition. Even further, it provides such a computer system wherein such re-opening conditions comprise at least one scheduled participant cancellation.

In accordance with another preferred embodiment hereof, this invention provides a computer system comprising: at least one computer personal-profile database structured and arranged to searchably store personal profile data relating to at least one plurality of registered users of at least one computer network; and at least one computer proposed-activity database structured and arranged to searchably store activity data, relating to at least one proposed multiple-person activity of at least one activity type, relating to at least one registered user of the at least one computer network; wherein such at least one proposed multiple-person activity requires attendance of all of the multiple persons relating to such at least one proposed multiple-person activity; and wherein such activity data relating to such at least one proposed multiple-person activity comprises at least one such activity type, at least one profile description of the multiple persons required; at least one geographic area, and at least one time frame; and at least one computer activity-participation-request interface structured and arranged to assist receiving at least one request from at least one such registered user to participate in such at least one multiple-person proposed activity; at least one computer participation-request database structured and arranged to automatically searchably store such at least one request from such at least one registered user to participate in such at least one multiple-person proposed activity; at least one computer activity-participation-response-manager structured and arranged to manage at least one response, responsive to such at least one request, to participate in such at least one multiple-person proposed activity; at least one computer activity-participation-manager processor structured and arranged to assist confirming sufficient participation in such at least one multiple-person proposed activity to form at least one scheduled activity; and at least one computer scheduled-activity-communicator processor structured and arranged to automatically communicate information relating to such at least one scheduled activity to registered users scheduled to participate in such at least one scheduled activity.

Moreover, it provides such a computer system, wherein such at least one computer activity-participation-manager processor comprises at least one computer activity-participation-sub-network processor structured and arranged to assist limiting participation in at least one such proposed multiple-person activity to specified users of such at least one plurality of registered users of at least one computer network. Additionally, it provides such a computer system, wherein such at least one computer activity-participation-manager processor comprises at least one computer activity-participation-sub-network processor structured and arranged to assist limiting participation in at least one such proposed multiple-person activity relating to personal profile data of such at least one plurality of registered users of at least one computer network. Also, it provides such a computer system, further comprising: at least one computer user-associating interface structured and arranged to assist associating at least one registered user of the at least one computer network with at least one other registered user of the at least one computer network, forming at least one registered user sub-network; and at least one computer user-sub-network database structured and arranged to assist storage of such at least one registered user sub-network; wherein such computer activity-participation-manager processor comprises at least one computer activity-participation-sub-network processor structured and arranged to assist limiting participation in at least one such proposed multiple-person activity to those in at least one specified at least one registered user sub-network.

In addition, it provides such a computer system further comprising at least one computer attendance-number-setting interface structured and arranged to set a number of attendees who are desired to participate in such at least one proposed multiple-person activity; wherein such at least one computer activity-participation-manager processor comprises at least one computer activity-participation-closing processor structured and arranged to prevent additional registered users from confirming participation in such at least one proposed multiple-person activity when the number of registered users scheduled to participate in such at least one scheduled activity is equal to the number of attendees who are desired to participate in such at least one proposed multiple-person activity. And, it provides such a computer system further comprising at least one computer participation-status-communication processor structured and arranged to automatically communicate participation status information to such registered users prevented from confirming participation in such at least one proposed multiple-person activity. Further, it provides such a computer system wherein such at least one computer activity-participation-manager processor comprises at least one computer hyperlink-generation-interface structured and arranged to assist generating at least one clickable hyperlink which, when clicked by at least one registered user, confirms that registered user's participation in such at least one multiple-person proposed activity.

Even further, it provides such a computer system further comprising at least one computer interface structured and arranged to assist receiving at least one telephone-transmitted signal relating to such at least one proposed multiple-person activity; at least one computer telephone-transmitted-signal-to-user processor structured and arranged to associate such at least telephone-transmitted signal with at least one registered user; at least one computer telephone-transmitted-signal-interpreter processor structured and arranged to interpret such at least one telephone-transmitted signal as a denial to participate or confirmation to participate in such at least one proposed multiple-person activity responsive to such at least one request from at least one such registered user to participate in such at least one multiple-person proposed activity. Even further, it provides such a computer system further comprises at least one computer participation-approval processor structured and arranged to approve of at least one request to participate in at least one multiple-person proposed activity. Even further, it provides such a computer system wherein such at least one computer activity-manager processor comprises at least one computer activity-cancellation processor structured and arranged to cancel at least one request to participate in at least one multiple-person proposed activity. Even further, it provides such a computer system wherein such computer activity-manager processor further comprises at least one computer activity-closing processor structured and arranged to close at least one multiple-person proposed activity to prevent participation request acceptance when closing conditions are met.

Even further, it provides such a computer system wherein such computer activity-manager processor further comprises at least one computer activity-re-opening processor structured and arranged to re-open participation request acceptance in at least one multiple-person proposed activity when re-opening conditions are satisfied. Even further, it provides such a computer system wherein such computer activity-manager processor further comprises at least one computer re-opening-communicator processor structured and arranged to automatically communicate such reopening of such at least one multiple-person proposed activity to the multiple persons relating to such at least one multiple-person proposed activity. Even further, it provides such a computer system wherein such closing conditions comprise at least one temporal condition and/or at least one attendance condition. Even further, it provides such a computer system wherein such re-opening conditions comprise at least one scheduled participant cancellation.

In accordance with another preferred embodiment hereof, this invention provides a method comprising the steps of: offering, by at least one social network web site to at least one other web site, integration of at least one social network web site feature of the at least one social network web site for display on such at least one other web site; integrating, upon acceptance of such offering, of at least one social network web site feature of the at least one social network web site for display on such at least one other web site; wherein users of the at least one other web site are permitted to access such at least one social network web site feature while at the at least one other web site.

### DEFINITIONS, ACRONYMS AND CROSS-REFERENCES

The following terms and acronyms are explained below as background and are used throughout the detailed description:

BLOG (Web log or Weblog). Any system that supports an online diary such as a personal chronological log of thoughts published on a Web page or a shared on-line journal where people can post diary entries about their personal experiences and hobbies.

Chat/Chat Room. Any system that allows any number of users to have a typed (and/or voice-based), real-time, on-line conversation, either by all users logging into the same computer, or more commonly nowadays, via a network. Using special software, Internet users can enter chat areas or “virtual spaces” where they can communicate in real time.

Client-Server. A model of interaction in a distributed system in which a program at one site sends a request to a program at another site and waits for a response. The requesting program is called the “client”, and the program that responds to the request is called the “server”. In the context of the World Wide Web, the client is typically a “Web browser” that runs on a user's computer; the program that responds to Web browser requests at a Web site is commonly referred to as a “Web server”.

Database. One or more large structured sets of persistent data maintained upon a computer system organized and structured according to a software system defining rules for organization as well responding to queries to read, write, or modify data as well as provide statistical information regarding the contained data. As used herein for purposes of discussion, a database may be either a single unified system or a distributed system wherein certain database elements are located upon different systems, acting in harmony to appear as one unified database.

Domain Name System (DNS). An Internet service that translates domain names (which are alphabetic identifiers) into Internet Protocol (“IP”) addresses (which are numeric identifiers for machines on a TCP/IP network).

Email. A system for sending and receiving messages electronically over a computer network, as between personal computers.

Extensible Markup Language (XML). XML describes a class of data objects known as XML documents and partially describes the behavior of computer programs which process these documents. More specifically, XML is a restricted form of the Standard Generalized Markup Language (also known as SGML). XML documents are made up of storage units defined as entities which in turn comprise either parsed or unparsed data in the form of characters or simply a character. XML is designed and intended to improve the functionality of the Internet by providing more flexible and adaptive forms of information. XML can be used to store any kind of structured information and in such encapsulated form, pass it between different computer systems which would otherwise be unable to communicate.

Hypertext Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other Web sites and other Web documents (commonly referred to as “hyperlinks”). For more information on HTML, see Ian S. Graham, The HTML Source Book, John Wiley and Sons, Inc., 1995 (ISBN 0471-11894-4).

Hypertext Transport Protocol (HTTP). The standard World Wide Web client-server protocol used for the exchange of information (such as HTML documents and client requests for such documents) between a Web browser and a Web server. HTTP includes a number of different types of messages that can be sent from the client to the server to request different types of server actions. For example, a “GET” message, which has the format GET, causes the server to return the document or file located at the specified Universal Resource Locator (URL).

HTTPS. HTTP over SSL (Secure Sockets Layer) can be best understood as a secure form of HTTP communication. Specifically, SSL is a protocol utilized for the authentication and encryption of HTTP traffic. In operation, the server and client exchange a set of encryption keys that are used to create a unique encryption key used to encrypt all data exchanged during the session.

Inline FRAME. A floating frame, with content just like an ordinary frame, included in the HTML 4 standard. Inline Frames are useful for maintaining a frame of information on the user's display at all time even when the underlying content is scrolled up or down.

Instant Messaging. Abbreviated “IM”, a type of communications service that enables one to create a kind of private chat room with another individual in order to communicate in real time over the Internet; IM is analogous to a telephone conversation but using text-based, not voice-based, communication. Typically, the instant messaging system alerts you whenever somebody on your private list is online. You can then initiate a chat session with that particular individual.

Internet. A collection of interconnected (public and/or private) networks that are linked together by a set of standard protocols to form a distributed network. While this term is intended to refer to what is now commonly known as the Internet, it is also intended to encompass variations that may be made in the future, including changes and additions to existing standard protocols.

LAN. A Local Area Network of computer systems, typically within a building or office, permitting networking, the associated sharing of resources and files, such as application software, printers, and client information, in an inter-office setting.

Native Application. An application designed to run in the computer environment (machine language and OS) being referenced. The term is used to contrast a native application with an interpreted one such as a Java application that is not native to a single platform. The term may also be used to contrast a native application with an emulated application, which was originally written for a different platform.

PHP. A server-side, cross-platform, HTML-embedded scripting language used to create dynamic Web pages. PHP is Open Source software.

Push Service. A “Push Service” describes a style of Internet-based communication where the request for a given transaction is initiated by the publisher or central server. It is contrasted with “pull technology”, where the request for the transmission of information is initiated by the receiver or client.

Short Message Service (SMS). A service available on most digital mobile phones (and other mobile devices, e.g., a “Pocket PC”, or occasionally even desktop computers) that permits the sending of short messages (also known as text messages, or more colloquially SMSes, texts or even txts) between mobile phones, other handheld devices and even landline telephones. Messages are sent via a store-and-forward mechanism to a Short Message Service Center (SMSC), which will attempt to send the message to the recipient. If the user is not reachable at a given moment, the SMSC will save the message. Later when the user is reachable, the SMSC will retry the delivery process.

Structured Query Language (SQL). SQL is a standard language used to communicate with relational database management systems (such as Oracle, Sybase, Microsoft SQL Server, Access, etc.) for the purpose of performing tasks such as data insertion, deletion, update, and general query for the return of data.

The Simple Object Access Protocol (SOAP). SOAP is a lightweight XML/HTTP-based protocol for the exchange of information in a decentralized distributed platform-independent environment. Fundamentally, SOAP consists of three parts. The first is an envelope that defines a framework for describing what is contained in the message and how it should be processed. The second is a set of encoding rules for expressing instances of application-defined data types. The third is a normalized convention for representing remote procedure calls and responses.

Transmission Control Protocol/Internet Protocol (TCP/IP). A standard Internet protocol (or set of protocols) which specifies how two computers exchange data over the Internet. TCP/IP handles issues such as packetization, packet addressing, and handshaking and error correction. For more information on TCP/IP, see Volumes I, II and III of corner and Stevens, Internetworking with TCP/IP, Prentice Hall, Inc., ISBNs 0-13-468505-9 (vol. I), 0-13-125527-4 (vol. II), and 0-13-474222-2 (vol. III).

Uniform Resource Locator (URL). A unique address which fully specifies the location of a file or other resource on the Internet. The general format of a URL is protocol://machine address:port/path/filename. The port specification is optional, and, if not entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

WAN. A Wide Area Network, such as the Internet.

World Wide Web (“Web”). Used herein to refer generally to both (1) a distributed collection of interlinked, user-viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the Hypertext Transfer Protocol (HTTP), and the electronic pages are encoded using the Hypertext Markup Language (HTML). However, the terms “World Wide Web” and “Web” are intended to encompass future markup languages and transport protocols that may be used in place of or in addition to the Hypertext Markup Language (HTML) and the Hypertext Transfer Protocol (HTTP).

### BRIEF DESCRIPTION OF THE DRAWINGS

FIG. 1 shows a diagrammatical overview of the network communications used in the instant system according to a preferred embodiment of the present invention.

FIG. 2 shows a simplified functional diagrammatical overview of the relationship among the Web site server and users of the instant system according to a preferred embodiment of the present invention.

FIG. 3 shows a simplified functional diagrammatical overview of the relationship between the Web server and the Matchmaker Web site and its primary functions, according to the preferred embodiment of FIG. 1.

FIG. 4 shows a summary schematic of the primary entities and their relationships associated with the instant system and method, according to the preferred embodiment of the present invention.

FIG. 5 shows a summary schematic of the primary steps which may be completed in the instant system and method, according to the preferred embodiment of the present invention.

FIG. 6 shows an example of a screen for the Web site home page screen presented to visitors according to a preferred embodiment of the present invention.

FIG. 7 shows an example of a welcome screen displayed after member login according to a preferred embodiment of the present invention.

FIG. 8 shows an example of a member registration screen used to register new members according to a preferred embodiment of the present invention.

FIG. 9 shows an example of a singles member profile screen that is completed by new single members according to a preferred embodiment of the present invention.

FIG. 10 shows an example of a screen used by members to add a photo their member profile according to a preferred embodiment of the present invention.

FIG. 11 shows an example of a couple's member profile screen that is completed by new members joining as a couple according to a preferred embodiment of the present invention.

FIG. 12 shows an example of a team's member profile screen that is completed by new members joining as a team according to a preferred embodiment of the present invention.

FIG. 13 shows an example of a Match Request screen used by members to input desired match information for a particular activity, usually a sport-related activity, according to a preferred embodiment of the present invention.

FIG. 14 shows an example of a screen reminding a member that a new sports skill will be added to their profile when requesting a match according to a preferred embodiment of the present invention.

FIG. 15 shows an example of a quick search screen used to find a member by their screen name according to a preferred embodiment of the present invention.

FIG. 16 shows an example of a member search screen which permits a member to search for members with specific attributes according to a preferred embodiment of the present invention.

FIG. 17 shows an example of kids search screen which permits a member to search for kids with a specific set of attributes according to a preferred embodiment of the present invention.

FIG. 18 shows an example of a member search results screen according to a preferred embodiment of the present invention.

FIG. 19 shows an example of a completed member profile according to a preferred embodiment of the present invention.

FIG. 20 shows an example of a member's favorites list screen according to a preferred embodiment of the present invention.

FIG. 21 shows an example of a member's photo screen according to a preferred embodiment of the present invention.

FIG. 22 shows an example of an email screen permitting members to email each other according to a preferred embodiment of the present invention.

FIG. 23 shows an example of an instant messaging screen permitting members to message each other according to a preferred embodiment of the present invention.

FIG. 24 shows an example of a Match Search screen for searching for members that have entered desired match information according to a preferred embodiment of the present invention.

FIG. 25 shows an example of a Search Results screen displaying all members' profile information for members having input match information matching search criteria entered by a member according to a preferred embodiment of the present invention.

FIG. 26 shows an example of a bulletin board search screen permitting a member to search for possible match requests posted to the bulletin board according to a preferred embodiment of the present invention.

FIG. 27 shows an example of a bulletin board posting matching a member's search according to a preferred embodiment of the present invention.

FIG. 28 shows an example of a bulletin board post screen which permits a member to add a new bulletin board posting according to a preferred embodiment of the present invention.

FIG. 29 shows an example of a directory search screen which permits members to search for Advertisers according to a preferred embodiment of the present invention.

FIG. 30 shows an example of location listing screen for a member's search criteria according to a preferred embodiment of the present invention.

FIG. 31 shows an example of a map request screen for obtaining a map or directions to a selected advertiser's location according to a preferred embodiment of the present invention.

FIG. 32 shows an example of an advertiser information screen used by prospective Advertisers according to a preferred embodiment of the present invention.

FIG. 33 shows an example of the first sign up screen used by an advertiser to place the information on the Web site according to a preferred embodiment of the present invention.

FIG. 34 shows an example of advertiser or location provider instructions screen for guiding Advertisers through the set up process according to a preferred embodiment of the present invention.

FIG. 35 shows an example of an advertising help screen which provides answers to Advertisers' frequently asked questions according to a preferred embodiment of the present invention.

FIG. 36 shows an example of a member's shopping opportunities screen displaying retailers offering discounts through the Web site according to a preferred embodiment of the present invention.

FIG. 37 shows an example of a member's shopping opportunities screen displaying Advertisers and retailers, within a particular category, offering discounts through the Web site according to a preferred embodiment of the present invention.

FIG. 38 shows an example of a chat screen used by members to chat when both are online according to a preferred embodiment of the present invention.

FIG. 39 shows an example of an alternate Search Results screen displaying all members' profile information for members having input match information matching search criteria entered by a member according to a preferred embodiment of the present invention.

FIG. 40 shows an example of a member profile that may be sent via text (SMS) messaging screen to another member according to a preferred embodiment of the present invention.

FIG. 41 shows an example of a text (SMS) messaging screen permitting members to text (SMS) message each other according to a preferred embodiment of the present invention.

FIG. 42 shows an example of an administrator's screen permitting approval or disapproval of advertisements submitted by Players Guide Advertisers according to a preferred embodiment of the present invention.

FIG. 43 shows an example of an advertiser edit screen permitting an advertiser to edit previously submitted advertisements according to a preferred embodiment of the present invention.

FIG. 44 shows an example of a user profile illustrating capability of member linking to a Player's Network according to a preferred embodiment of the present invention.

FIG. 45 shows an example of the Player's Network screen of a user according to a preferred embodiment of the present invention.

FIG. 46 shows an example of the Match Request Notification Service of the Player's Network screen according to a preferred embodiment of the present invention.

FIG. 47 shows an example of a Match Request Notification Service on the Matches screen according to a preferred embodiment of the present invention.

FIG. 48 shows an example of a Message Center screen according to a preferred embodiment of the present invention.

FIG. 49 shows an example of a One Click Match Join feature according to a preferred embodiment of the present invention.

FIG. 50 shows an example of a Match screen according to a preferred embodiment of the present invention.

FIG. 51 shows an example of a Match History feature of the My Confirmed Matches heading according to a preferred embodiment of the present invention.

FIG. 52 shows a simplified diagrammatic overview illustrating, in a simplified form, features of the instant system according to the preferred embodiment of the present invention.

FIG. 53 shows another simplified diagrammatic overview illustrating other features of the instant system according to the preferred embodiment of the present invention.

FIG. 54 shows a flowchart illustrating a preferred response management system of the instant system according to a preferred embodiment of the present invention.

FIG. 55 shows a simplified diagrammatic overview generally illustrating methods of communicating among users of the instant system according to the preferred embodiment of the present invention.

FIG. 56 shows a schematic diagram, illustrating installing mobile native application on mobile device, according to a preferred embodiment of the present invention.

FIG. 57 shows a schematic diagram, illustrating use of sports matchmaking system with a “Push Service”, according to a preferred embodiment of the present invention.

FIG. 58 shows a close up view of a mobile device according to a preferred embodiment of the present invention.

FIG. 59 shows a diagrammatic view illustrating user and systems interactions in an integrated matchmaker system, according to a preferred embodiment of the present invention.

FIG. 60 shows an exemplary screenshot view illustrating administration of an integrated matchmaker system according to the preferred embodiment of FIG. 59.

FIG. 61 shows an exemplary screenshot view, illustrating an administrative account screen, according to the preferred embodiment of FIG. 59.

FIG. 62 and FIG. 63 show exemplary screenshot views, illustrating private-labeled user introductory screens, according to the preferred embodiment of FIG. 59.

FIG. 63 shows an exemplary screenshot view, illustrating a member search results screen, according to the preferred embodiment of FIG. 59.

FIG. 64 shows an exemplary screenshot view, illustrating a member database content screen, according to the preferred embodiment of FIG. 59.

FIG. 65, FIG. 66, and FIG. 67 show exemplary screenshot views, illustrating user referral screens, according to the preferred embodiment of FIG. 59.

FIG. 68 shows an exemplary screenshot view, illustrating an activity event screen, according to the preferred embodiment of FIG. 59.

FIG. 69 shows an exemplary screenshot view, illustrating an activity invitation, according to the preferred embodiment of FIG. 59.

FIG. 70A and FIG. 70B show exemplary screenshot views, illustrating an activity detail screen, according to the preferred embodiment of FIG. 59.

FIG. 71, FIG. 72 and FIG. 73 show exemplary screenshot views, illustrating referral handling, according to the preferred embodiment of FIG. 59.

### DETAILED DESCRIPTION OF THE BEST MODES AND PREFERRED EMBODIMENTS OF THE INVENTION

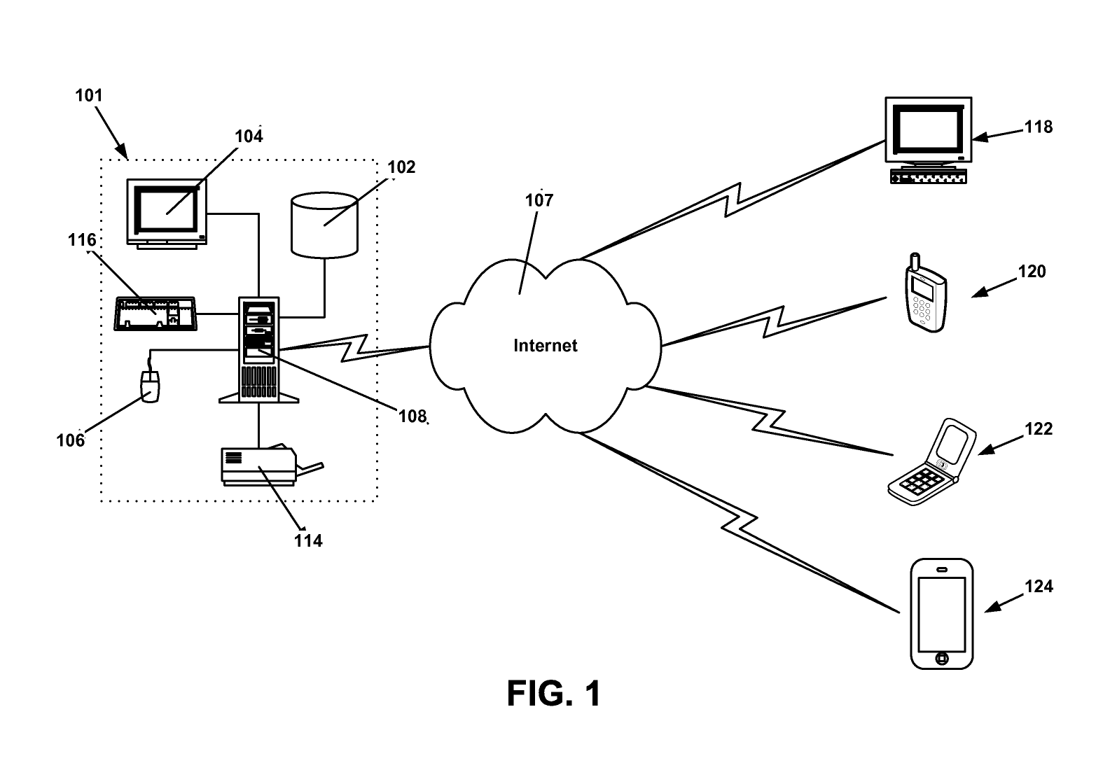

FIG. 1 shows a diagrammatical overview of the network communications used in the instant system according to a preferred embodiment of the present invention. A preferred embodiment comprises matchmaker computer system 101 preferably connected by way of the Internet 107 to users 118, 120, 122 and 124.

Matchmaker computer system 101 preferably comprises computer system 108 which comprises input and output devices, processors, storage, and memory. Computer system 108 preferably comprises display screen or monitor 104, keyboard 116, printer 114, and mouse 106. Computer system 108 further preferably comprises database 102 (at least embodying herein computer personal-profile database means for searchably storing personal profile data relating to at least one plurality of registered users of at least one computer network and computer proposed-activity database means for searchably storing activity data, relating to at least one proposed multiple-person activity of at least one activity type, relating to at least one registered user of the at least one computer network; and also at least embodying herein at least one computer personal-profile database structured and arranged to searchably store personal profile data relating to at least one plurality of registered users of at least one computer network, and at least one computer proposed-activity database structured and arranged to searchably store activity data, relating to at least one proposed multiple-person activity of at least one activity type, relating to at least one registered user of the at least one computer network). Computer system 108 also preferably comprises storage and memory for storage and execution of software comprising preferred embodiments of the present invention. Computer system 108 is preferably connected to the Internet 107 that serves as a preferred communications medium using Hypertext Transport Protocol (“http”) as a preferred protocol. The Internet 107 comprises a global network of networks and computers, both public and private. The Internet 107 is the preferred connection method by users 118, 120, 122 and 124 in some preferred embodiments of the present invention.

Upon reading the teachings of this specification, those with ordinary skill in the art will now understand that, under appropriate circumstances, considering such issues as network traffic issues, capacity issues, etc., other hardware arrangements of matchmaking computer system such as multiple processors, multiple databases, distributed systems, etc., may suffice.

As discussed further herein, users preferably communicate with matchmaker computer system 101 in various ways. In some instances, users communicate with matchmaker computer system 101 via a Web browser installed on a personal computer (user 118). In this instance, user 118 accesses matchmaker web site 300 with an Internet Web browser such as Microsoft and Internet Explorer or Mozilla Firefox. In other instances, users preferably communicate with matchmaker computer system 101 via a web browser on a mobile device, such as a smart phone (user 120). User 120 preferably accesses matchmaker web site 300 with an Internet web browser installed on the mobile device. In still other instances, users preferably communicate with matchmaker computer system 101 via SMS text messaging or using a mobile telephone (user 122) [and preferably in response to a request to “join” a match as discussed further herein]. In the SMS text messaging instance, messages are preferably processed with the assistance of an SMS Gateway (such as CELLTRUST® Corporation of Scottsdale, Ariz.). And, users preferably communicate with matchmaker computer system 101 using a mobile device (such as an APPLE IPHONE mobile device) having application software (e.g., a native application as discussed further herein) to interact with matchmaker computer system 101 (user 124).

Preferably, users of matchmaker computer system 101 use the above described components to communicate with a social network established with the assistance of matchmaker computer system 101. Preferably, all methods of communication described above are available to users of matchmaker computer system 101 to provide multiple avenues of this “peer to network” communication.

Upon reading the teachings of this specification, those with ordinary skill in the art will now understand that, under appropriate circumstances, considering such issues as then-available technology and communication devices then-available, etc., other communication instruments to communicate with matchmaker computer system such as neural net linking, other wireless handheld devices, wireless, network-connected identification devices, etc., may suffice.

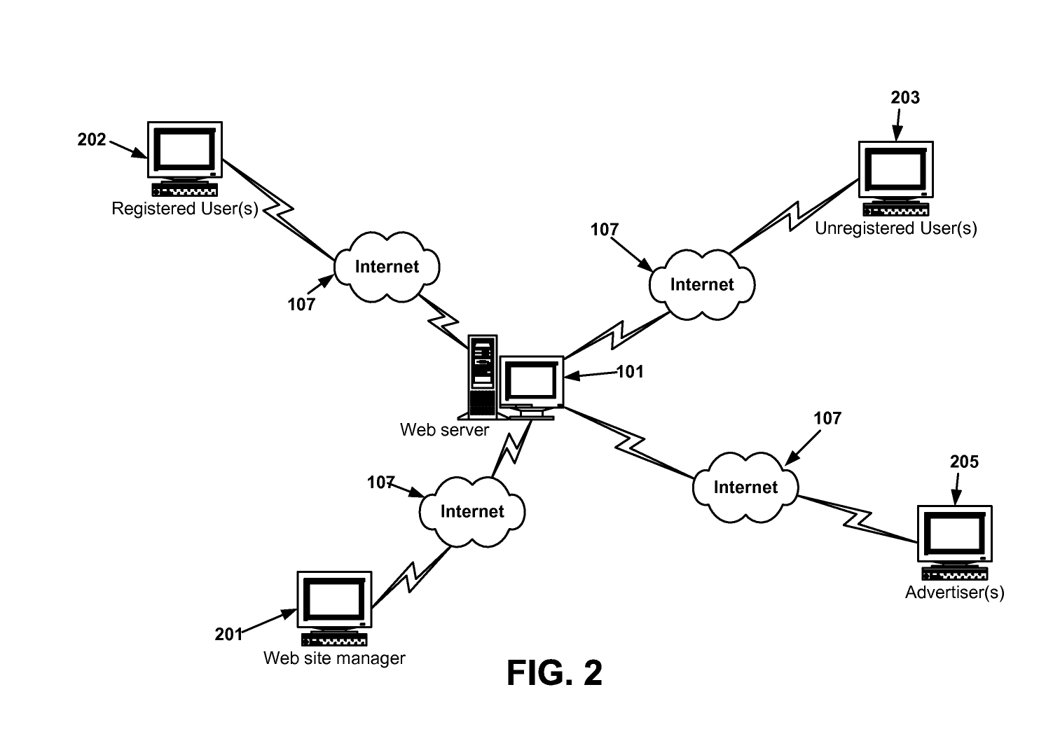

FIG. 2 shows a simplified functional diagrammatical overview of the relationship among matchmaker computer system 101 and users of the instant system according to a preferred embodiment of the present invention. Preferably, at least one Registered User 202 will use a Web browser, such as Internet Explorer, to connect to matchmaker computer system 101 through the Internet 107. Once connected, Registered User 202 will login and begin using the functions available to them. Similarly, at least one Unregistered User 203 will use a Web browser, such as Internet Explorer, to connect to matchmaker computer system 101 through the Internet 107. Once connected, Unregistered User 203 is preferably encouraged to register and become a member. Preferably, Unregistered User 203 is not required to register; however, unregistered users will not be able to utilize all the functions available to registered users until they register. Likewise, Advertiser 205 wishing to advertise on Web site 300 preferably uses a Web browser, such as Internet Explorer, to connect to matchmaker computer system 101 through use of the Internet 107 to set up and maintain their advertisements and advertising campaigns. Finally, Web site manager 201 also preferably uses a Web browser, such as Internet Explorer, to connect to matchmaker computer system 101 through use of the Internet 107 to operate and maintain Web site 301.

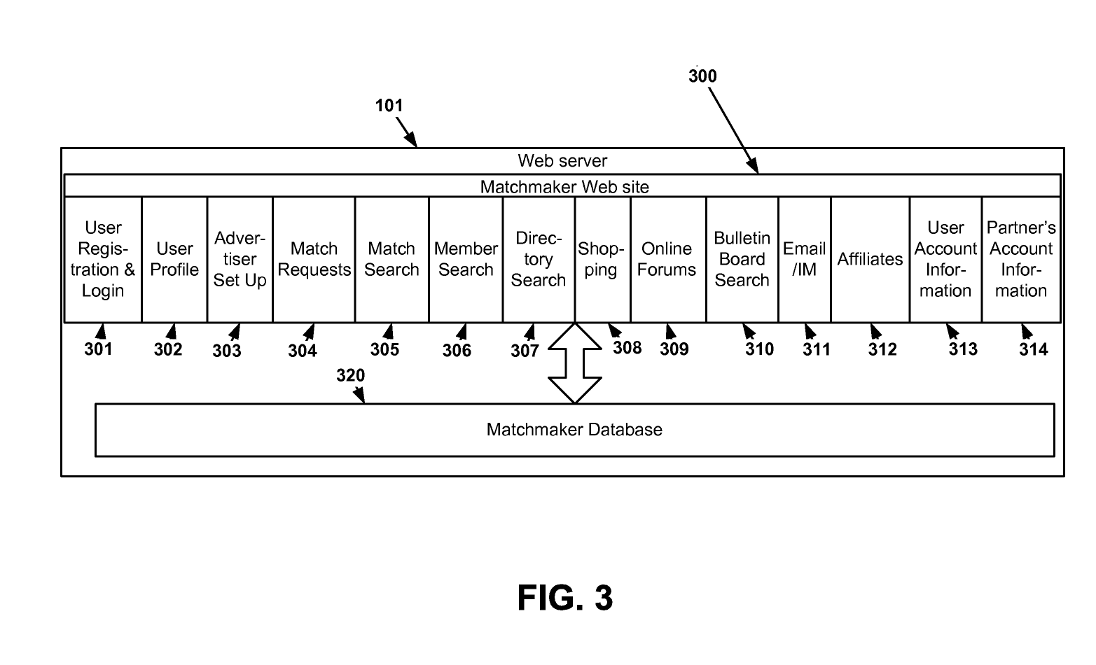

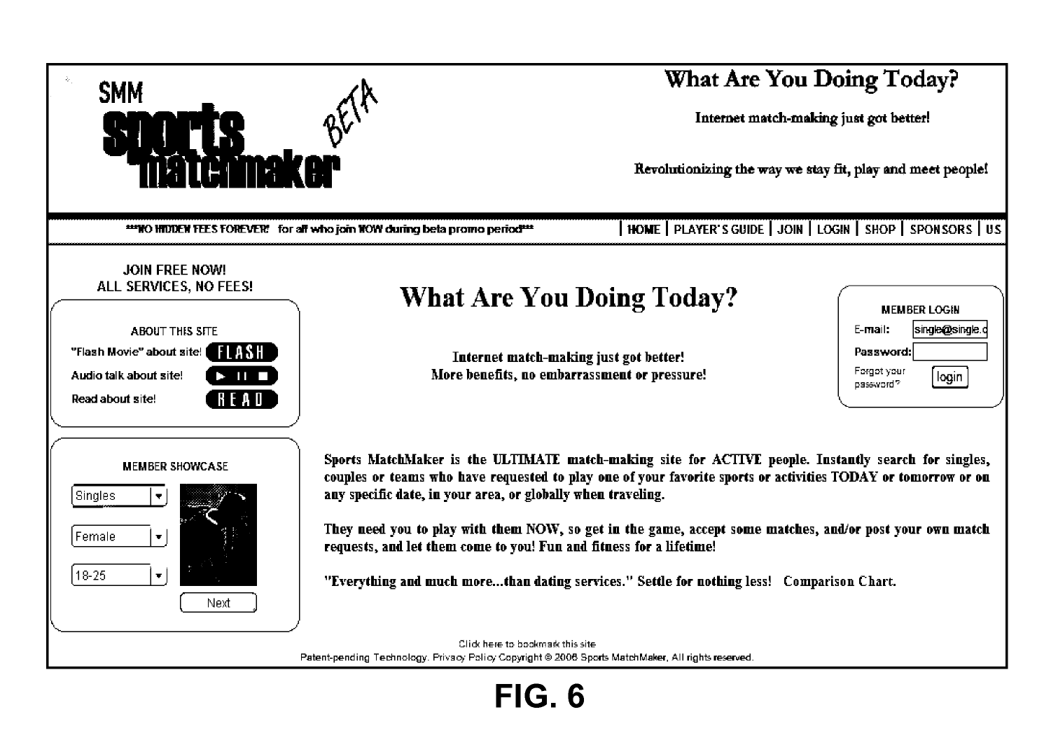

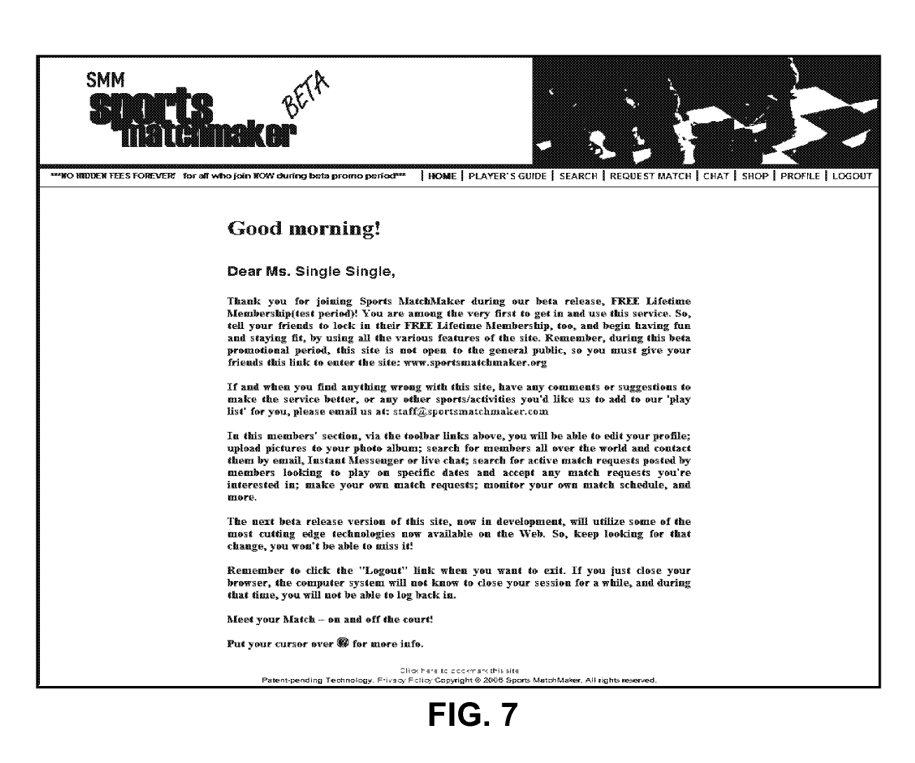

FIG. 3 shows a simplified functional diagrammatical overview of the relationship between matchmaker computer system 101 and the Matchmaker Web site 300 and its primary functions, according to the preferred embodiment of FIG. 1. Substantially all functional components and Matchmaker Database 320 of Web site 300 preferably reside on matchmaker computer system 101. The functional component User Registration & Login 301 preferably comprises login functions for Registered Users, and registration processes for Unregistered Users (see FIGS. 6-8). Such functional components preferably comprise User Registration & Login 301, User Profile 302, Advertiser Set Up 303, Match Requests 304, Match Search 305, Member Search 306, Directory Search 307, Shopping 308, Online Forums 309, Bulletin Board Search 310, Email/IM 311, Affiliates 312, User Account Information 313, and Partner's Account Information 314, as shown.

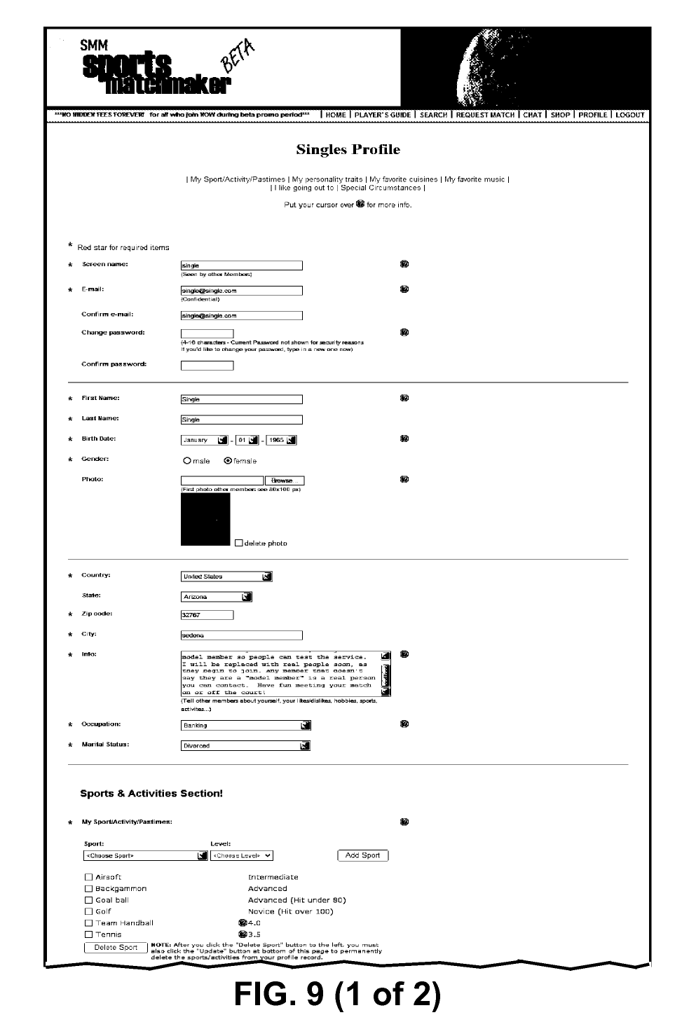

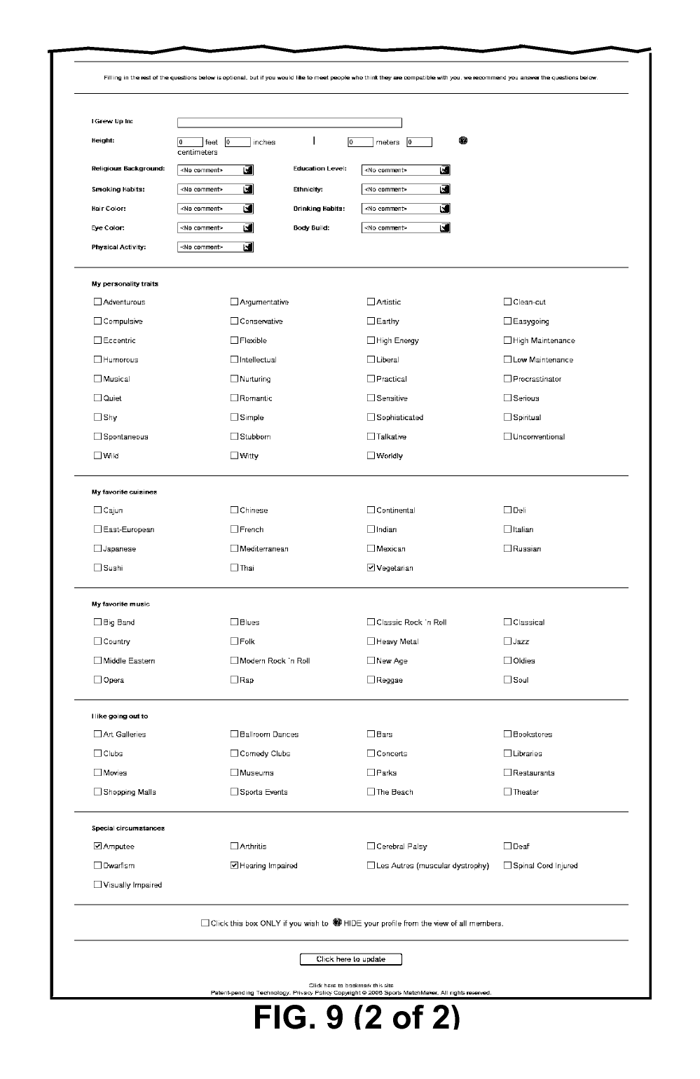

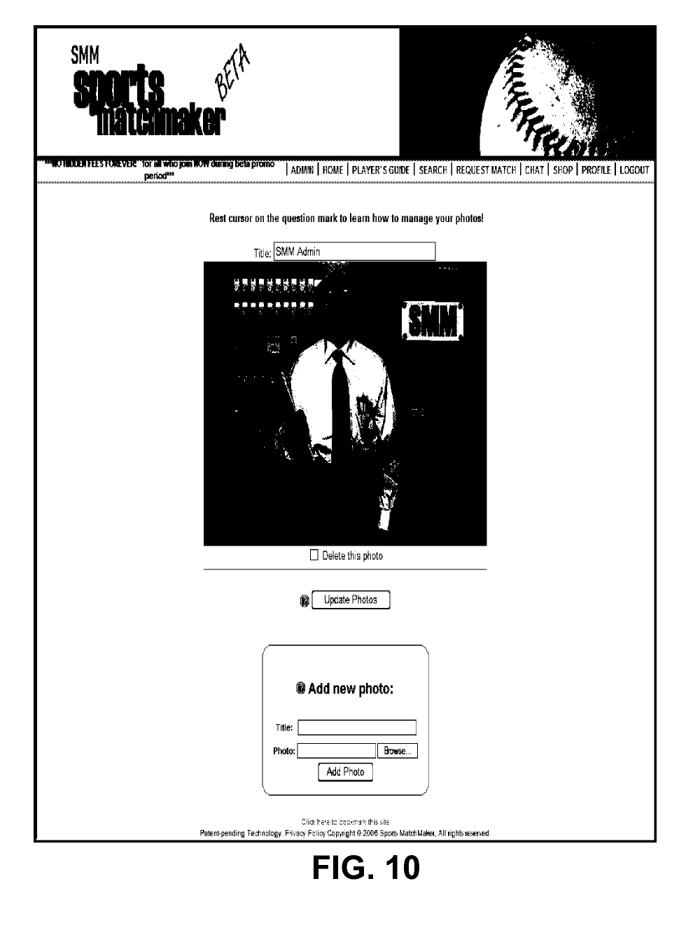

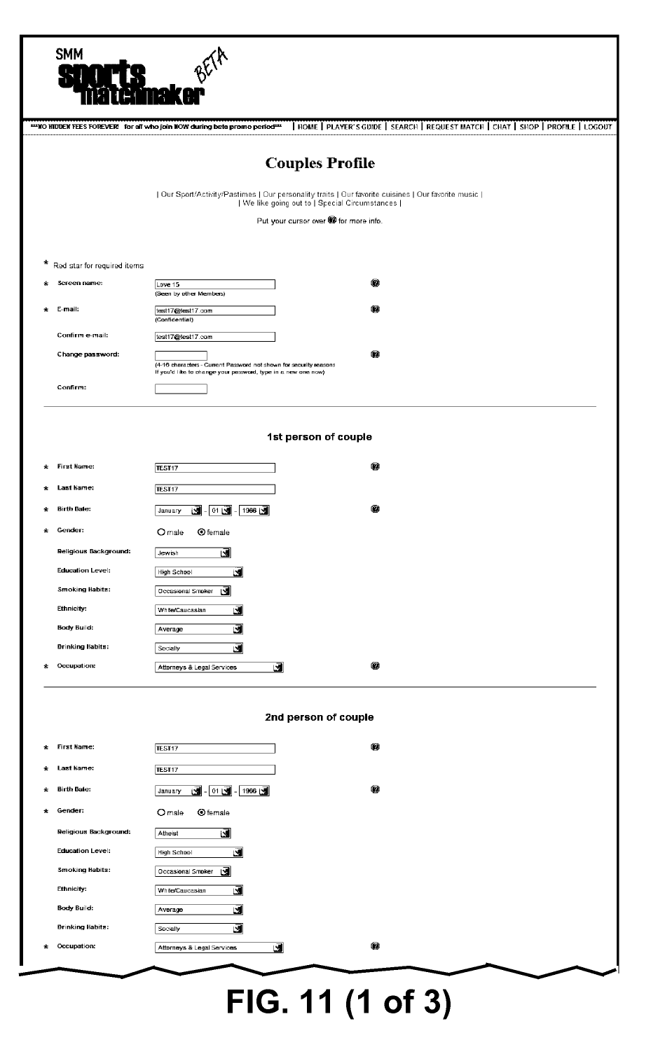

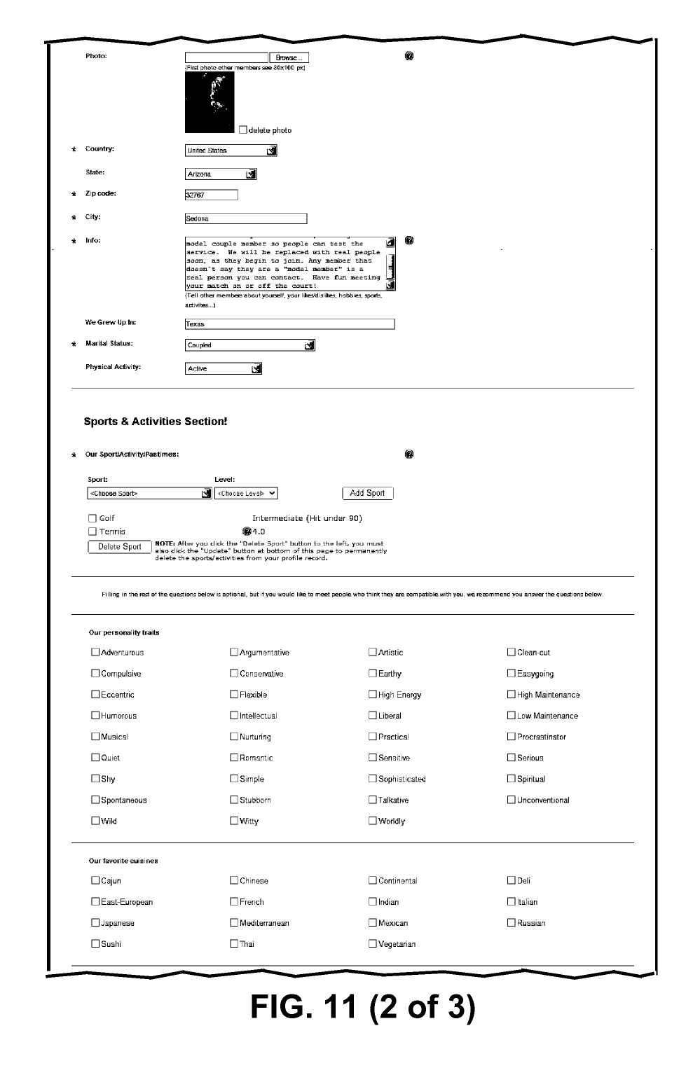

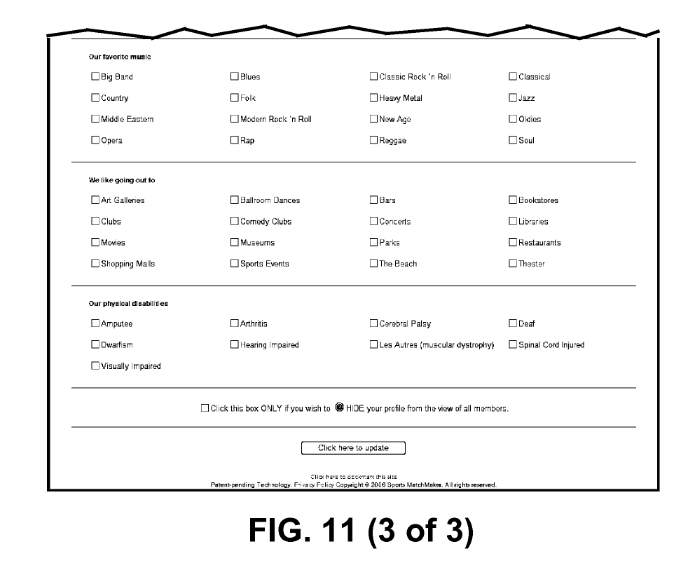

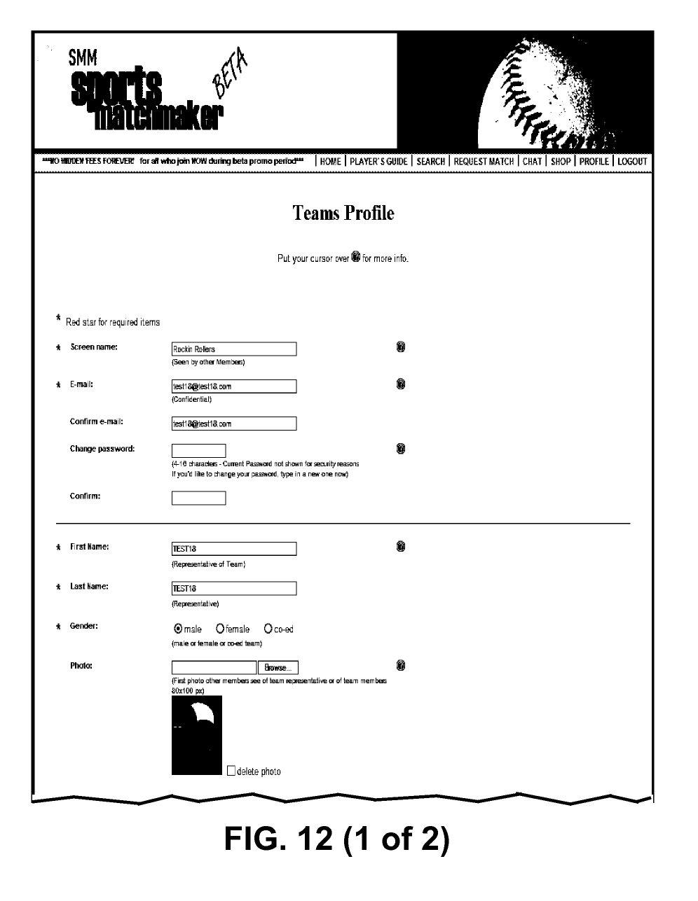

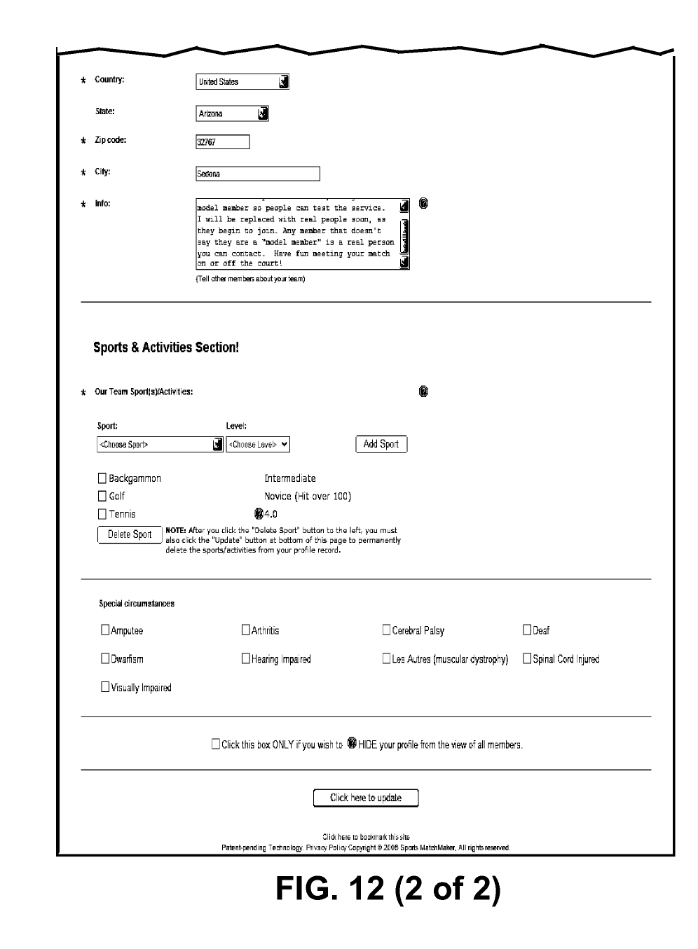

Functional component User Profile 302 permits Registered Users to create or update their profile information. Preferably, Unregistered Users may register and then complete the profile information as an individual, a couple, a team, or a parent who may complete a profile on behalf of his or her children (see FIG. 9, FIG. 10, FIG. 11, and FIG. 12) (at least herein embodying wherein at least one of such at least one first participant and such at least one second participant comprises at least one team; and at least herein embodying wherein at least one of such at least one first participant and such at least one second participant comprises at least one couple). Preferably, Registered Users also use User Profile 302 to update their profile information. Upon reading the teachings of this specification, those with ordinary skill in the art will now understand that, under appropriate circumstances, considering such issues as user preference, competitive requirements, etc., a searchable value such as an entity, which may be an employer, a company, a sports club, a hotel, a fitness center, other organizations, etc., may be input, stored, and associated with a Registered User.

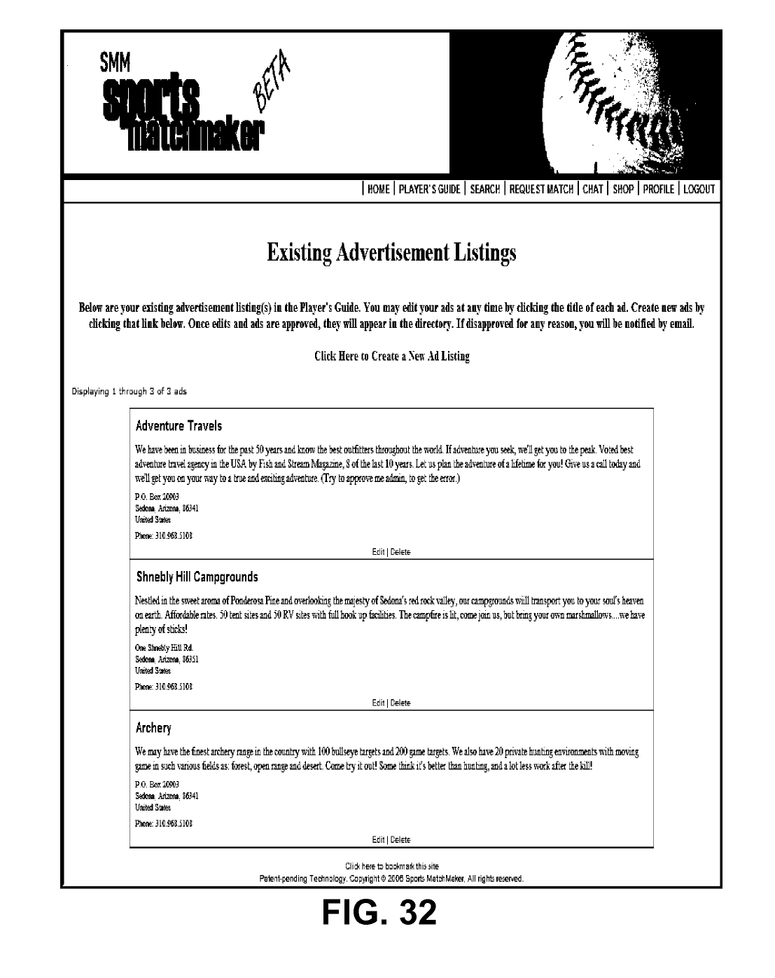

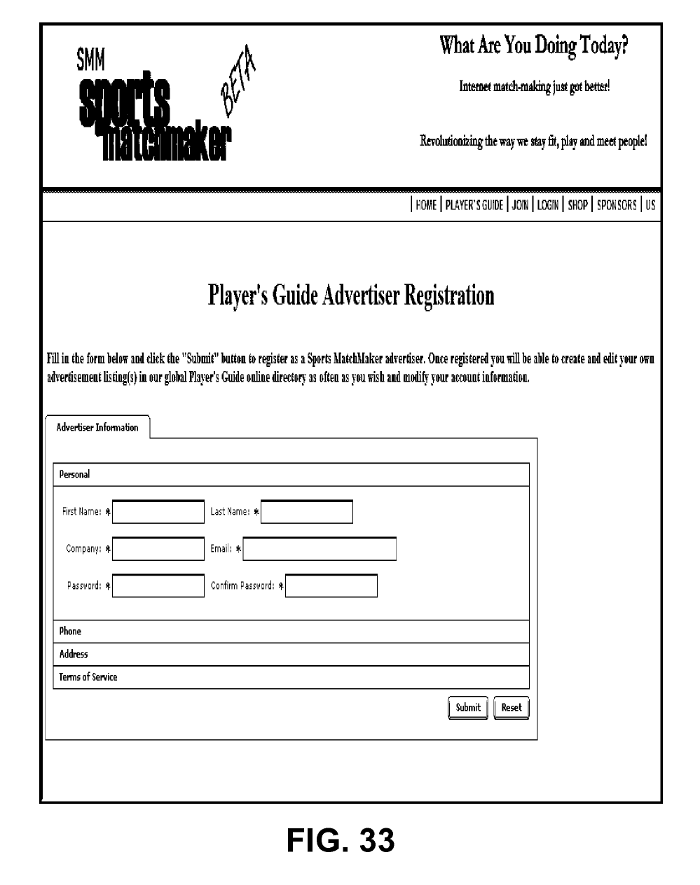

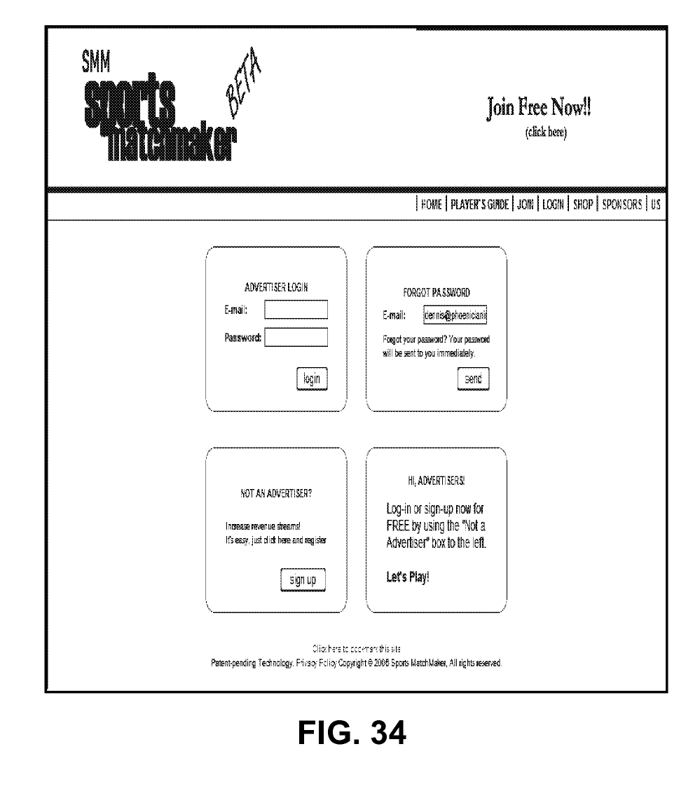

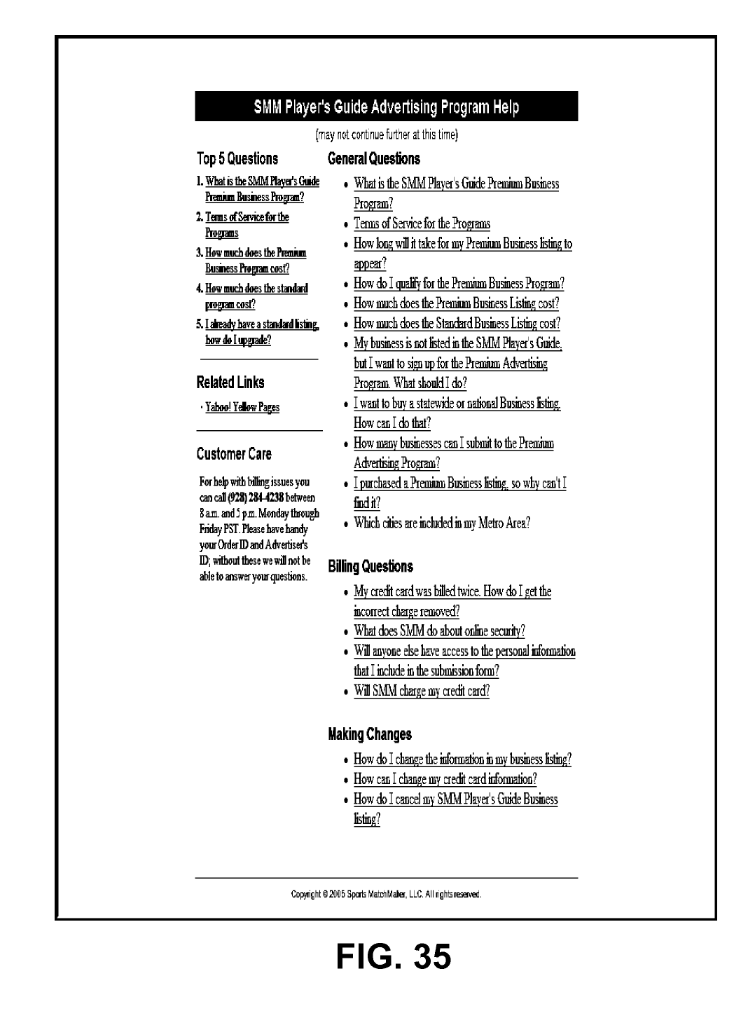

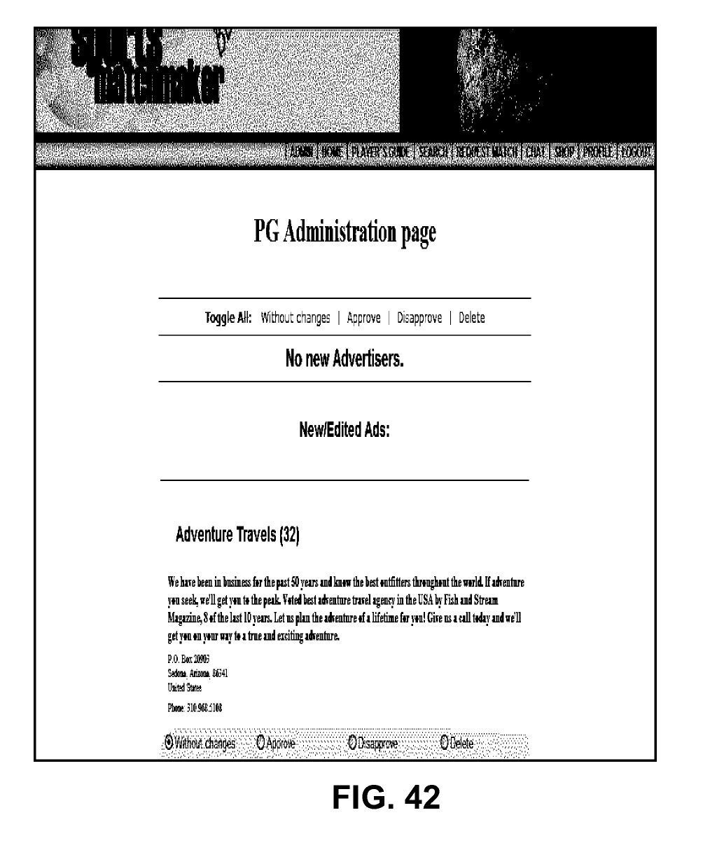

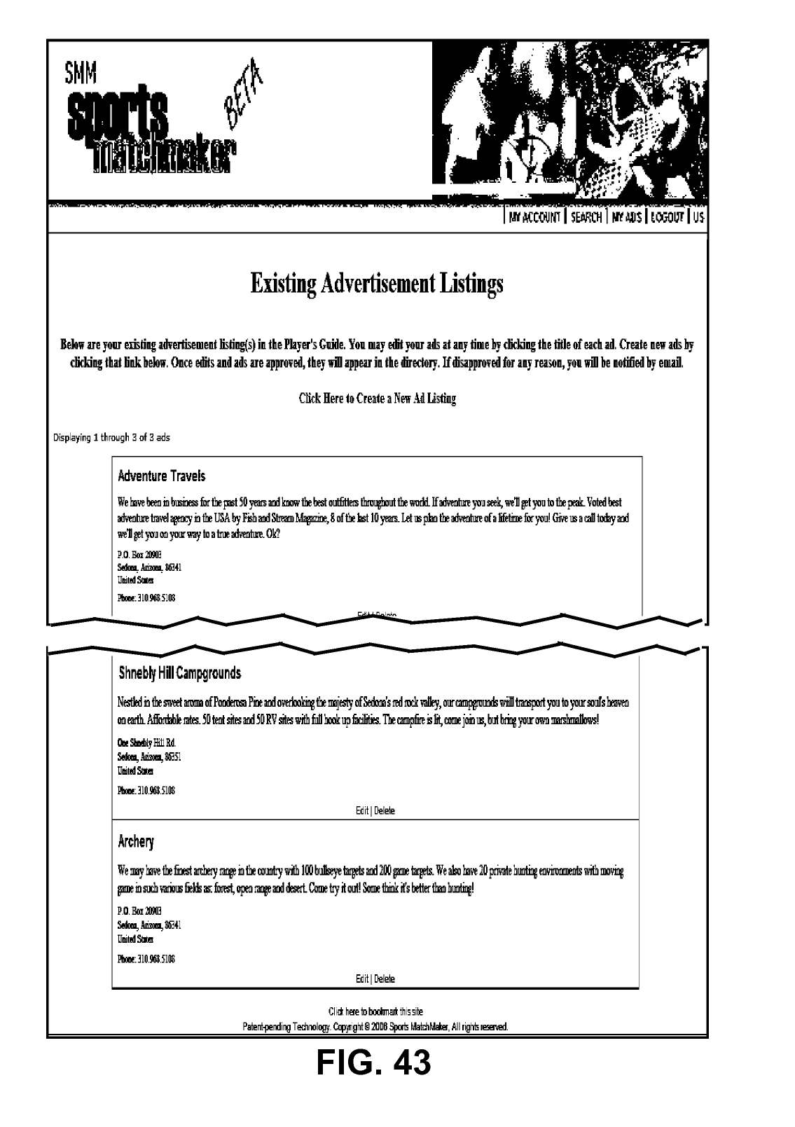

Advertiser Set Up 303 is preferably used to establish new Advertiser accounts, update existing Advertiser accounts, and create and modify advertising information to be displayed on Matchmaker Web site 300 as part of a directory of venues (Player's Guide). Preferably, Advertiser Set Up 303 also provides help instructions, frequently asked question lists, and advertising plan costs and benefit explanations, including preferred placement within the directory of business entities. Preferably, Advertiser 205 provides specific information about their business, its location, and any special offers (see FIG. 32, FIG. 33, FIG. 34, and FIG. 35). Preferably, Advertiser 205 may create Advertiser's own directory listing and then checkout by making the required payment using a credit card or other form of Internet-based payment, such as Pay-Pal. Preferably, after payment is made, the submitted advertisement is reviewed by Web site administrator (see FIG. 42) for approval. Preferably, if the advertisement is approved, Web site administrator will permit the advertisement to be posted in the directory requested by Advertiser 205. Preferably, Advertiser 205 may review approved directory listings (advertisements) and make changes or remove any or all directory listings (see FIG. 43) (at least herein embodying after such step of receiving payment, approving such at least one Web site advertisement; and at least herein embodying displaying such approved such at least one Web site advertisement).

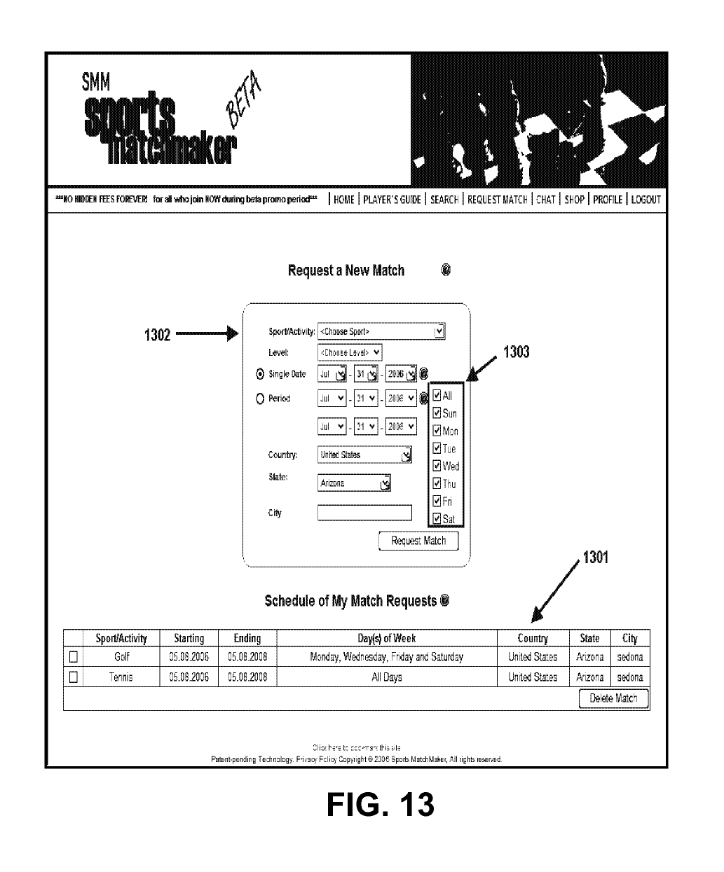

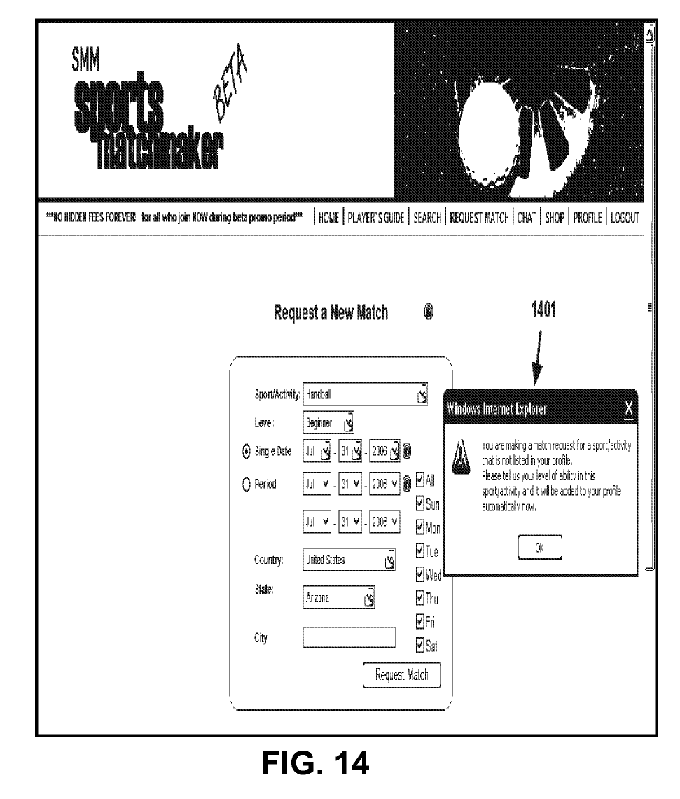

Match Request 304 is preferably used by a Registered Users to create and store an offer to meet another Registered User at a specific place and time for a sporting or social event (at least herein embodying computer database means for searchably storing proposed-event information wherein such proposed-event information comprises at least at least one type of proposed joint event, at least one proposed geographic area for such proposed joint event, and at least one proposed time frame for such at least one proposed joint event; at least herein embodying computer interface means for permitting database entry on behalf of such at least one first participant of such at least one proposed joint event; and at least herein embodying wherein such at least one type of proposed joint event comprises at least one sporting event). As shown in FIG. 13, preferably previous match requests made by Registered User 202 are listed in Schedule of My Match Requests 1301 (shown below Request Match Dialog 1302). Preferably, when a Registered User completes Request Match Dialog 1302 for a sport/activity not in their profile, Add Sport/Activity Reminder 1401 is presented as demonstrated in FIG. 14 (at least herein embodying computer processing means for retrieving on behalf of such at least one first participant such proposed-event information from such computer database means). Preferably, Registered User 202 may remove, or delete, any match request shown in Schedule of My Match Requests 1301.

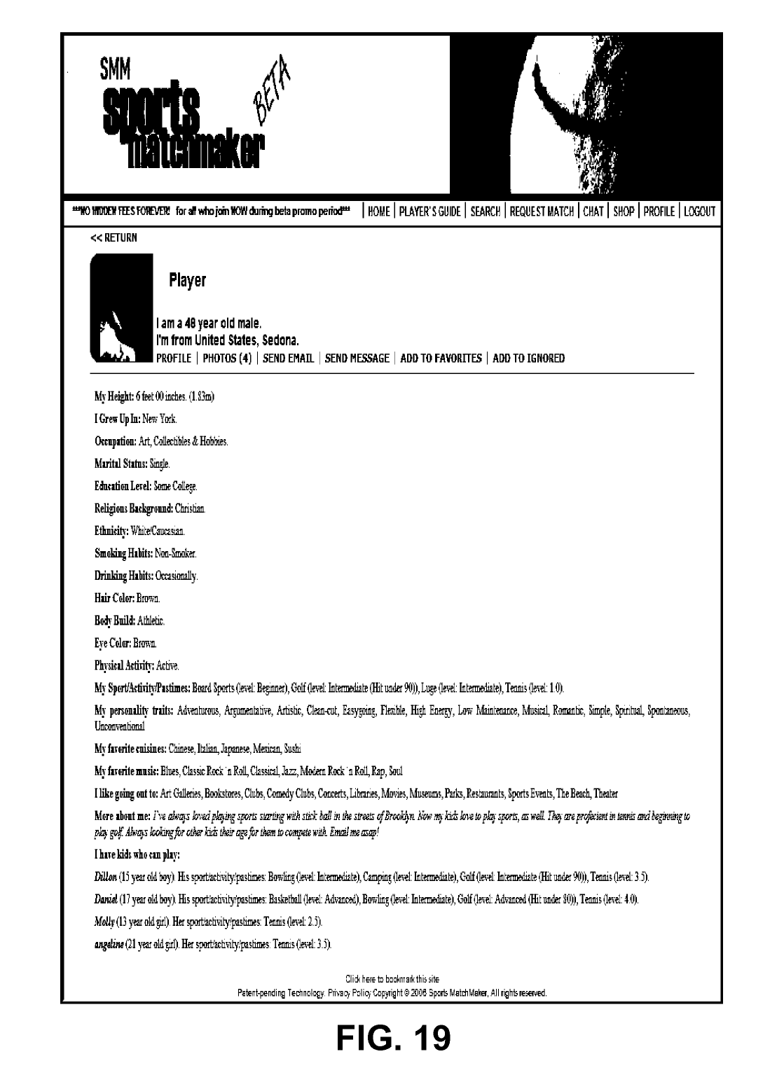

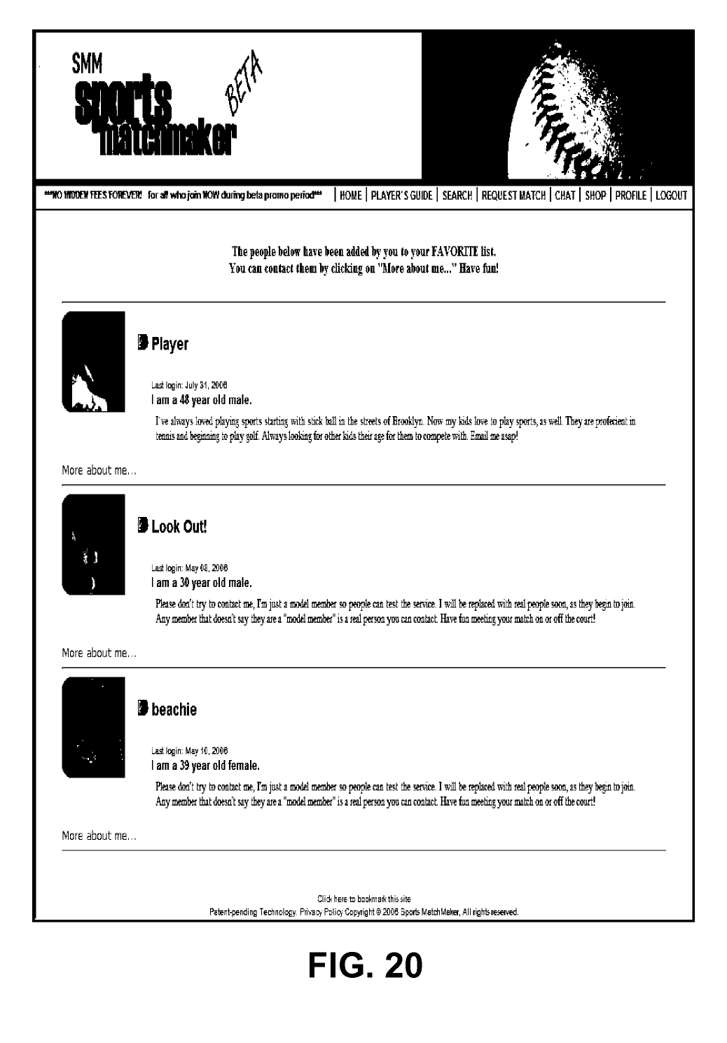

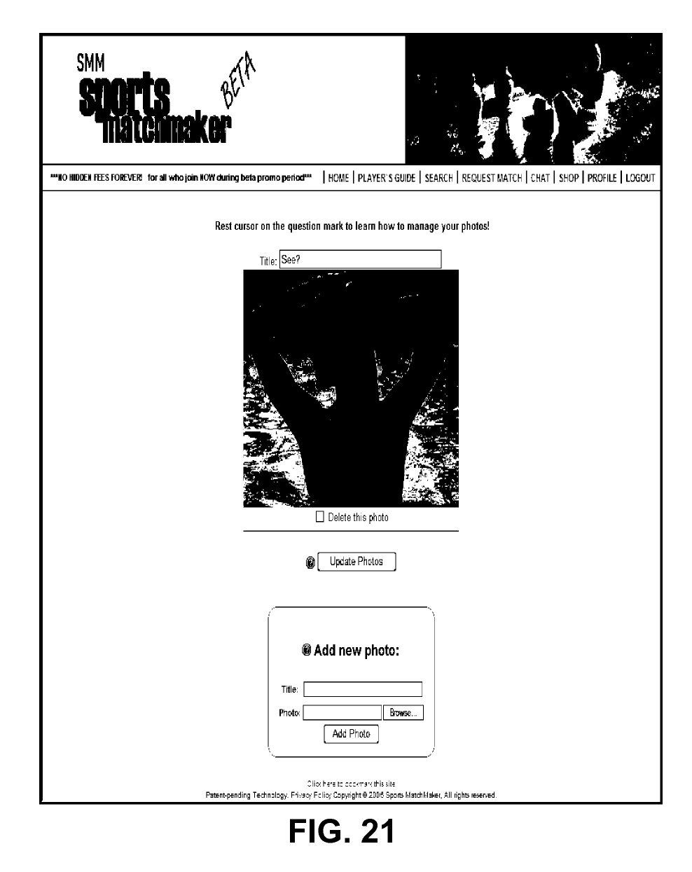

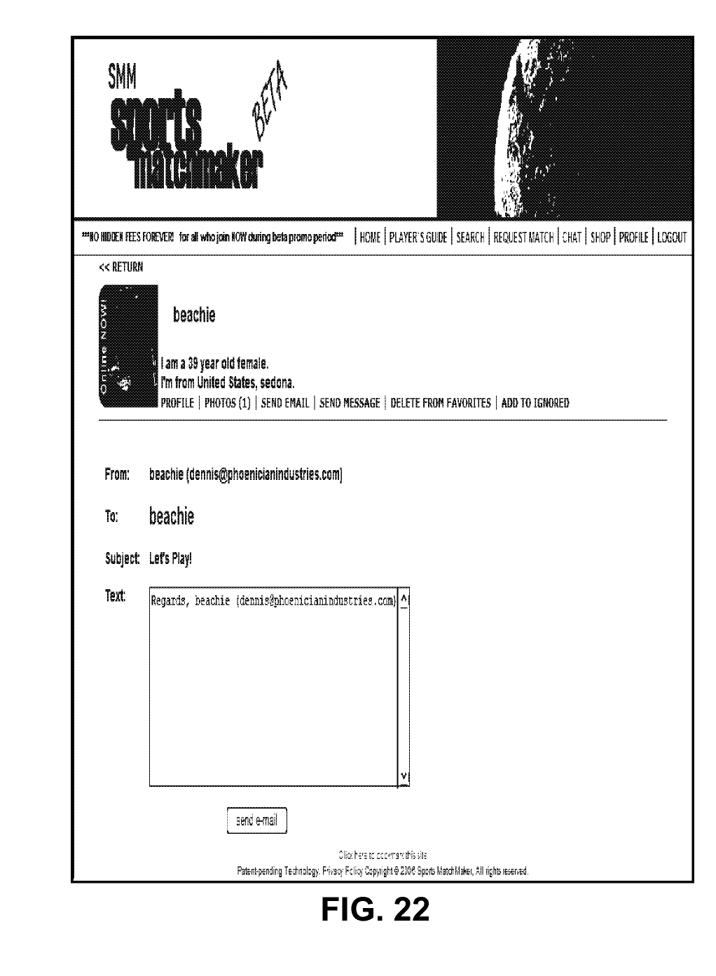

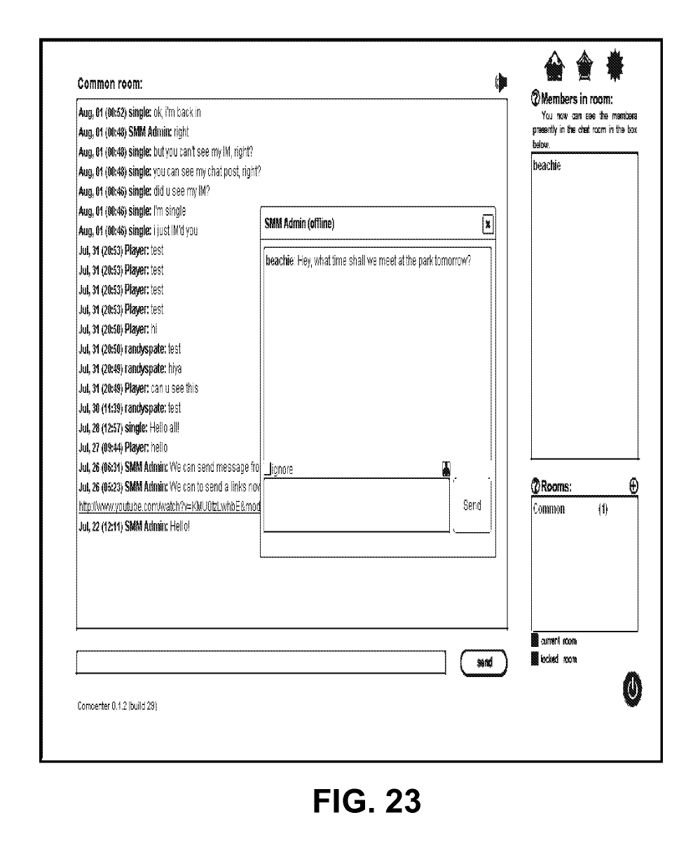

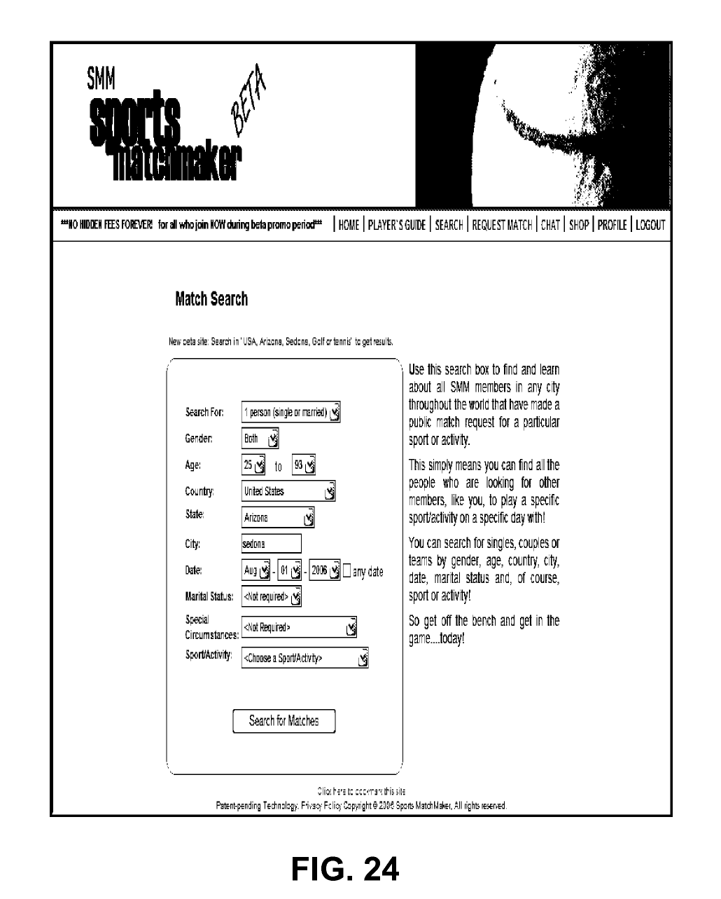

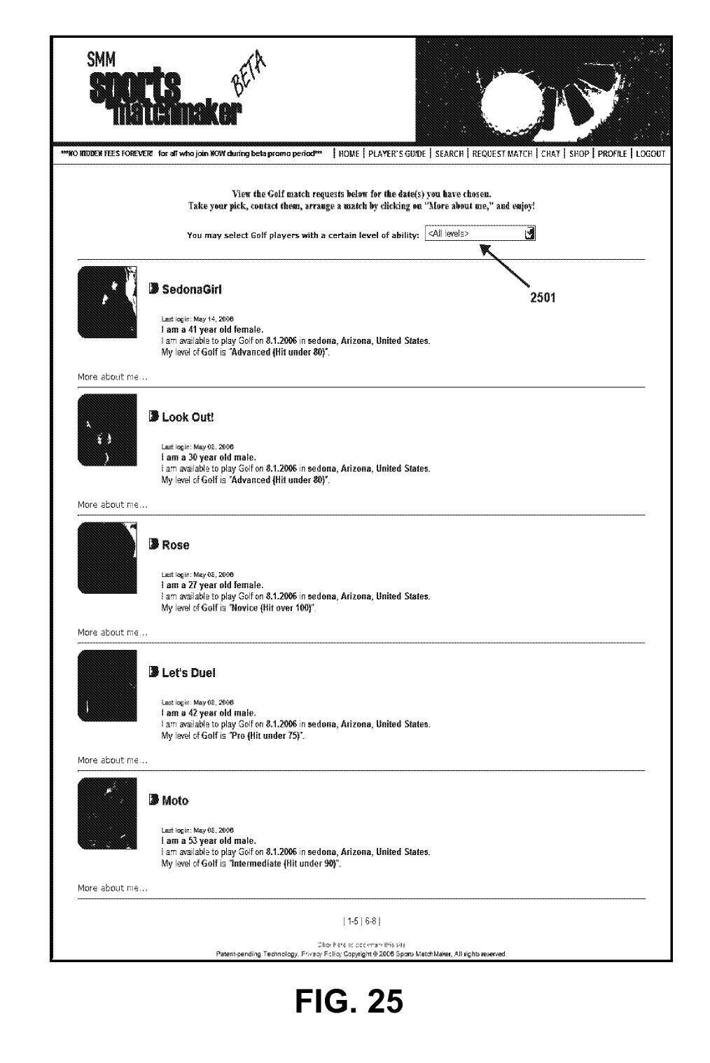

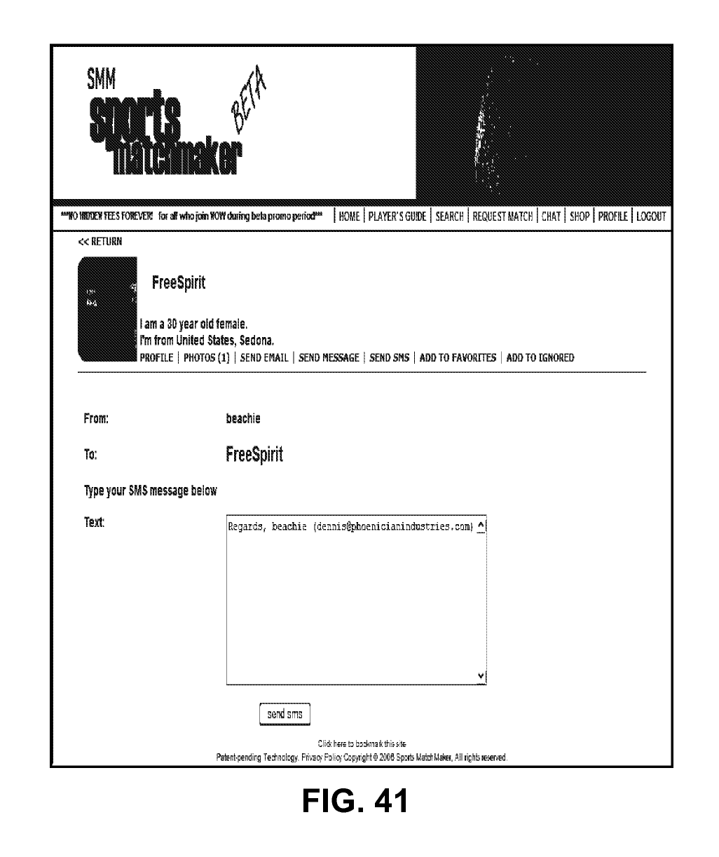

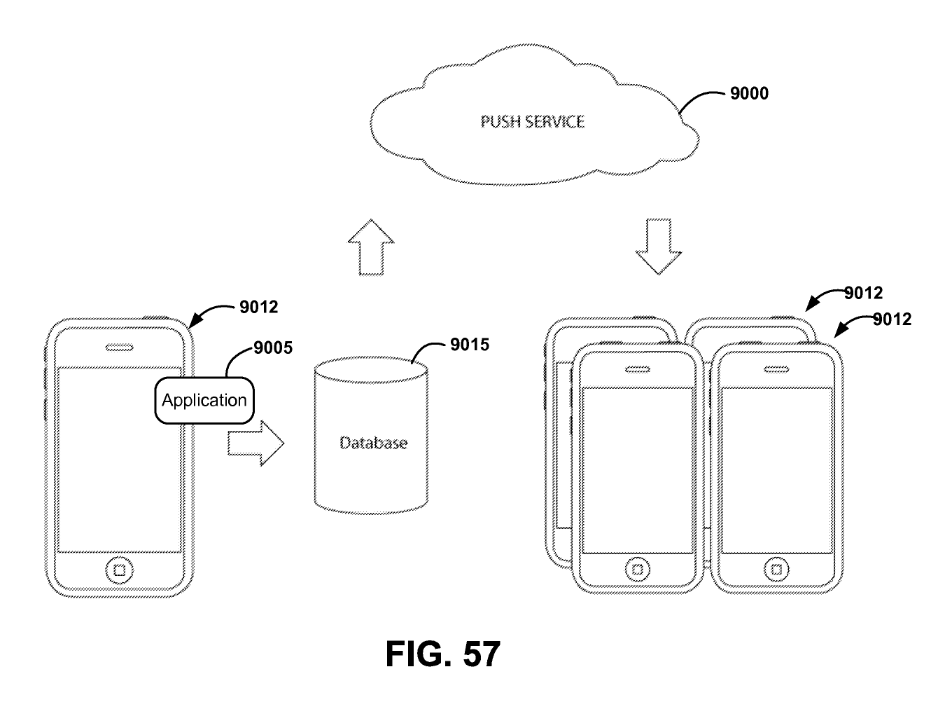

Preferably, functional component Match Search 305 provides a Registered User with the ability to input match criteria including sport/event, time frame, and location as well as selected personal criteria, including age, gender, and marital status. After inputting match criteria, a Registered User may then search Matchmaker Database 320 for all Registered Users having input match requests that meet such criteria, as shown in FIG. 24 (at least herein embodying computer interface means for permitting entry on behalf of such at least one second participant first searchable criteria for proposed matching of such at least one proposed joint event; and at least herein embodying computer processing means for retrieving from such computer database means such proposed-event information matching such first searchable criteria). As used herein, time frame may refer to a specific date and time, a range of dates, a range of times, or one or more specified days of the week, month, etc. FIG. 25 provides an example of match requests that fit the inputted criteria. Upon reading the teachings of this specification, those with ordinary skill in the art will now understand that, under appropriate circumstances, considering issues such as the need for partial matching of search criteria, etc., other selection arrangements, such as, for example, using of heuristic selection methods for partial or approximate matching, etc., may suffice. Upon reading the teachings of this specification, those with ordinary skill in the art will now understand that, under appropriate circumstances, considering such issues as user preference, competitive requirements, etc., an entity value, such as an employer, a company, a hotel, a sports club, a fitness center, or other organization, etc., may be searchably associated with a Registered User and may be used as a search criteria. Preferably, the search results may be refined by specifying the desired skill level as shown at the top of FIG. 25. Preferably, a Registered User may then view the profile (see FIG. 19) and optional photo (see FIG. 21) of each Registered User who has made a match request matching the search criteria. A dialog between the Registered Users may then be initiated using either email (see FIG. 22), Instant Messaging (“IM”) (see FIG. 23), digital mobile phone-based text messaging (“SMS messaging”) (see FIG. 41), or communication via mobile devices having installed a “native application” (see FIG. 57) where the Registered Users may agree to meet in person for the sporting or social event. Upon reading the teachings of this specification, those skilled in the art will now appreciate that, under appropriate circumstances, considering such issues as future technology, cost, etc., other event types, such as, for example, business events, political events, gaming events, cooking events, medical events, training events, lecture events, etc., may suffice.

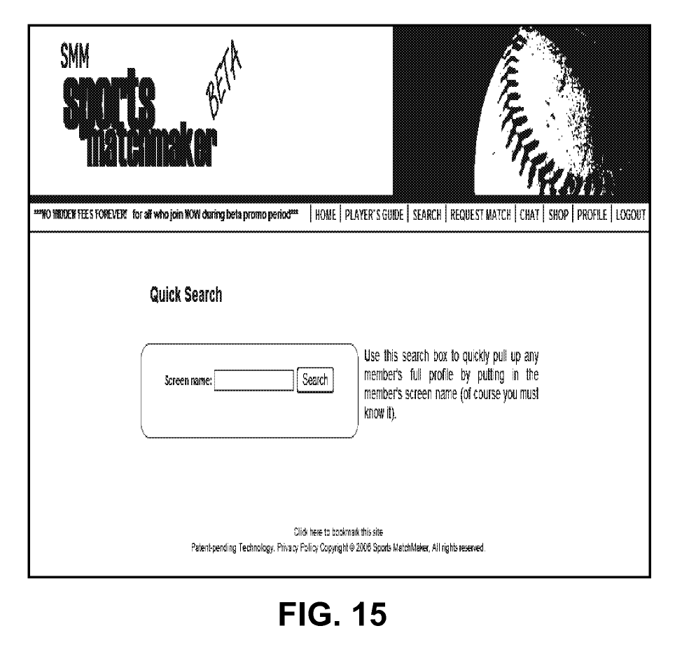

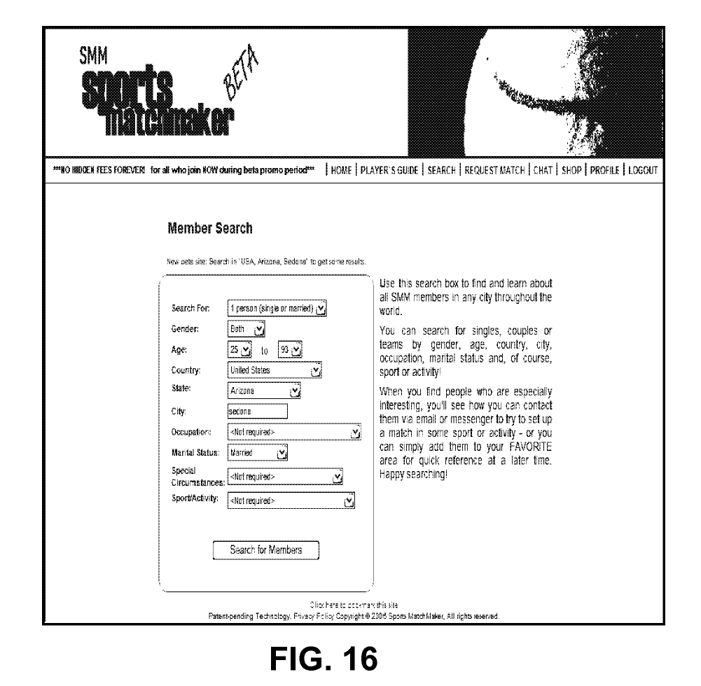

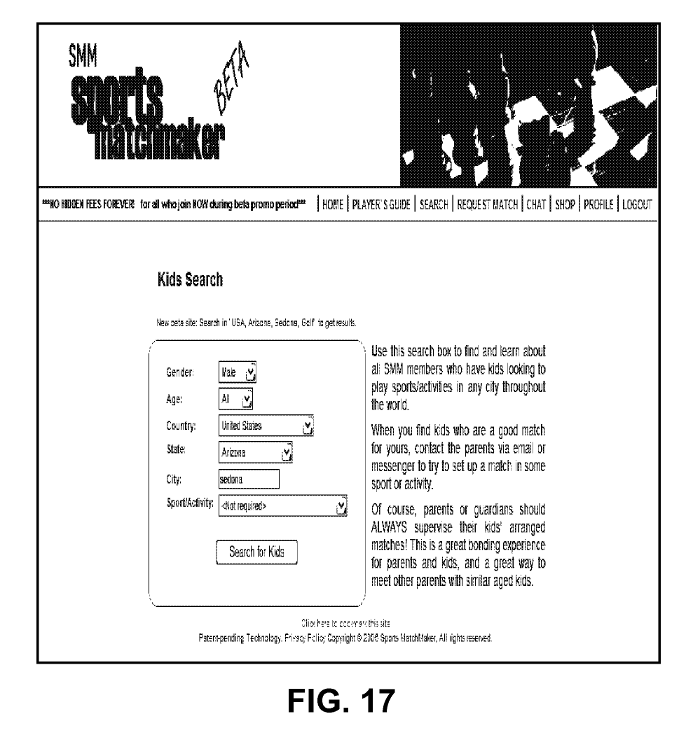

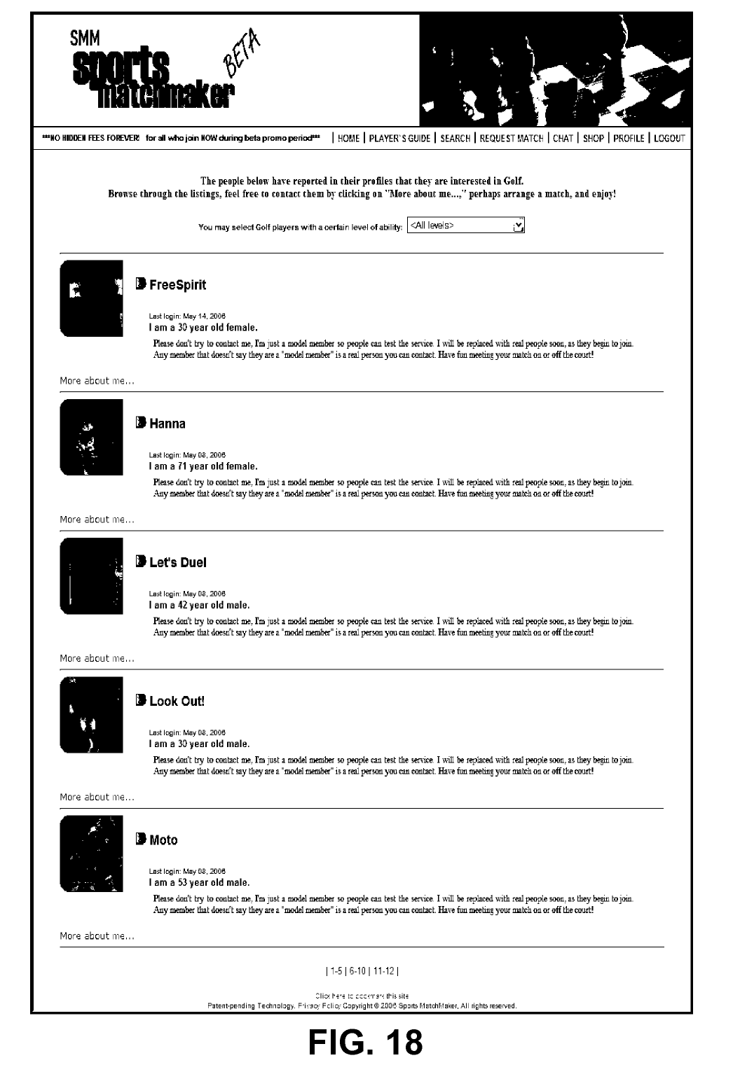

Preferably, Member Search 306 permits Registered User 202 to search Matchmaker Database 320 using the member criteria as shown in FIG. 16. Preferably, a search may be performed for singles, couples, or teams, as shown. Those members matching the search criteria are listed for review as shown in FIG. 18. Upon reading the teachings of this specification, those with ordinary skill in the art will now understand that, under appropriate circumstances, considering issues such as the need for partial matching of search criteria, etc., other selection arrangements, such as, for example, using of heuristic selection methods for partial or approximate matching, etc., may suffice. Preferably, the profile (see FIG. 19) and photo (see FIG. 21) may be viewed by Registered Users. A dialog between Registered Users may then be initiated using either email (see FIG. 22), Instant Messaging (IM) (see FIG. 23), digital mobile phone-based text (SMS) messaging (see FIG. 41), or communication via mobile devices having installed a “native application” (see FIG. 57). Preferably, Registered Users may also search for kids (see FIG. 17), which will return a list of singles or couples who have kids matching the search criteria. Preferably, a Registered User may also search for a member solely using a screen name as shown in FIG. 15.

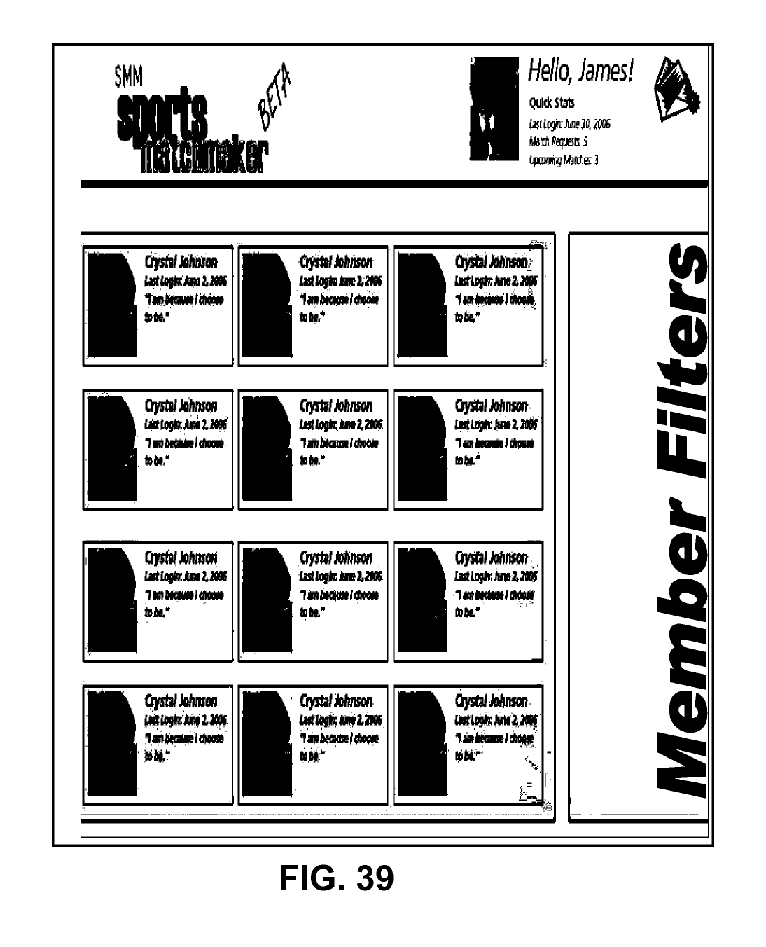

According to an alternate preferred embodiment of the present invention, alternate Search Results displaying all members' images for members whose inputted match information match the search criteria (see FIG. 39) may be presented to a Registered User. Preferably, when Registered User moves the cursor over each image, the profile information related to that member will be displayed. Preferably, when a Registered User slides the “ability level” bar, some images will fade in or out depending on each member's stated ability, etc. All these features will affect the speed and efficiency of searching that a Registered User will experience.

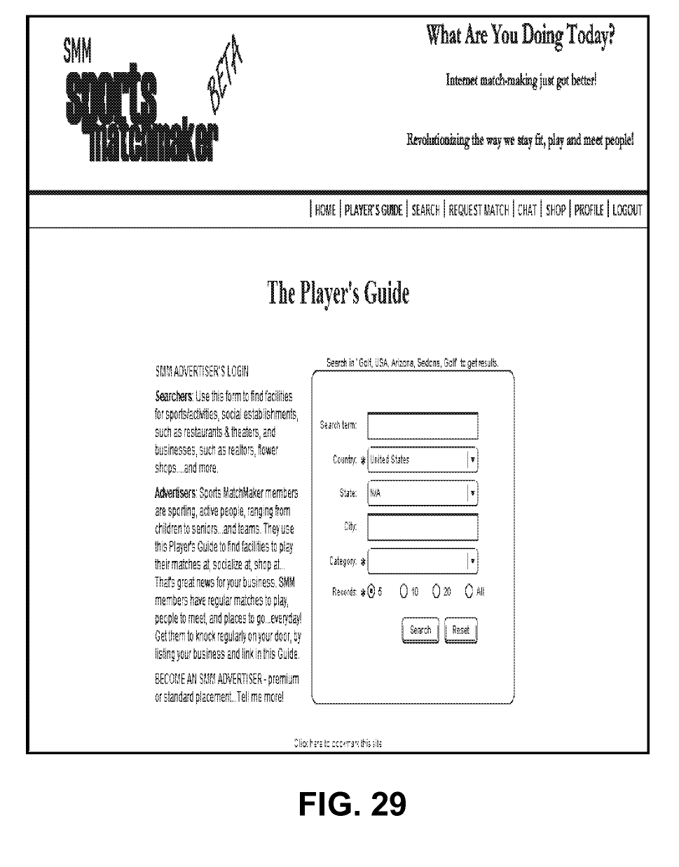

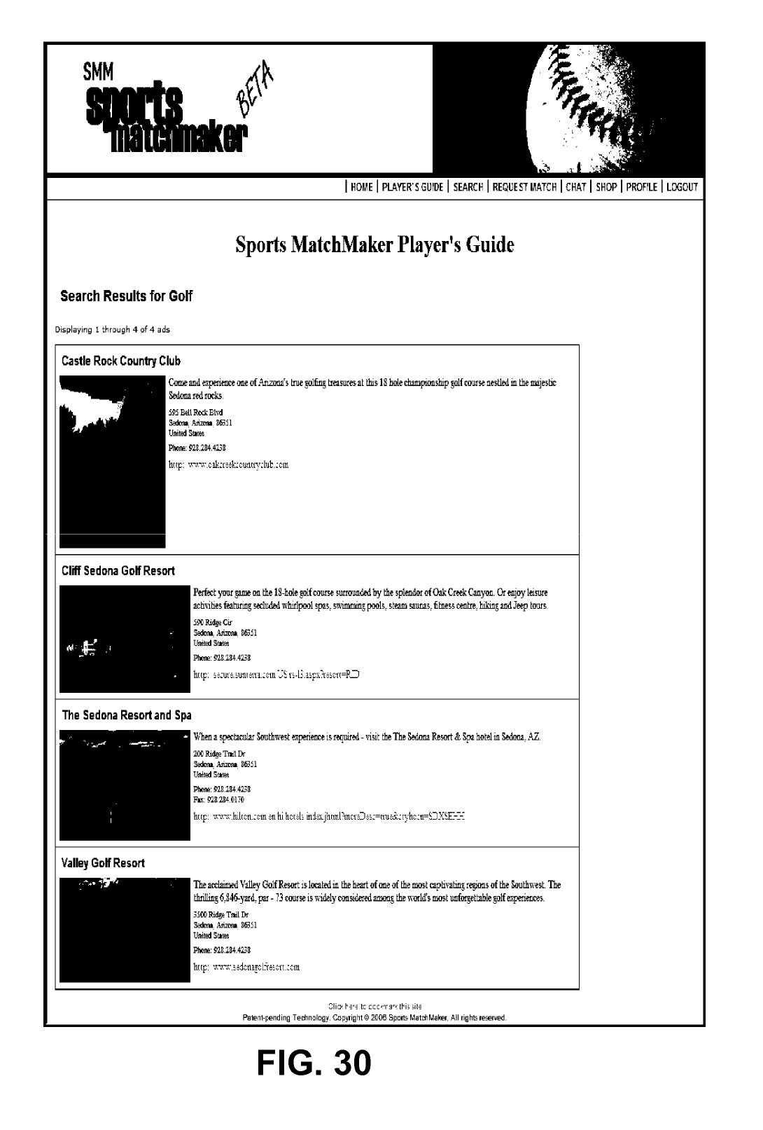

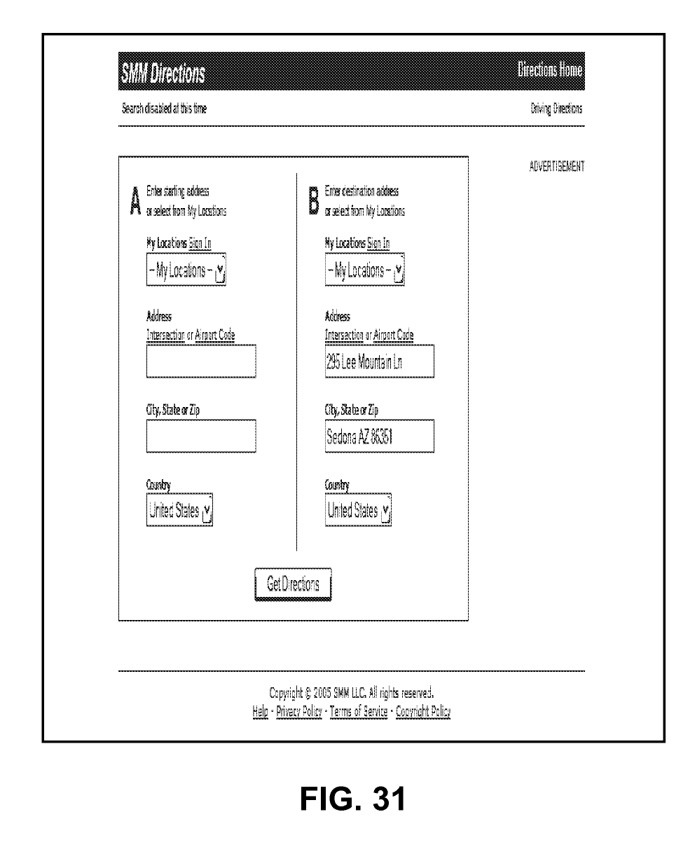

Directory Search 307 preferably permits a Registered User to identify and select a location at which a desired sporting or social event may be conducted. As shown in FIG. 29, a Registered User may search by business name or request a list of business entities within a category. FIG. 30 provides an example of the results of a search within the “Golf” category. Preferably, a Registered User may then view more detail about the business entity or request a map and driving directions to the business entity as shown in FIG. 31.

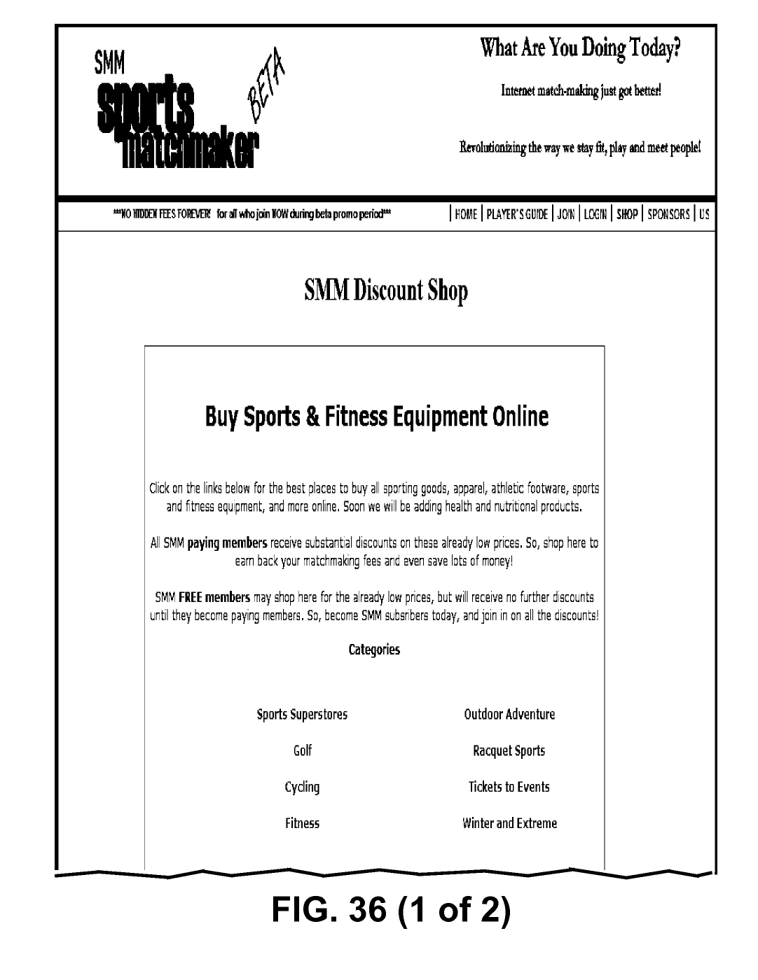

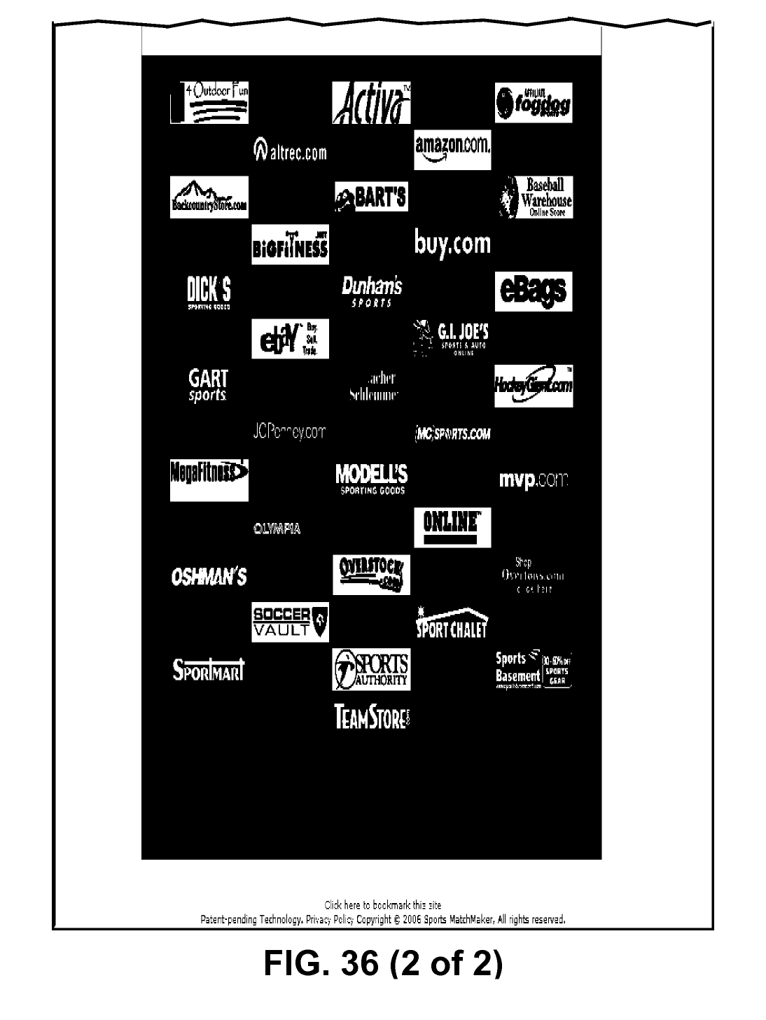

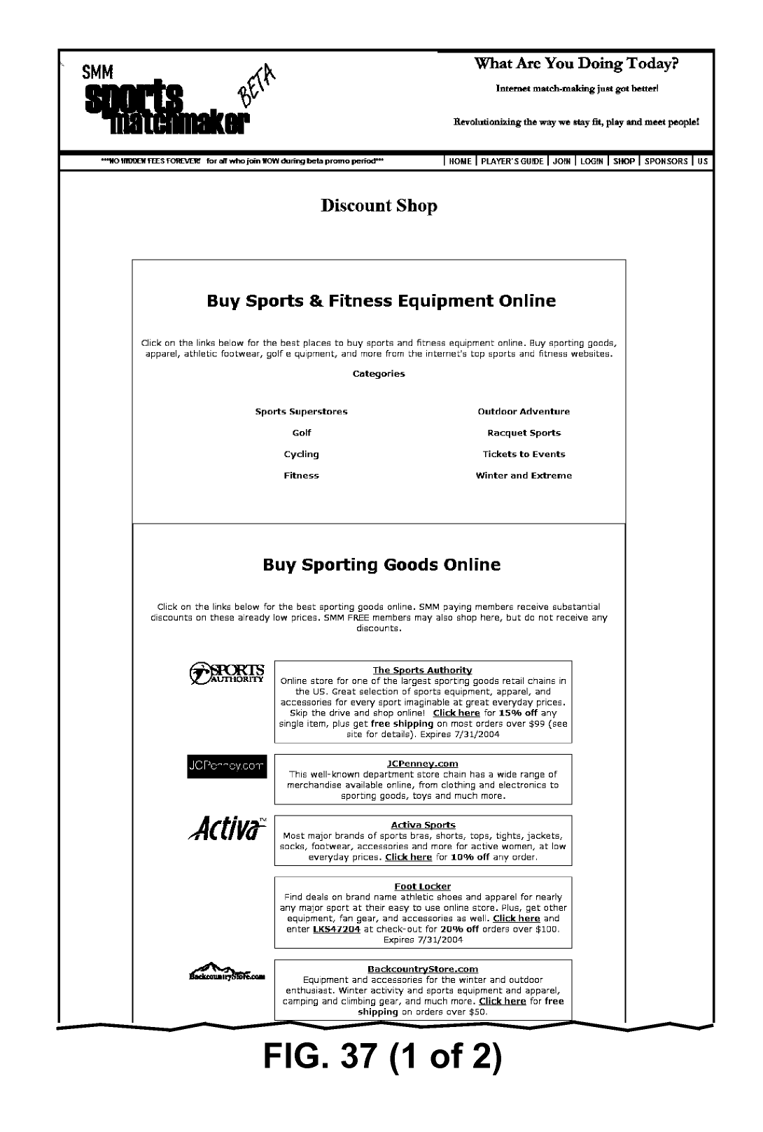

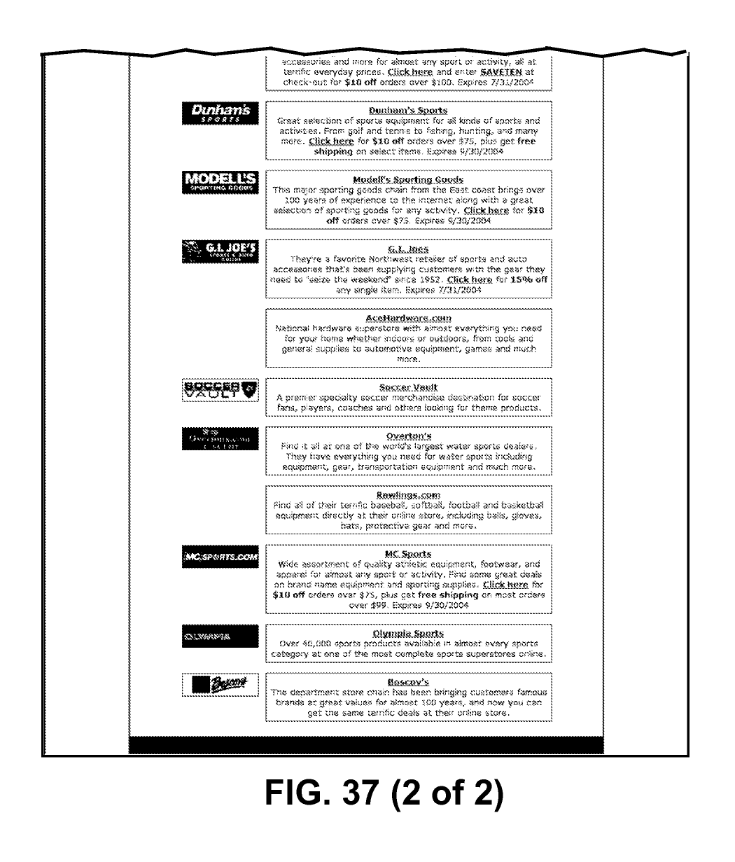

Functional component Shopping 308 preferably permits Registered User 202 to identify and select an online retailer as shown in FIG. 36 and FIG. 37. As shown in FIG. 37, preferably a Registered User may select a link to a desired online retailer and make a purchase, often at a discount. Preferably, the discounts provided are only available to Registered Users as a benefit of membership.

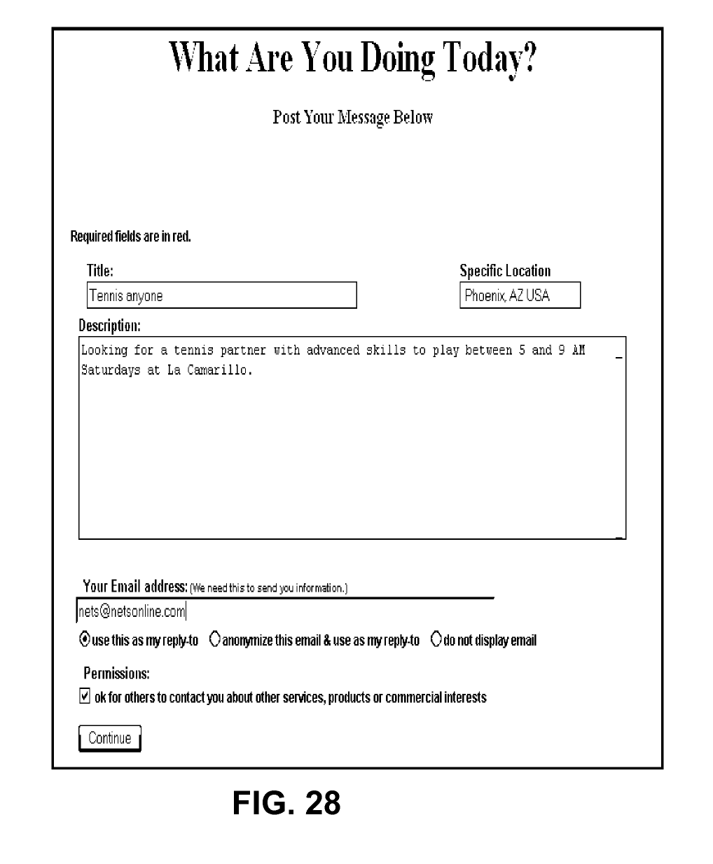

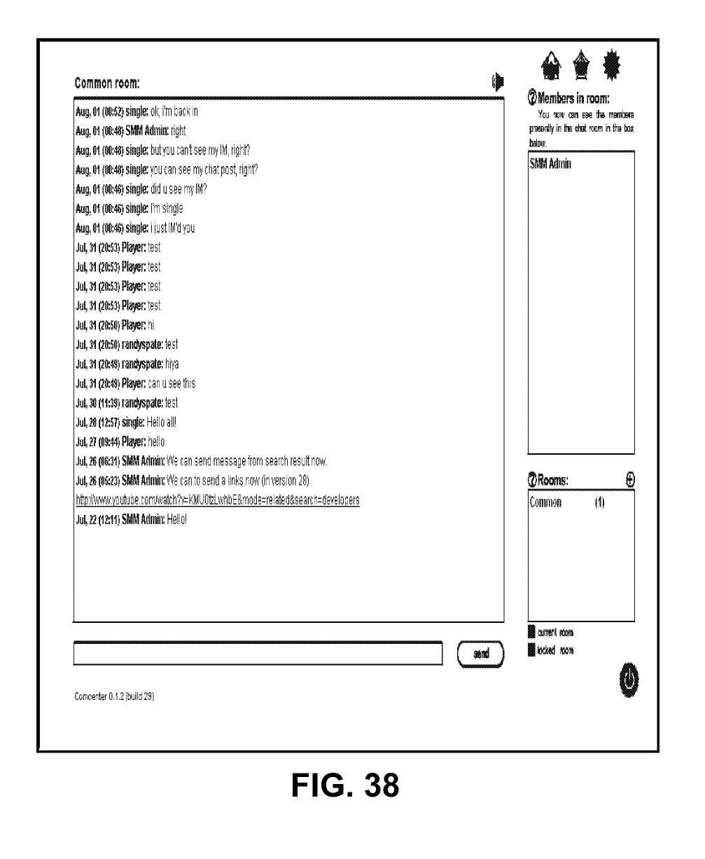

Functional component Online Forums 309 preferably comprises an online chat system, one or more Blogs, and online forums/bulletin boards made available to Registered Users. FIG. 22 shows an example of a preferred email message screen. FIG. 23 presents an example of a preferred Instant Message screen. FIG. 28 provides an example of a preferred screen used to post a new message to a bulletin board. FIG. 38 illustrates an example of a preferred chat screen.

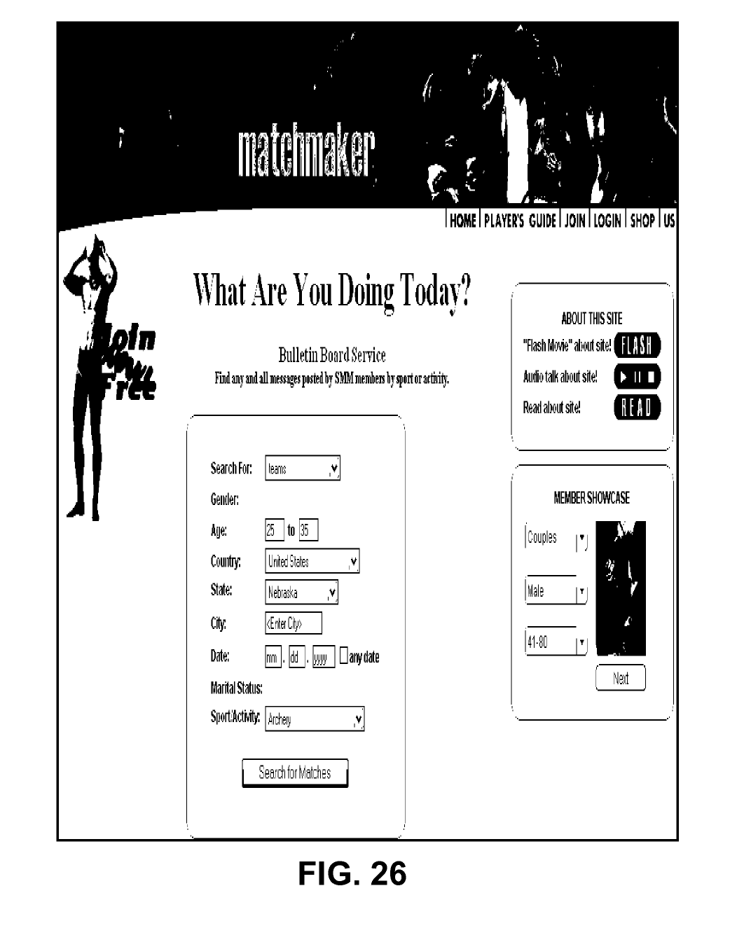

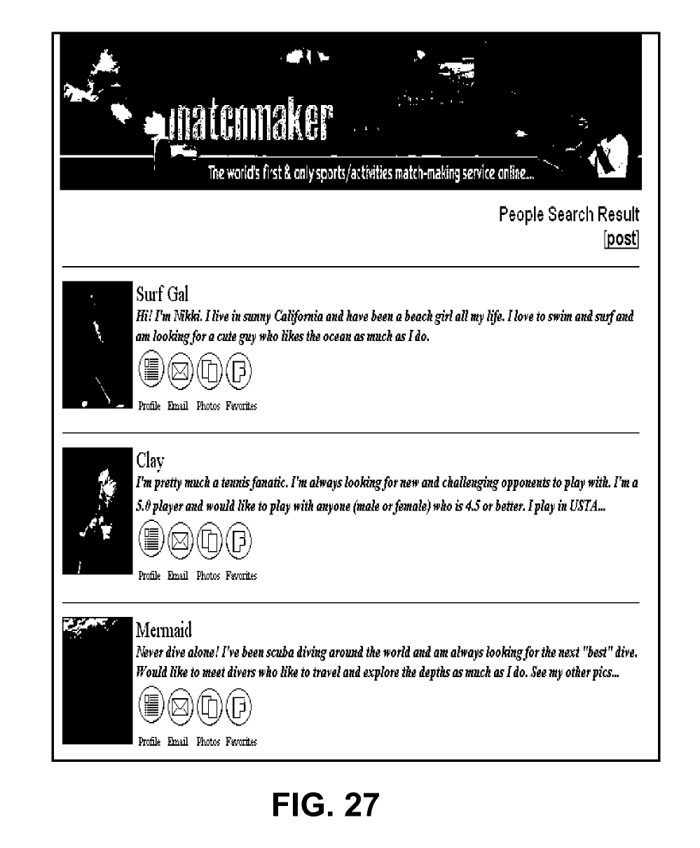

Functional component Bulletin Board Search 310 preferably permits a Registered User to search for messages posted to a bulletin board that meet the search specified criteria, as shown in FIG. 26. Preferably, the search process combines a search of the profile portion of Matchmaker Database 320 and text match searching of bulletin board messages. Upon reading the teachings of this specification, those with ordinary skill in the art will now understand that, under appropriate circumstances, considering issues such as the need for partial matching of search criteria, etc., other selection arrangements, such as, for example, using heuristic selection methods for partial or approximate matching, etc., may suffice. Preferably, all bulletin board messages matching the search criteria are displayed as shown in FIG. 27.

Functional component Email/IM 311 preferably provides the functionality necessary to support email and Instant Messaging between Registered Users. Additionally preferred functions include the use of screen names provided by Registered Users rather than actual email addresses or Instant Message handles.

Functional component Affiliates 312 preferably provides tracking and accounting for visitors who are referred from affiliate Web sites who then become Registered Users. Preferably, the business entities operating the affiliated Web sites have agreed to include a link to Matchmaker Web site 300 which can be used by Unregistered Users. Preferably, an Affiliate calculates any remuneration owed to each business entity as a result of a referred Unregistered User becoming a Registered User.

Functional component User Account Information 313 preferably comprises all the necessary administrative functions to manage a database of members including tracking and collection of membership fees.

Functional component Partner's Account Information 314 preferably comprises all the necessary administrative functions to manage a database of affiliate, advertising, and shopping partners. Preferably, these functions include the tracking and collection of fees due to Web site Manager 201 and tracking and payment of fees due to affiliate partners for new member referrals.

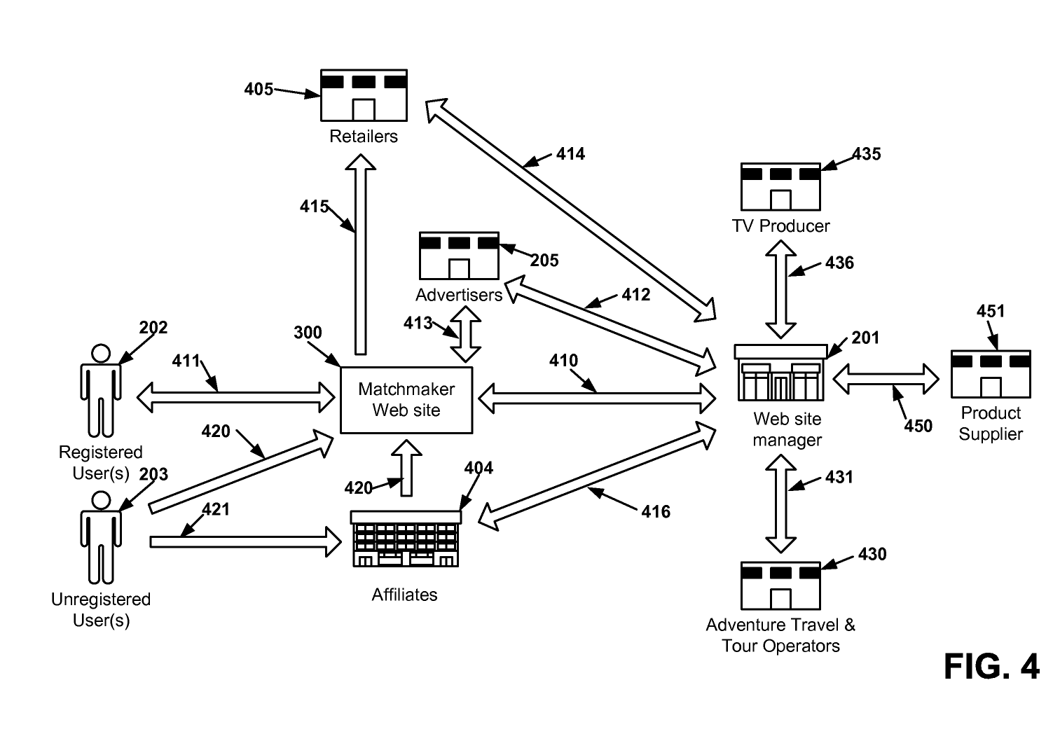

FIG. 4 shows a summary schematic of the primary entities and their relationships associated with the instant system and method, according to the preferred embodiment of the present invention.

Preferably, Web site manager 201 establishes and manages Matchmaker Web site 300 in step Manage Web site 410.

Preferably, in step Establish Advertiser Relationships 412 Web site Manager 201 offers opportunities to be listed in directory of venues (Player's Guide) for sporting and social events. Preferably, Advertiser 205 uses Advertiser Set Up 303 to select from one of the plans offered, complete its directory entry, and set up the method of payment. Preferably, each Advertiser 205 also has the opportunity to become an Affiliate 404, which preferably entitles Advertiser 205 to discounted advertising rates and other benefits. Advertiser 205 preferably comprises sporting venues such as golf courses, tennis clubs, health clubs, martial arts studios, paintball facilities, or any other location that provides a venue for a sporting event. Additionally, Advertiser 205 preferably comprises social venues such as movie theaters, restaurants, campgrounds, and hotels. In addition Advertiser 205 preferably comprises businesses that provide services and products that support sporting, athletic, and social activities.

Preferably, Web site Manager 201 will selectively contract with Advertiser 205 or other venues including hotels, restaurants, and clubs to cater and manage sporting and social events such as tennis tournaments, bridge tournaments, and similar competitions. In turn, preferably Web site Manager 201 will promote each planned tournament via email targeted to selected members within the Matchmaker Database 320 who, for instance, have indicated an interest in planned sporting or social events. Preferably, Web site Manager 201 will accept reservations and entry fee payments for planned events.

Preferably, in step Establish Retailer Relationships 414, Web site Manager 201 will offer Web site links to Retailer 405 to permit Registered User 202 to purchase products and services from Retailer 405. In return, Retailer 405 preferably offers Registered User 202 a discount on some or all its products or services. In summary, the intent is to use the increased interest in shopping with Retailer 405 to provide an incentive for visitors to become Registered Users.

Preferably, in step Establish Affiliate Relationships 416, Web site Manager 201 offers a commission to each Affiliate 404 for each visitor that comes to Matchmaker Web site 300 from the Web site of Affiliate 404 who then becomes a Registered User. Preferably, each Affiliate 404 agrees to place a link on its Web site and to promote Matchmaker Web site 300. As noted, Affiliate 404 may also become Advertiser 205 and receive reductions in costs for the placement of entries in directory of venues. Affiliate 404 preferably comprises the same business that may be Advertiser 205, but in addition preferably comprises Web sites which are devoted to both professional and amateur sporting events. Additionally Affiliate 404 preferably comprises Web sites focused on nutritional and performance improvement products.

Preferably, in step Establish Travel Relationships 431 Web site Manager 201 preferably will arrange to promote and advertise products and services offered by Adventure Travel and Tour Operators 430 domestically and internationally. Preferably, Web site Manager 201 will, in turn, receive referral fees or commissions for members that use the advertised products and services and optionally advertising fees associated with ads presented on Matchmaker Web site 300.

Preferably, in step Establish TV Relationships 436, Web site Manager 201 preferably will arrange with TV Producer 435 to promote and advertise at least one “reality” television program oriented toward using competitors chosen from members in Matchmaker Database 320 for national and international competitions. Preferably, in turn, the reality television program will promote that only members (singles, couples, and teams) will be chosen from the members in Matchmaker Database 320. Preferably, Web site Manager 201 will, in turn, receive increased registrations of members thus increasing substantially the number of members in Matchmaker Database 320, which in turn increases demand for the other services and products offered in and through Matchmaker Web site 300.

Preferably Web site Manager 201 will use Registered Users 202 stored in the Matchmaker Database 320 as a source for advertising and organizing tournaments in all kinds of sports/activities. Advertisers 205 (such as tennis clubs, golf clubs, etc.) will preferably host and run in local areas throughout the globe. Prizes will preferably be supplied by Web site Manager 201. Preferably the winners of first round tournaments are then eligible to play in the second round tournaments, and so on, until the final championship match or event. Preferably, TV Producer 435, as a business partner of Web site Manager 201, such as a FOX Sports, preferably will send camera crews to various cities during the rounds of tournaments to conduct interviews and capture footage of participants, matches, etc.—like the talent program “American Idol” does during the audition process. Then, the final championships will preferably comprise the core content of a reality television program aired by TV Producer 435. The benefit is that Web site Manager 201 can use the Advertisers 205 (such as athletic club facilities) nationwide, which are in the business of holding tournaments, to recruit and bring in revenue and new members to the Advertiser 205 (preferably Web site Manager 201 registers all tournament entrants and collects the fees online). Also, these Advertisers 205 (athletic clubs) will actually compete to hold the Web site Manager 201 tournaments since there is a likelihood that TV Producer 435 camera crews may visit and give the Advertisers 205 exposure by collecting footage of the tournament. These tournaments constantly being run year round are preferably the eliminating and qualifying process for the ultimate reality television program. When the reality show is advertised, they will draw new members to Web site Manager 201, since tournament participants must be Registered Users 202, and, as many people desire to appear on a reality television program, they will most likely register for the Web site Manager 201 local tournaments for such an opportunity.

Preferably, in step Establish Supplier Relationship 450 Web site Manager 201 will arrange with at least one Product Supplier 451 to provide products for resale by Web site Manager 201. Preferably, Matchmaker Web site 300 will provide electronic commerce (also known as “eCommerce”) functions necessary for Registered User 202 to purchase and pay for the offered products. Preferably, the offered products will comprise nutrition products generally associated with health and fitness. Upon reading the teachings of this specification, those with ordinary skill in the art will now understand that, under appropriate circumstances, considering issues such as market changes and customer demand changes, other types of products may be offered for sale, such as, for example, sporting equipment, clothing, etc.

Registered User 202 preferably completes login to Matchmaker Web site 300 to initiate the step Use Matchmaker Web site 411. Preferably, Registered User 202 agrees to pay a periodic fee in return for access to all functions available through Matchmaker Web site 300, including Match Requests 304, Match Search 305, Member Search 306, Online Forums 309, Bulletin Board Search 310, and Email/IM 311.

In step Find Activity Location 413, Registered User 202 preferably uses Advertiser Search 307 to select at least one activity location.

In step Purchase Goods and Services 415, Registered User 202 preferably uses Shopping 308 to find a retailer from which to purchase the desired products and services.

Preferably, Unregistered User 203 may visit Matchmaker Web site 300 directly and become a member by completing the User Registration and Login 301 and agreeing to pay a periodic fee as depicted by step User Access and Registration 420.

Preferably, in step Visit Affiliate Web site 421, Unregistered User 203 may visit the Web site of Affiliate 404 which presents information about Matchmaker Web site 300 and a link to Matchmaker Web site 300. Preferably, selecting the link will present Registration and Login 301 to Unregistered User 203 which begins step User Access and Registration 420, further described above.

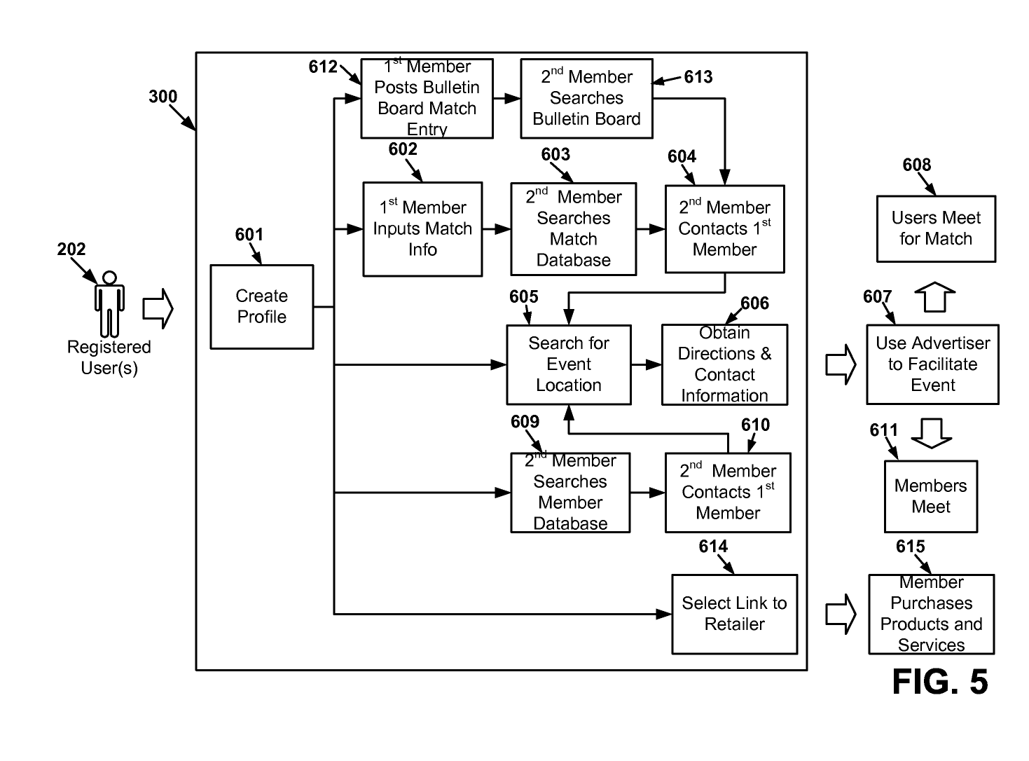

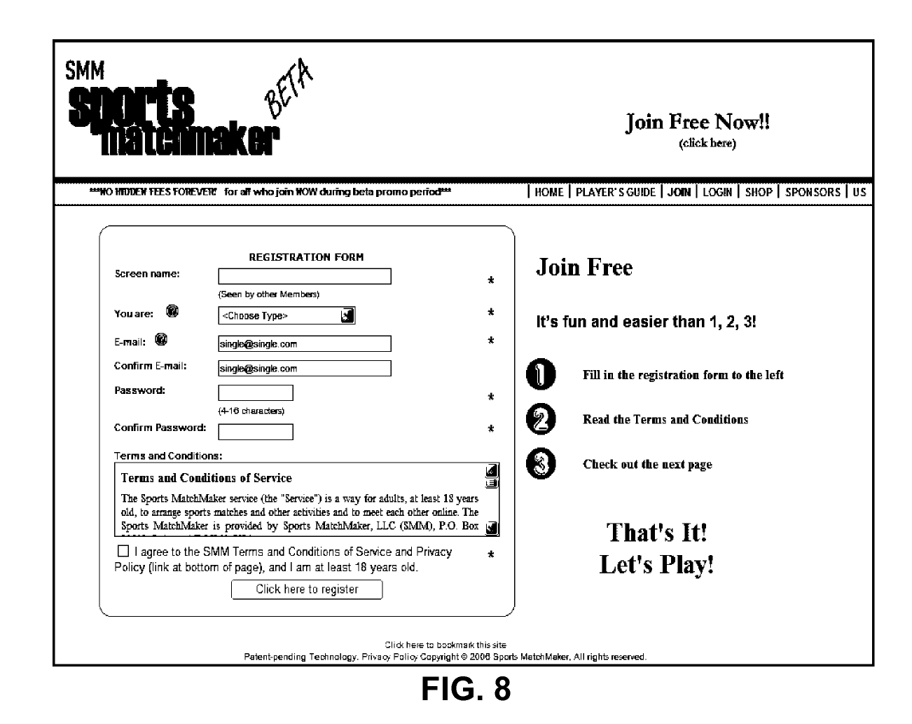

FIG. 5 shows a summary schematic of the primary steps which may be completed in the instant system and method, according to the preferred embodiment of the present invention. Preferably, each visitor must register and create a profile to utilize the functions of Matchmaker Web site 300 in step Create Profile 601. Preferably, a new member completes the registration form (FIG. 8) indicating whether the registration is for a single, a couple, or a team by completing the field “You Are:” which then takes the user to the appropriate profile form (FIG. 9, FIG. 11, or FIG. 12 for a single, couple, and team, respectively) and where the user completes at least the required fields which include demographic data (such as age, gender, marital status, etc.), contact information (such as email address), and the user's preferred sports/activities pastimes and related skill level (at least herein embodying computer interface means for permitting database entry, on behalf of such at least one first participant, of at least one first skill level of such at least one type of proposed joint event; at least herein embodying computer database means for searchably storing participant personal profile information wherein such participant personal profile information comprises at least at least one unique identifier, such at least one type of such proposed joint event, such of at least one first skill level of such at least one type of proposed joint event, demographic information, contact information; and at least herein embodying computer interface means for database entry on behalf of such at least one first participant such personal profile information; at least herein embodying wherein such personal profile information further comprises at least two of the following: children information; participant background information; personality traits information; favorite foods information; preferred music information; and at least one image). Preferably, each Registered User 202 may have more than one sports/activities pastime. Preferably, Registered User 202 may then enter the member's area (FIG. 15, FIG. 16, FIG. 17 and FIG. 24) and begin searching for members and matches. Preferably, when Registered User 202 logs out of the Matchmaker Web site 300 the first time, the Registered User cannot log in again until the Registered User receives an initiation email and activates the membership by clicking a link provided in such email. If Registered User 202 tries to log in before receiving the initializing email, the site will automatically provide them with a button to send out, or deliver, another activation email. Registered User 202 is then directed to look for the email and activate the membership by clicking the link provided in the email. Once Registered User 202 activates his/her membership, Registered User 202 may log in and begin searching via all search boxes for adult members, Match Requests, members by screen name and adults who have kids broken down by gender, age, sports played, and level of ability (FIG. 15, FIG. 16, FIG. 17, and FIG. 24). Preferably, Registered User 202 cannot contact another member or make a match request (FIG. 13) until the Registered User becomes a paying member. Preferably, Registered User 202 may contact other members and/or make match requests without requiring payment.

As shown, preferably in step First Member Inputs Match Info 602, Registered User 202, preferably as a paid member (alternately preferably payment is not needed), makes at least one Match Request which is a public request (offer) (alternately preferably a request to those within the user's social network as disclosed herein) to play a match with others in a particular sport/activity in a particular city, on a specific date, with a person or persons having a particular gender, martial status (couple or team), and particular skill level (FIG. 13 and FIG. 14). As depicted, Registered User 202 may indicate a preference for the day of week by selecting the desired Day of Week Check Boxes 1303. Preferably, use of Day of Week Check Boxes 1303 permits searching by day of week. Preferably, sport/activity match requests (offers) may include any time and location based event, such as playing a round of golf, fishing, watching a sporting event, going to a movie, or having dinner.

Once at least one match request is posted to Matchmaker Database 320, preferably another Registered User 202 may search for a match that meets his/her criteria as shown in step Second Member Searches Match Database 603. Preferably, Registered User 202 uses the Match Search Screen (FIG. 24) to query Matchmaker Database 320. Preferably, all member profiles associated with Match Requests satisfying the search criteria are presented in the Search Results screen (FIG. 25) (at least herein embodying computer processing means for retrieving from such computer database means such proposed-event information matching such second searchable criterion). As shown, Registered User 202 may then filter the displayed Match Requests by selecting a skill level from Skill Level Drop Down 2501 (at least herein embodying computer interface means for permitting entry on behalf of such at least one second participant at least one second searchable criterion for proposed matching with such at least one skill level of such at least one type of proposed joint event).

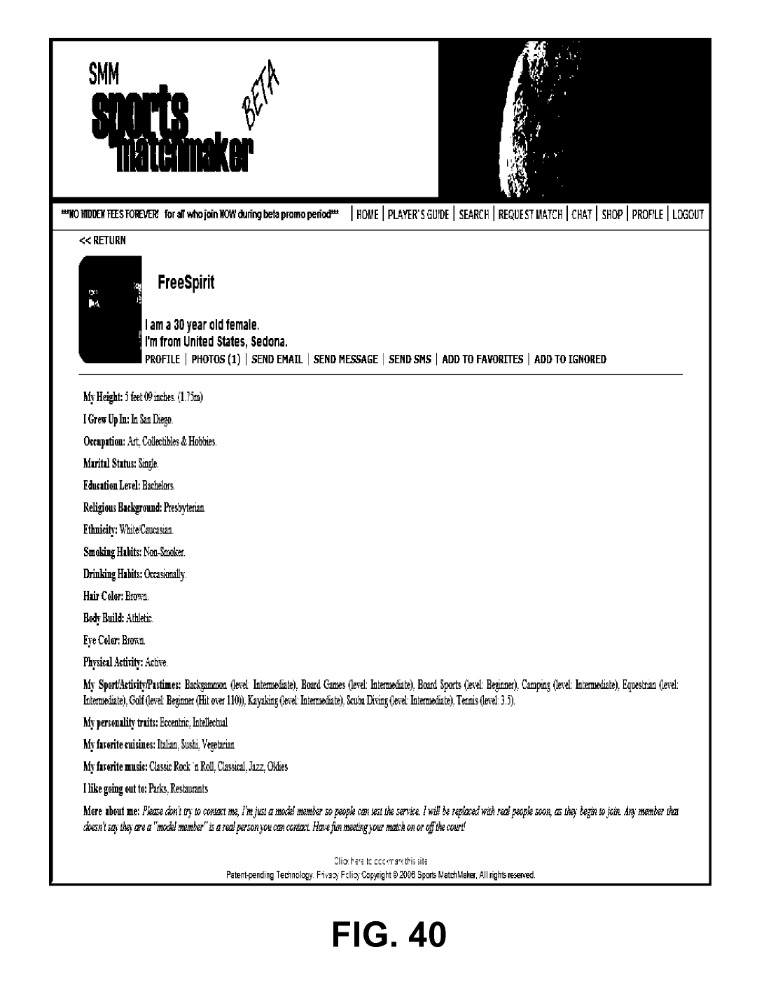

Once Registered User 202 determines that a listed profile of a member with a matching Match Request is desirable, in step Second Member Contacts First Member 604, preferably, Registered User 202 views (requesting) the details of the member's profile on the Member Profile screen (FIG. 19). If the selected member is still desirable, Registered User 202 (as a paid member) may contact the other member using Instant Messaging (FIG. 23), email (FIG. 22), digital mobile phone-based text messaging (SMS messaging) (see FIG. 40 and FIG. 41), the chat room system (FIG. 38), or the bulletin board system (FIG. 28) by selecting the appropriate link on the Member Profile screen (at least herein embodying computer processing means for assisting such at least one second participant to communicate with such at least one first participant). Preferably, in all cases, communication between members is done using the member's “screen name” rather than their actual email addresses or mobile phone numbers to protect privacy and ensure security (at least herein embodying computer processing means for assisting non-disclosure of first contact information of such first participant to such second participant; at least herein embodying computer processing means for assisting non-disclosure of second contact information of such second participant to such first participant; and at least herein embodying wherein the step of assisting such at least one second participant to communicate with such at least one first participant is accomplished with text messaging on digital mobile phones).

A business advantage that Matchmaker Web site 300 provides is that Registered Users 202 may immediately (preferably with one click) find the main object that Registered Users 202 are searching, namely, people. Statistics show that the faster Registered Users 202 can find what they are looking for on Matchmaker Web site 300, the more successful the Matchmaker Web site 300 will be.

Preferably, the present Matchmaker Web site 300 immediately connects Registered Users 202 together using the least amount of computing resources as possible and providing more than one method of beginning the process of making a match. Registered Users 202 will then be able to use their computer resources to communicate further with each other, if they so choose.

Once both Registered Users 202 have agreed to meet for a match a location for the match play must be determined. If a location must be found, Registered User 202 preferably searches the directory of venues (Player's Guide) to view information about the variety of locations available, in step Search for Event Location 605. As shown in FIG. 29, Registered User 202 may search by business name or category or select a category from those displayed. The resulting list of venues is presented in a listing of the directory entries fitting the search criteria (FIG. 30).

In step Obtain Directions and Contact Information 606, preferably selecting one of the directory entries presents additional information about the venue, such as costs, reservation requirements, and hours of operation. Additionally, Registered User 202 may choose to obtain a map or driving directions by selecting the Map link which permits Registered User 202 to complete the map form as shown in FIG. 31.

After selecting a venue, Registered User 202 will complete the necessary arrangements to conduct the match at the agreed date and time in step Use Advertiser to Facilitate Event 607.

In step Users Meet for Match 608 individuals, couples or teams, as the case may be, meet and complete the planned activity.

Referring again to FIG. 5, step Second Member Searches Member Database 609, Registered User 202 may search for another Registered User 202 for the purpose of meeting socially by using one of the member search screens, Quick Search (FIG. 15), Member Search (FIG. 16) or Kid Search (FIG. 17). Preferably, Registered User 202 may search by any combination of the search fields provided including singles, couples, or teams (at least herein embodying computer interface means for permitting entry on behalf of such at least one second participant at least one third searchable criteria for proposed matching of such personal profile information). All members matching the search criteria are preferably displayed on the Member Search Results screen (FIG. 18) (alternate Member Search Results screen, (see FIG. 39) may also be displayed) (at least herein embodying computer processing means for retrieving from such computer database means such first personal profile information matching such third searchable criteria).

Once Registered User 202 determines that a listed member is desirable, step Second Member Contacts First Member 610, preferably, Registered User 202 views the selected member's profile on the Member Profile screen (FIG. 19). If the selected member is still desirable, Registered User 202 (as a paid member) may contact the other member via Instant Messaging (FIG. 23), via email (FIG. 22), text messaging (SMS messaging) (see FIG. 40 and FIG. 41), the chat room system (FIG. 38), or the bulletin board system (FIG. 28) by selecting the appropriate link on the Member Profile screen.

Once both Registered Users 202 have agreed to meet socially a location must be determined. If a location must be found, Registered User 202 preferably searches the directory of venues (Player's Guide) to view information about the variety of locations available, in step Search for Event Location 605. As shown in FIG. 29, Registered User 202 may search by business name or category or select a category for those displayed. The resulting list of venues is presented in a listing of the directory entries fitting the search criteria (FIG. 30).

In step Obtain Directions and Contact Information 606, preferably, selecting one of the directory entries presents additional information about the venue, such as costs, reservation requirements, and hours of operation. Additionally, Registered User 202 may choose to obtain a map or driving directions by selecting the Map link which permits Registered User 202 to complete the map form as shown in FIG. 31.

After selecting a venue, Registered User 202 will complete the necessary arrangements to meet socially at the agreed date and time in step Use Advertiser to Facilitate Event 607.

Following selection and arrangement of a location the individuals, couples or teams, as the case may be, meet as shown in step Members Meet 611.

Referring again to FIG. 5, Registered User 202 may post messages to the bulletin board as shown in step First Member Posts Bulletin Board Entry 612. Preferably, when Registered User 202 decides to make a post to the bulletin board (FIG. 28), the message is automatically associated with the personal profile of the registered user with a link so that the readers of the bulletin board message can click the link and read the profile of Registered User 202 who posted the message (at least herein embodying computer database means for searchably storing at least one bulletin board posting; at least herein embodying computer interface means for entry on behalf of such at least one first participant of such at least one bulletin board posting; and at least herein embodying computer processing means for associating such at least one such bulletin board posting with such at least one first participant). Preferably, bulletin board messages may be used to assist in setting up sports/activity matches or simply to make announcements.

In step Second Member Searches Bulletin Board 613, Registered User 202 may search for bulletin board messages preferably using search criteria as shown in FIG. 26 (at least herein embodying such fourth search criteria comprise: at least one type of proposed joint event; at least one proposed geographic area for such proposed joint event; at least one proposed time criterion for such at least one proposed joint event). Preferably, the entered search criteria will be used to search in combination through both the member profiles and the bulletin board messages to complete the request (at least herein embodying computer interface means for permitting entry on behalf of such at least one second participant at least one fourth searchable criteria for proposed matching with such personal profile information). As shown in FIG. 27, the search result preferably presents a list of all messages matching the search criteria (at least herein embodying computer processing means for retrieving such at least one bulletin board posting associated with such personal profile information matching such fourth search criteria). Registered User 202 may view the profile of Registered User 202 that posted the message by selecting the profile button and/or the photo button. Additionally, Registered User 202 may contact the individual by selecting the email button.

Referring again to FIG. 5, in step Select Link to Retailer 614, Registered User 202 may search for an online retailer to purchase a product or service. The preferred method for searching is shown in FIG. 36 and FIG. 37. Preferably, Registered User 202 selects a link to the desired Retailer 405 and makes a purchase through the Web site of Retailer 405 as shown in step Member Purchases Products and Services 615.

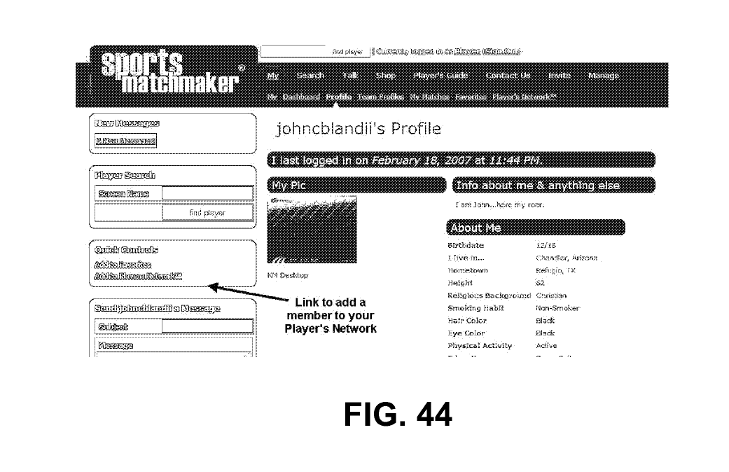

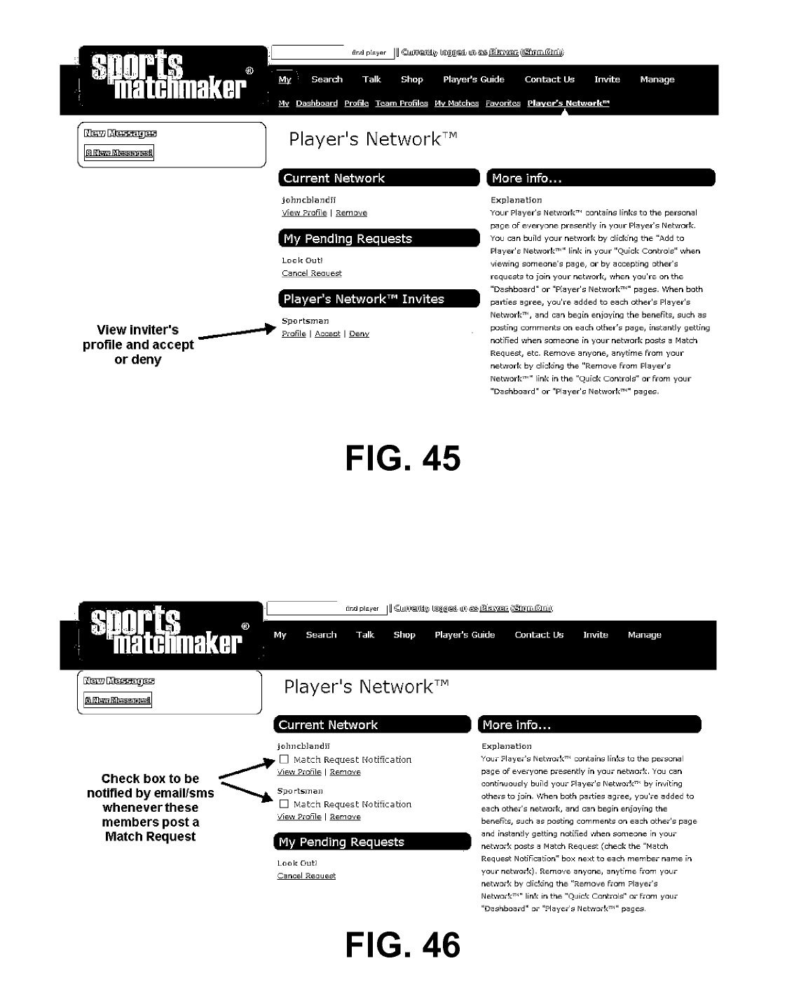

FIG. 44 shows an example of a user profile screen illustrating capability of member linking to a Player's Network according to a preferred embodiment of the present invention. More particularly, as shown, the Player's Network is the social network of each user, preferably stored on at least one database associated with matchmaker computer system 101. Preferably using this user profile screen, a first Registered User (the “inviter”) may invite other Registered Users (the “invitees”) to become a “friend” of the first Registered User. Preferably, the invitee is notified of the invitation through the invitee's external e-mail as well as through Matchmaker Web site 300 internal e-mail, as shown in FIG. 45, or through other communication methods associated with matchmaker computer system 101 (SMS messaging, native application notification, etc.). The invitation directs the invitee to the Player's Network page of the first Registered User, where the invitee may view the profile of first Registered User. Also from this page, the invitee may either “accept” or “deny” the invitation to join the inviter's Player's Network, as shown. Using this system, users may become members of other user's social network for messaging purposes (users may message those in their social network while excluding others).

Once part of a Player's Network, the “friends” of the first Registered User may post “comments” on the first Registered User's 202 profile screen. Where the first Registered User (also herein called a “member”) does not want their user profile to be accessed by the public, in these situations, the first Register User may block the general public's access to the page by designating this page “private”. Once designated “private”, only “friends” of a Registered User will have access to personal pages not generally accessible to the general public. As shown in FIG. 44, a link under “Quick Controls” permits a first Registered User to invite a member to the first Registered User's Player's Network by clicking the link “Add to Players Network”.

FIG. 45 shows an example of the Player's Network screen of a user according to a preferred embodiment of the present invention. The Player's Network screen displays the “Current Network”, “My Pending Requests”, and “Players Network Invites” of a Registered User. The heading “Current Network” list the “friends” of a Registered User. The heading “My Pending Requests” lists those users who have requested to join the Player's Network of a Registered User. The heading “Player's Network Invites” lists those users who have invited a Registered User to join their Player's Network. From this screen, a Registered User may easily view an inviting member's profile or accept or deny the invitation with a single click, as shown. Such arrangement at least embodying herein computer user-associating interface means for assisting associating at least one registered user of the at least one computer network with at least one other registered user of the at least one computer network, to form at least one registered user sub-network; and computer user-sub-network database means for assisting storage of such at least one registered user sub-network; wherein such computer activity-participation-manager processor means comprises computer activity-participation-sub-network processor means for assisting limiting participation in at least one such proposed multiple-person activity to those in at least one specified at least one registered user sub-network, and at least one computer user-associating interface structured and arranged to assist associating at least one registered user of the at least one computer network with at least one other registered user of the at least one computer network, forming at least one registered user sub-network; and at least one computer user-sub-network database structured and arranged to assist storage of such at least one registered user sub-network; wherein such computer activity-participation-manager processor comprises at least one computer activity-participation-sub-network processor structured and arranged to assist limiting participation in at least one such proposed multiple-person activity to those in at least one specified at least one registered user sub-network).

FIG. 46 shows an example of the Match Request Notification Service of the Player's Network screen according to a preferred embodiment of the present invention. The Match Request Notification Service of the Player's Network screen allows a Registered User to receive all of the Registered User's match request details through email or SMS messaging that are posted by selected members of the Registered User's Player's Network. As shown in FIG. 46, a Registered User need only select a check box near a Registered User's screen name to receive an email or SMS message when those selected users post Match Requests. This feature increases the chances of two members meeting when their schedules permit.

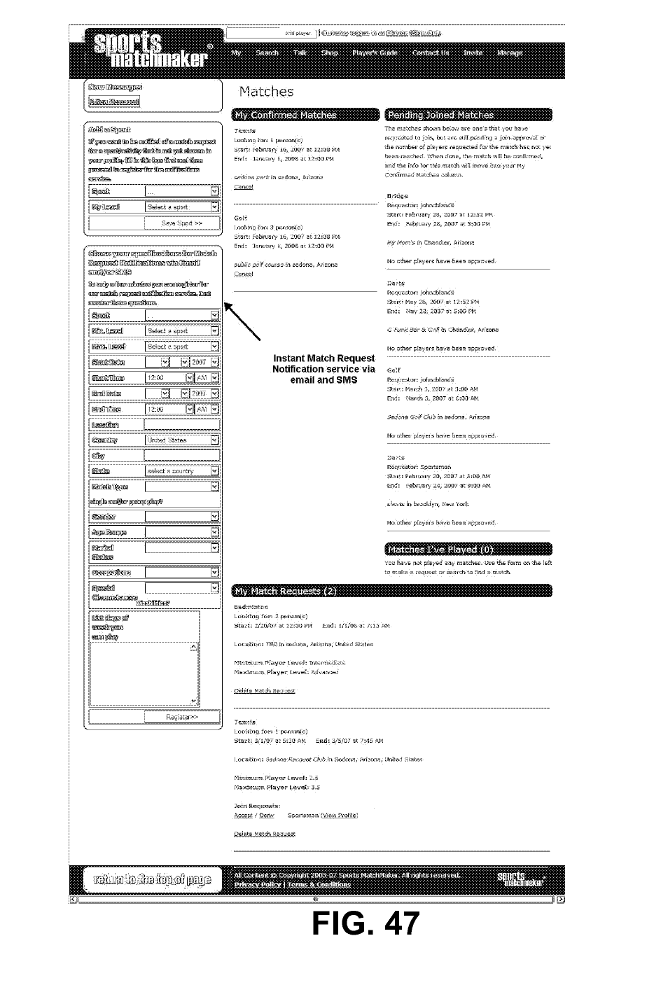

FIG. 47 shows an example of a Match Request Notification Service on the Matches screen according to a preferred embodiment of the present invention. The Match Request Notification Service preferably allows a Registered User to receive all match request details from any other member, not just those members in the Registered User's Players Network, that match selected Registered User criteria. The Match Requests are preferably sent to a member through email or SMS messaging. The criteria that may be selected preferably include the following: sport, minimum level, maximum level, start date, start time, end date, end time, location, country, city, state, match type (single and/or group play), marital status, occupations, special circumstances (disabilities), and days of the week available to play. Once criteria are selected, a registered user will then preferably be able to receive match requests that are compatible with the schedule, personality, etc., of the registered user. This feature permits a registered user to spend less time searching for matches, and more time setting up matches.

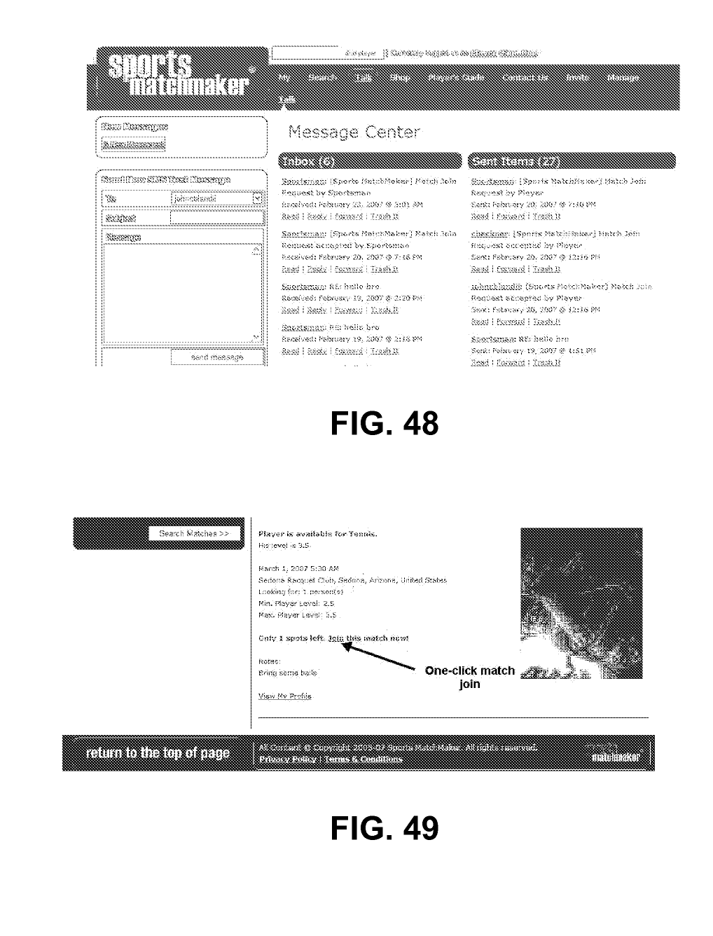

FIG. 48 shows an example of a Message Center screen according to a preferred embodiment of the present invention. The Message Center Screen preferably permits a member to send SMS text messages anonymously through the matchmaker computer system 101, as shown. The anonymous messaging feature is preferably a security feature, and preferably allows one to contact registered users without exchanging personal information, such as telephone numbers (which a user may initially want to keep private). The anonymous messaging will preferably additionally function with Internet enabled phones so that members may connect to the Message Center screen and send an SMS message while somewhere in the field. For example, a member may send a message to another user stating, “I'm at the courts. Are you on your way?”

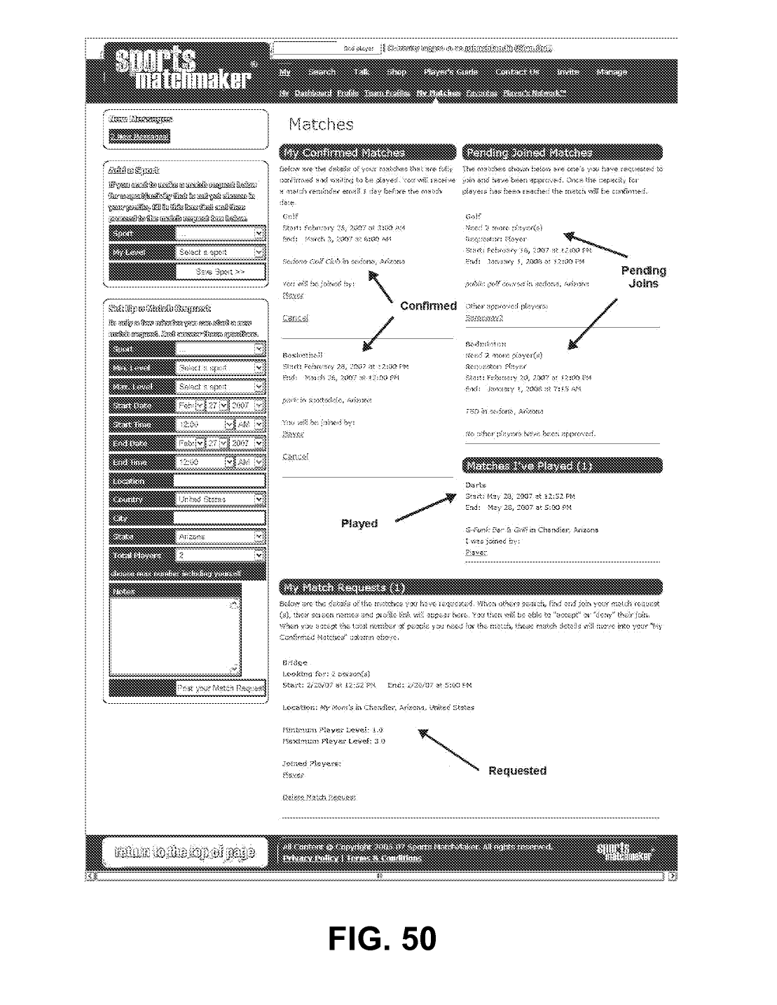

FIG. 49 shows an example of the “One-Click Match Join” feature of the matchmaker computer system 101 according to a preferred embodiment of the present invention. The one-click match join feature preferably permits members (“requestees”) to “join” a match or event requested by another member (the “requestor”) by clicking once on a link. Once the link is clicked, preferably both an internal and external email and/or a SMS message is delivered to the requestor of the match. The email and/or SMS message preferably notifies the requestor that someone has asked to join the requestor's requested match. Further, once the “Join” link is clicked, the match details of the joined match preferably appear in the requestee's “Pending Joined Matches” column (as shown in FIG. 50) for increased ease in viewing, reminding, and planning. After clicking the “Join” hyperlink, the Requestor is preferably directed back to the Matches screen (as shown in FIG. 47) where the requestor may preferably “accept” or “deny” the person that joined. The requestor “accept” or “deny” feature preferably allows the requestor to monitor who is joining matches so that matches are not being filled with users who do not intend to play the joined matches. Preferably, the requestor has the ability to specify some or all of the following information: sport, minimum level, maximum level, start date, start time, end date, end time, location, country, city, state, match type (single and/or group play, how many spots available), marital status, occupation, special circumstances (disabilities), and days of the week available to play. The requestor may also preferably append notes to the match request.

FIG. 50 shows an example of a Match screen according to a preferred embodiment of the present invention. As shown, the Matches screen preferably displays the following information scheduled matches/activities (“My Confirmed Matches”), matches/activities that are being scheduled (e.g., matches that are awaiting players or awaiting approval of a request to participate) (“Pending Joined Matches”), match/activity history (“Matches I′ve Played”), and matches/activities requested (“My Match Requests”).

The “My Confirmed Matches” heading preferably lists details of confirmed matches that are waiting to be played. The sport, time, location, and user name of other members, or match attendees, are preferably displayed, as shown. Preferably, at a predetermined time period (preferably one day) before each match, a match reminder email and/or SMS message is preferably automatically delivered to each match participant. Such match reminder assists in match attendance by reminding users of the scheduled match.

The “Pending Joined Matches” heading preferably lists all matches that a member has “joined”; however, the matches are still pending awaiting a “join-approval” and/or the number of players requested for the match has not yet been reached. Once the pending joined matches are no longer pending, these match details will preferably appear under the “My Confirmed Matches” heading.

The “My Played Matches” heading preferably allows a user to view a match play history and details of past matches.

As described with respect to FIG. 49, the “One-Click Match Join” feature preferably allows a match requestor to “accept” or “deny” a match join request with one click, which preferably automatically generates an internal and external email and/or SMS to the match joiner notifying the match joiner that match joiner's match join was accepted or denied by the match requestor. If the join was accepted, and when the total number of participants has joined and been accepted, then the match details preferably display under the “Confirmed Matches” column for all of the participant user's.

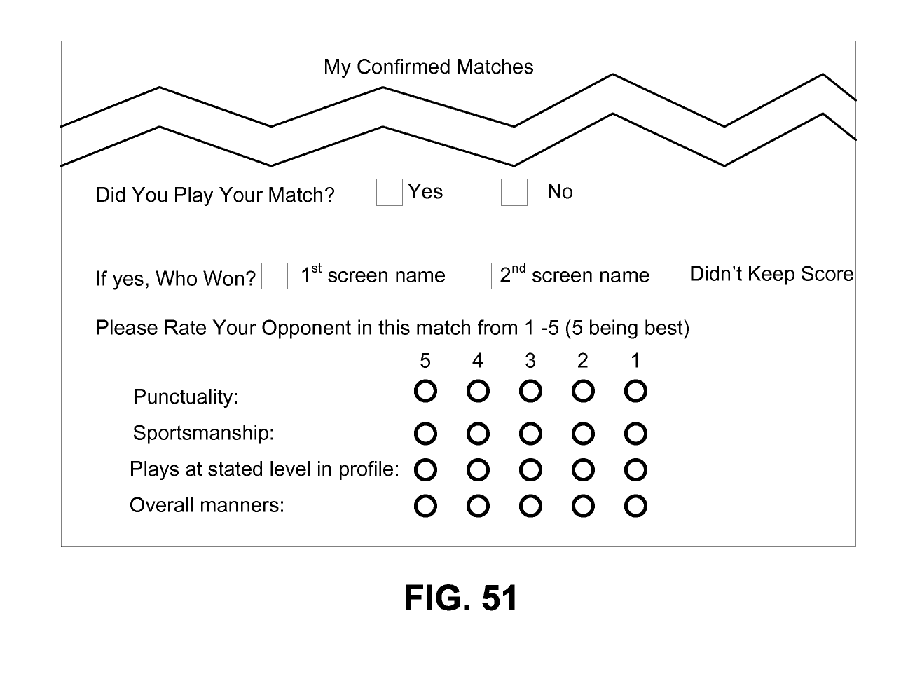

FIG. 51 shows an example of a Match History feature of the My Confirmed Matches heading according to a preferred embodiment of the present invention. The “My Played Matches” heading is preferably populated with data as follows. Preferably, a time period (preferably one day) after each confirmed match time period, a series of follow-up questions preferably appear under the match details in the “My Confirmed Matches” heading. The follow-up questions preferably ask whether the match was played, as shown. If the match was not played, and the “No” checkbox is chosen, all further questions do not require answers and are preferably removed from the screen. If “Yes” is chosen, further questions are preferably provided for input by the registered user. The system preferably asks for the winner of the match or if score was even kept, as shown. In some sport events or social events score may not be kept. The system further preferably asks registered users to rate their opponents in at least the following preferred areas: punctuality, sportsmanship, plays at stated level in profile, and overall manners, as shown. As shown in FIG. 51, a 1-5 scales is preferably used to rate your opponent.

Upon answering all of the questions, the questionnaire and the match details are preferably removed from the “My Confirmed Matches” column. The gathered data is then preferably displayed in “Play History” (who each registered user played, when, what sport, etc.) and “Confirmed Wins” (displayed when both match participants report the same winner in competitive sports) on each members Matches page.

Each registered user preferably has the option of hiding that registered user's Confirmed Wins statistics from the view of other users. Preferably, each player cannot hide the ratings relating to punctuality, sportsmanship, etc., described above. This preference allows all registered users to check one another's overall punctuality, sportsmanship, stated level accuracy, manners rating, etc. This feature is useful since users who misbehave or are not accurate about their playing ability will not get future match play requests making the Web site a reliable one. Further, knowing that users will be rated may keep them on their best behavior.

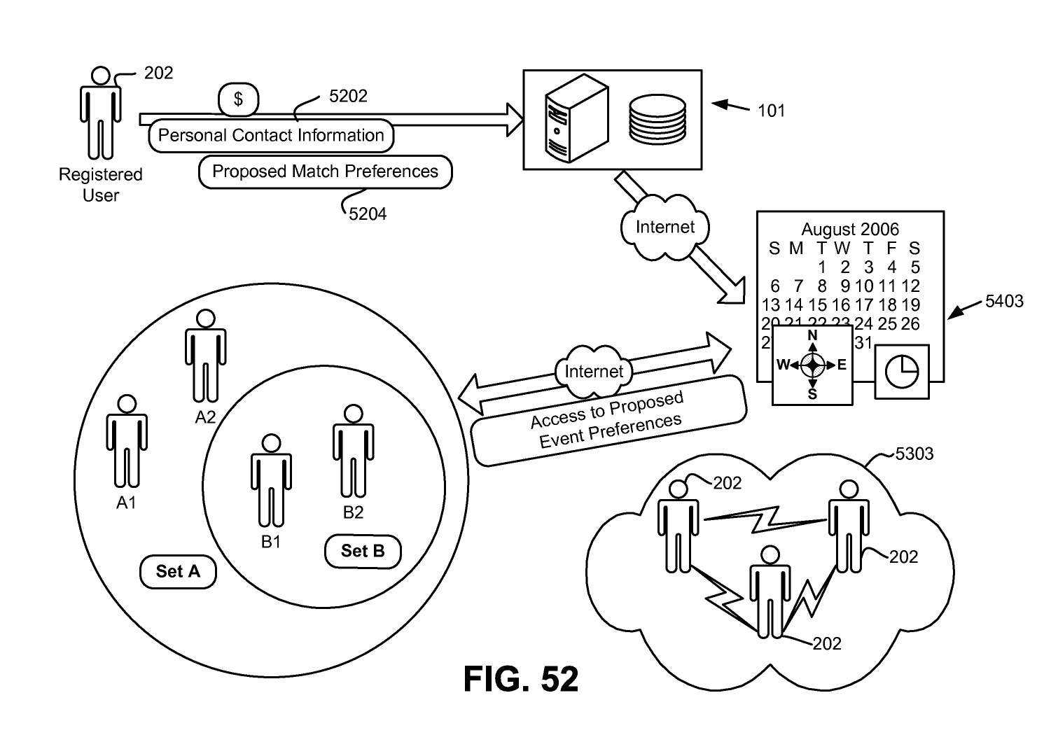

FIG. 52 shows a simplified diagrammatic overview illustrating, in a simplified form, features of the instant system according to the preferred embodiment of the present invention.

As previously stated, registered user 202 preferably registers to obtain access the systems functions (alternatively preferably, user 202 may pay a fee for access to Matchmaker web site 300), as shown.

Upon accessing matchmaker computer system 101, registered user 202 preferably inputs, via at least one computer interface, personal contact information 5202 to matchmaker computer system 101 which is stored on an associated database. Registered user 202 also preferably enters, via at least one computer interface (preferably a form available on Matchmaker web site 300 [see FIG. 47]), proposed match preferences 5204 for unconfirmed, unscheduled proposed matches (depicted as calendar, compass, clock arrangement 5403) for storage on the associated database.

As is indicated and shown on FIG. 47, a highly preferred combination of data fields for preferred event preferences comprises the following: preferred activity (such as a sport), preferred start date, preferred start time, preferred end date, preferred end time, preferred location, preferred match type (single or group-type event), as shown. It is noted that users may specify a date range when that user is potentially available for a match. Preferably, users may specify the number of participants that are desired to participate in the proposed match. Preferably, users input a maximum number of desired participants (see FIG. 50, total players field). Preferably, users also may specify a skill level of desired participants (preferably a range [see FIG. 50 minimum level field and maximum level field]).

Also preferably, other data fields may be used to narrow the group of registered users with which a particular registered user may choose to associate. In FIG. 47, the following data fields are preferred: gender, age range, marital status, occupation(s), special circumstances or disabilities, and general listing of the days of the week that a registered user is able or willing to participate in a proposed event. Preferably, a note field may also be displayed for any other information a user may wish to communicate to a prospective match participant.

Also, as is shown in FIG. 52, registered user 202 may select a set of registered users among which to share proposed event preferences using matchmaker computer system 101. For illustrative purposes, FIG. 52 shows two sets of potential participant groups. Set A comprises User A1, User A2, User B1, and User B2. Set B comprises User B1 and User B2. Matchmaker computer system 101 preferably provides registered users with the ability to invite and associate a selected set of users, either the entire set of registered users of matchmaker computer system 101 or a selected subset of the entire set of registered users with one or more other registered users (i.e., the Player's Network, see FIG. 45 and FIG. 46). (The above arrangement at least embodying herein (a) computer activity-participation-sub-network processor means for assisting limiting participation in at least one such proposed multiple-person activity to specified users of such at least one plurality of registered users of at least one computer network, (b) computer activity-participation-sub-network processor means for assisting limiting participation in at least one such proposed multiple-person activity relating to personal profile data of such at least one plurality of registered users of at least one computer network, and (c) computer activity-participation-sub-network processor structured and arranged to assist limiting participation in at least one such proposed multiple-person activity to specified users of such at least one plurality of registered users of at least one computer network, and (d) at least one computer activity-participation-sub-network processor structured and arranged to assist limiting participation in at least one such proposed multiple-person activity relating to personal profile data of such at least one plurality of registered users of at least one computer network).

As shown on FIG. 45 and FIG. 46, a registered user uses matchmaker computer system 101 to communicate, preferably by messaging other registered users, requests, also called invitations, to join a member's preferred set of registered users. The invited users may then approve or deny the invitation.

With reference to FIG. 45, a screen of Matchmaker web site 300 is shown displaying a hyperlink to the personal profile of the inviting registered user. The screen shown in FIG. 45 also shows hyperlinks that, when clicked and followed, give an invitee/registered user the ability to accept or deny the invitation to join a Player's Network. Matchmaker web site 300 also permits a user to view those registered members which have been selected for inclusion within the Player's Network, the selected set of members, of a registered user.

Once in a Player's Network, the members of the Player's Network will have access to unscheduled, unconfirmed proposed matches 5403, which may also be referred to as Match Requests (see, e.g., FIG. 47).

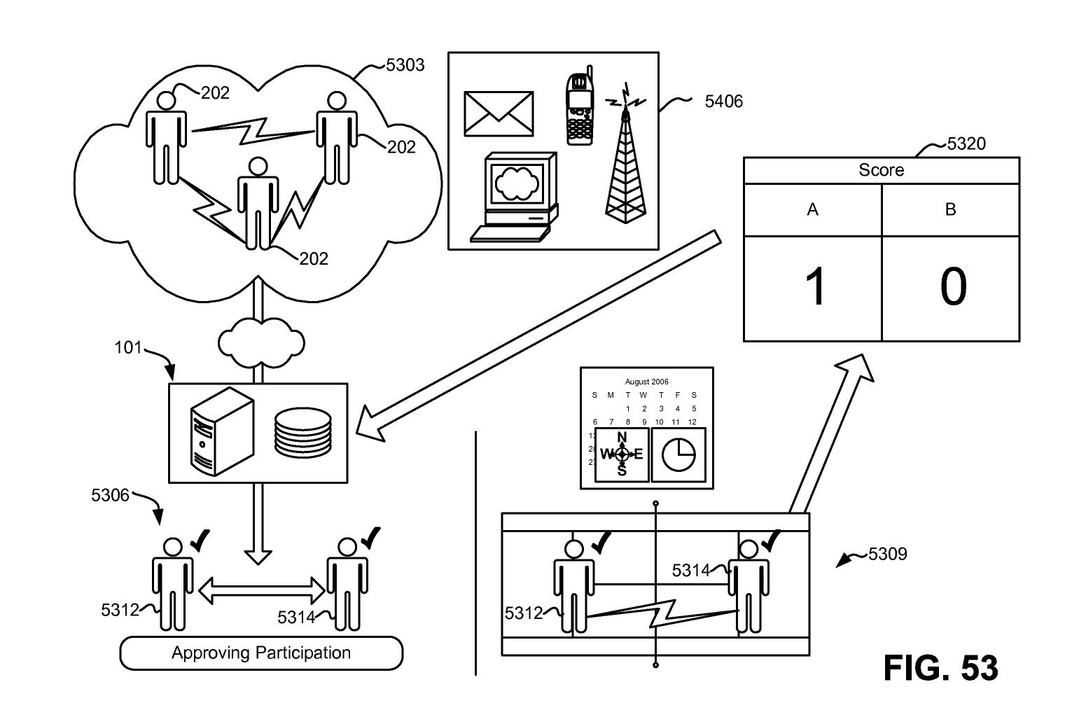

Matchmaker computer system 101 further provides the ability for registered users 202 to be notified of match requests submitted by the registered users of a particular selected set. Such notification may be provided with communication tools 5406 (see FIG. 53), preferably, Matchmaker web site 300, e-mail, SMS/text messaging using mobile telephones, instant messaging, and/or mobile devices having native applications.

Upon submission of proposed match preferences by at least one registered user 202 to a Player's Network (or to the entire set of users of matchmaker computer system 101), those proposed match preferences may be approved by another registered user so as to form a confirmed, scheduled match. Matchmaker computer system 101 preferably provides the ability for registered users 202 to communicate with one another (such step of communicating is depicted as communication cloud 5303), as shown in FIG. 52 and FIG. 53. Further, approved participant 5312 and approved participant 5314 are shown in FIG. 53 to illustrate such approval event.

FIG. 53 shows another simplified diagrammatic overview illustrating other features of the instant system according to the preferred embodiment of the present invention. More particularly, FIG. 53 further illustrates the approval process (such step of approving illustrated as approval step 5306) for confirming and scheduling proposed events among registered users of a Player's Network using matchmaker computer system 101.

Preferably, after an unscheduled, unconfirmed proposed match is displayed to a Player's Network, registered users 202 are presented with the option of approving or denying participation in a presented unscheduled, unconfirmed proposed match (such unscheduled, unconfirmed proposed match is typically displayed to a registered user by way of Matchmaker web site 300 or by way of SMS messaging [see FIG. 47]).

As shown in FIG. 53, registered users preferably communicate (with a variety of communication technologies) using matchmaker computer system 101 and also preferably through the Matchmaker web site 300. The goal of the presentation of proposed matches and providing approval is that at least two registered users will approve and confirm participation in a proposed match. Matchmaker web site 300 preferably automates the confirmation process as well as scheduling aspects of a proposed match so the proposed match may occur at a particular date, time, and location.

FIG. 48 illustrates the ability of registered users to communicate within Matchmaker website 300 using the internal email messaging of Matchmaker Web site 300. The internal email messaging system provides a registered user with the ability to read several match requests and approve or deny participation in that match request.

With reference to FIG. 49, Matchmaker Web site 300 preferably provides registered users with the ability to display match-availability to a selected set of registered users. Also shown is the result of a data field wherein a registered user may input a maximum number of participants which may join a particular match (Matchmaker Web site 300 preferably displays the number of remaining participation openings left to fill the match).

In operation, preferably, registered user 202 clicks on an approval hyperlink, shown and embodied in FIG. 49 with the displayed text “join this match now”, to communicate to an inviter that a participant is confirmed for the match. Upon clicking, matchmaker computer system 101 automatically performs the necessary updating of its database and communicates the approved confirmation to the inviting registered user. Further, the match is scheduled and is preferably displayed on the participating members personal profile pages (see, e.g., FIG. 50, “My Confirmed Matches”). The display of confirmed events is for the benefit of the participating member's personal time scheduling purposes. The above arrangement embodies computer hyperlink-generation-interface means for assisting generating at least one clickable hyperlink which, when clicked by at least one registered user, confirms that registered user's participation in such at least one multiple-person proposed activity and at least one computer hyperlink-generation-interface structured and arranged to assist generating at least one clickable hyperlink which, when clicked by at least one registered user, confirms that registered user's participation in such at least one multiple-person proposed activity.

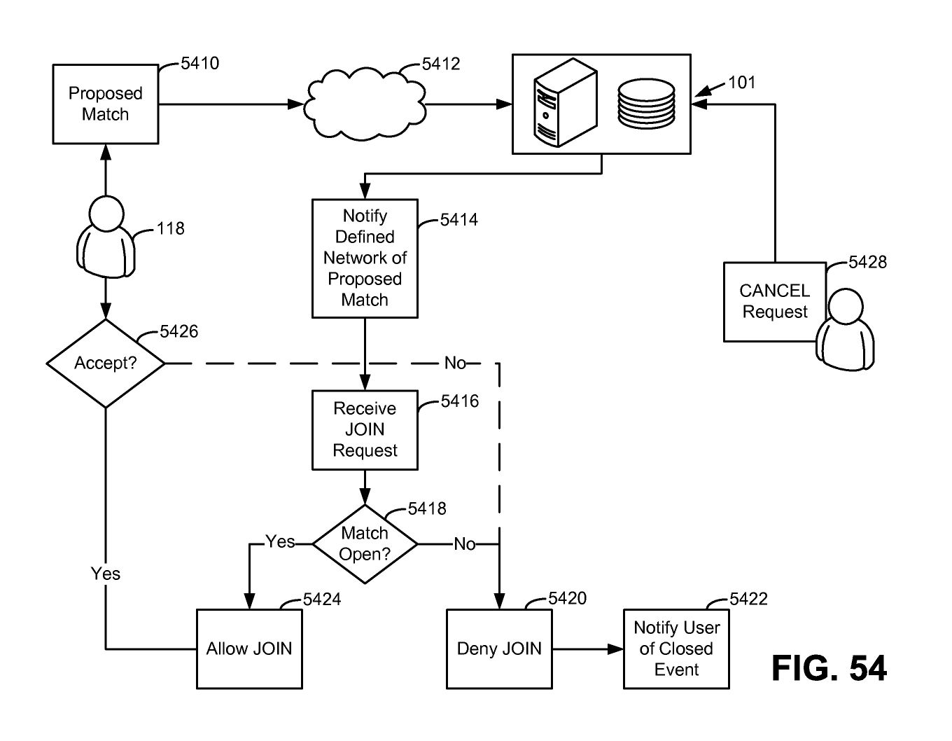

The above description shows the advantages of the peer to network communication model of the Matchmaker system. Preferably, Matchmaker system also incorporates a response management system, as described above, which further includes the ability for approved participants to cancel participation in a scheduled match. This may occur, for example, if the approved participant has a last minute emergency or has “overbooked” their schedule. In this scenario, the matchmaker computer system 101 manages the responses as illustrated in FIG. 54 (at least embodying herein computer activity-cancellation processor means for cancelling of at least one request to participate in at least one multiple-person proposed activity and computer activity-cancellation processor structured and arranged to cancel at least one request to participate in at least one multiple-person proposed activity). Further, matchmaker computer system 101 preferably initiates a re-communication of the availability of the proposed match after matchmaker computer system 101 detects a cancellation event.

FIG. 54 shows a flowchart illustrating a preferred response management system of the instant system according to a preferred embodiment of the present invention. More particularly, FIG. 54 shows a flowchart illustrating response management system 5403 of matchmaker computer system 101.

Preferably, a user of matchmaker computer system 101, for example user 118, using at least one computer interface communicatively coupled with matchmaker computer system 101, inputs a proposed match (preferred step 5410). In this example, user 118 uses a personal computer with an Internet browser to access matchmaker web site 300, logs in to matchmaker web site 300, and inputs data into the appropriate form (see, e.g., the form shown in FIG. 47). As indicated herein, users may also define proposed matches using web-enabled mobile computing devices, mobile telephones, and/or mobile computing devices with native applications which communicate with matchmaker computer system 101.

Preferably, the input information is transmitted to matchmaker computer system 101. Upon receipt of the input data, the database associated with matchmaker computer system 101 will be appropriately updated. Preferably, user 118 defines the maximum number of desired participants to participate in the proposed match (see FIG. 50 [total players field, “choose the max number including yourself”]). For example, a “doubles” game of tennis may have desired participation number of four. A “round robin” game of tennis may have a higher desired participation number (e.g., eight desired participants). In any regard, users of matchmaker computer system 101 preferably define the desired number of participants other than themselves (preferably a range from 1 to unlimited). Further, because activities at least require a minimum number of participants to effectively carry out the activity (one cannot play a doubles game of tennis with one person), this feature at least embodies herein wherein such at least one proposed multiple-person activity requires attendance of at least one minimum number of the multiple persons relating to such at least one proposed multiple-person activity or match. The above description at least embodies computer attendance-number-setting interface means for setting a number of attendees desired to participate in such at least one proposed multiple-person activity and at least one computer attendance-number-setting interface structured and arranged to set a number of attendees who are desired to participate in such at least one proposed multiple-person activity).

The user-input number and other input information (input to the computer interface) is preferably submitted to the matchmaker computer system 101 and the associated database is preferably updated. (At least embodying computer activity-participation-request interface means for assisting receiving at least one request from at least one such registered user to participate in such at least one multiple-person proposed activity; and at least one computer activity-participation-request interface structured and arranged to assist receiving at least one request from at least one such registered user to participate in such at least one multiple-person proposed activity). Such database (preferably database 102) at least embodies herein computer participation-request database means for automatically searchably storing such at least one request from such at least one registered user to participate in such at least one multiple-person proposed activity, and at least one computer participation-request database structured and arranged to automatically searchably store such at least one request from such at least one registered user to participate in such at least one multiple-person proposed activity.

Further, user 118 may also define what class of prospective participants that user 118 wishes to participate with (if any class is desired). For example, a user may only wish to interact with members of that user's Players Network, members of a certain gender, etc. If global positioning information is available to matchmaker computer system 101, registered user 118 may preferably select prospective participants who are in a particular geographic region at a particular time. Preferably, users may identify other users who have installed a “native application” on a mobile computing device (discussed below). The registered user may preferably select a class of prospective participants who have installed the native application. Further, mobile devices having native applications and global positioning technology may further be useful in that a user may pinpoint those prospective participants in a certain geographic area (via distance using global position data).

Once user 118 submits the proposed match information to matchmaker computer system 101 (via network cloud 5412, preferably the Internet), the database associated with matchmaker computer system 101 is preferably updated. At this time, preferably, matchmaker computer system 101 processes and transmits a notification of the proposed match to the appropriate users (the network of user 118, i.e., the users Player's Network or selected users) of the proposed match to solicit participation interest (step 5414). Those in the network of user 118 preferably receive e-mail notification, SMS message notification, or other electronic communication (preferably posting on matchmaker web site 300 as well as external e-mail notification) notifying the user of the proposed match. Preferably, users may select which method of communication that user prefers.

At this point the proposed match is considered “open”. Those in the network of user 118 may now choose to join the proposed match via electronic communication with matchmaker computer system 101.

When matchmaking computer system 101 receives a “join” request (preferred step 5416) for a proposed match, the system determines whether or not the proposed match is still open (preferred step 5418). The “open” conditions of matchmaking computer system 101 are preferably whether the maximum number of participants have joined the proposed match (and preferably have been approved by user 118) (an attendance condition) and/or whether the time input by user 118 for the proposed match has passed (a temporal condition). Further, matchmaking computer system 101 considers a match (also referred to as an activity) open when a cancellation is detected as described herein.

The “join” request is preferably transmitted via at least one computer interface communicatively coupled with matchmaker computer system 101. As indicated herein, the “joining” user may either visit matchmaker web site 300 and join a proposed match by clicking on an appropriate hyperlink (which will update the database associated with the matchmaker computer system 101), sending an SMS message by responding to an SMS proposed match notification (which will also update the database associated with the matchmaker computer system 101 after being processed by an SMS gateway and in a form usable by matchmaker computer system 101 and its associated database), or indicating participation interest via a mobile device native application.

In the event that matchmaker computer system 101 determines that the proposed match is closed, matchmaker computer system 101 will not permit that user to “join” the proposed match (preferred step 5420). Preferably, matchmaker computer system 101 notifies the user that attempted to join the proposed match, that the match is closed (preferred step 5422). This is advantageous in that user 118 does not have to deliver “bad news” to denied users.

In the event that matchmaker computer system 101 determines that the proposed match is open, matchmaker computer system 101 will permit that user to “join” the proposed match roster (preferred step 5424).

Preferably, user 118 has the option to accept or deny prospective participants after prospective users request participation in the proposed match (preferred step 5426), as shown (see also FIG. 47: accept/deny join request). Such arrangement embodies computer participation-approval processor means for approving of at least one request to participate in at least one multiple-person proposed activity and at least one computer participation-approval processor structured and arranged to approve of at least one request to participate in at least one multiple-person proposed activity. If the registered user accepts the prospective participant, matchmaker computer system 101 allows that prospective participant to join the proposed match (preferred step 5424). If not, matchmaker computer system 101 will not permit that user to “join” the proposed match roster (preferred step 5420). The above arrangement embodies herein computer activity-participation-closing processor means for preventing additional registered users from confirming participation in such at least one proposed multiple-person activity when the number of registered users scheduled to participate in such at least one scheduled activity is equal to the number of attendees desired to participate in such at least one proposed multiple-person activity and at least one computer activity-participation-closing processor structured and arranged to prevent additional registered users from confirming participation in such at least one proposed multiple-person activity when the number of registered users scheduled to participate in such at least one scheduled activity is equal to the number of attendees who are required to participate in such at least one proposed multiple-person activity.

If the event is closed and a user is denied, preferably, matchmaker computer system 101 notifies the user that attempted to join the proposed match, that the match is closed (preferred step 5422). Such notification is preferably an internal or external email, an SMS text message, or message delivered to a mobile device having matchmaker native application as described below. This arrangement embodies computer participation-status-communication processor means for automatically communicating participation status information to such registered users prevented from confirming participation in such at least one proposed multiple-person activity and at least one computer participation-status-communication processor structured and arranged to automatically communicate participation status information to such registered users prevented from confirming participation in such at least one proposed multiple-person activity. This is advantageous in that user 118 does not have to deliver “bad news” to denied users.

Once a proposed match is considered closed by matchmaker computer system 101 (at least embodying herein computer activity-closing processor means for closing at least one multiple-person proposed activity to prevent participation request acceptance when closing conditions are met and at least one computer activity-closing processor structured and arranged to close at least one multiple-person proposed activity to prevent participation request acceptance when closing conditions are met), future participants may only be added to the proposed match roster if a present participant cancels that participant's participation in the proposed match prior to the expiration of the proposed match time. Preferably, users may cancel their participation in a proposed match prior to the expiration of the time (a temporal condition) of the proposed match by interfacing with matchmaker computer system 101.

When matchmaking computer system 101 receives a cancellation request (preferred step 5428), the proposed match is now considered “open” (at least embodying herein computer activity-re-opening processor means for re-opening participation request acceptance in at least one multiple-person proposed activity when re-opening conditions are satisfied and at least one computer activity-re-opening processor structured and arranged to re-open participation request acceptance in at least one multiple-person proposed activity when re-opening conditions are satisfied). Preferably, matchmaker computer system 101 notifies prospective participants of the now available opening in the proposed match (preferred step 5414) (at least embodying herein re-opening-communicator processor means to automatically communicate such reopening of such at least one multiple-person proposed activity to the multiple persons relating to such at least one multiple-person proposed activity and at least one computer re-opening-communicator processor structured and arranged to automatically communicate such reopening of such at least one multiple-person proposed activity to the multiple persons relating to such at least one multiple-person proposed activity). This is advantageous in that the proposing user does not have to explain to all prospective participants that the match is now open for participation. Once re-opened, matchmaker computer system 101 allows users to “join” a proposed match until matchmaker computer system 101 determines again that a proposed match is “closed”. It is noted that this system permits users to communicate with the user's peer network in a very efficient way that was not possible with one to one communication.

Response management system 5403 at least embodies herein computer activity manager processor means for managing such at least one proposed multiple-person activity; wherein such computer activity manager processor means comprises computer activity-participation-response-manager processor means for managing at least one response, responsive to such at least one request, to participate in such at least one multiple-person proposed activity, computer activity-participation-manager processor means for assisting confirming sufficient participation in such at least one multiple-person proposed activity to form at least one scheduled activity, and computer scheduled-activity-communicator processor means for automatically communicating information relating to such at least one scheduled activity to registered users scheduled to participate in such at least one scheduled activity, and at least one computer activity-participation-response-manager structured and arranged to manage at least one response, responsive to such at least one request, to participate in such at least one multiple-person proposed activity; at least one computer activity-participation-manager processor structured and arranged to assist confirming sufficient participation in such at least one multiple-person proposed activity to form at least one scheduled activity; and at least one computer scheduled-activity-communicator processor structured and arranged to automatically communicate information relating to such at least one scheduled activity to registered users scheduled to participate in such at least one scheduled activity.

Returning briefly to FIG. 53, preferably, users participating in a match will meet and participate in the match, for example, a game of tennis, at a scheduled and confirmed time, date, and location based on the initial proposed match of a registered user (this arrangement of steps referred to as participating in match 5309).

After a period of time has elapsed from the date of confirmed, scheduled match, and upon a registered user visiting Matchmaker web site 300, Matchmaker website 300 provides a registered user with the ability to input data relating to the now-elapsed match into a form (see FIG. 51) which will be stored on Matchmaker database 320. In operation, a form is submitted to a registered user for data input (see FIG. 51) to gather data relating to the now-elapsed match (data 5320). Data 5320 may be the score, details of the match, behavioral characteristics of the participating member, etc. A registered user preferably enters requested data into the form. The requested data preferably comprises score, a notation whether or not the proposed match went as scheduled, and other behavioral-related questions or selections to rate the behavioral appropriateness of at least one other registered user who attended the match. The gathered data is then submitted to Matchmaker website 300 and stored for historical purposes. Reports relating to particular registered users may be generated and displayed by Matchmaker website 300 for the benefit of registered users and of a web site manager.

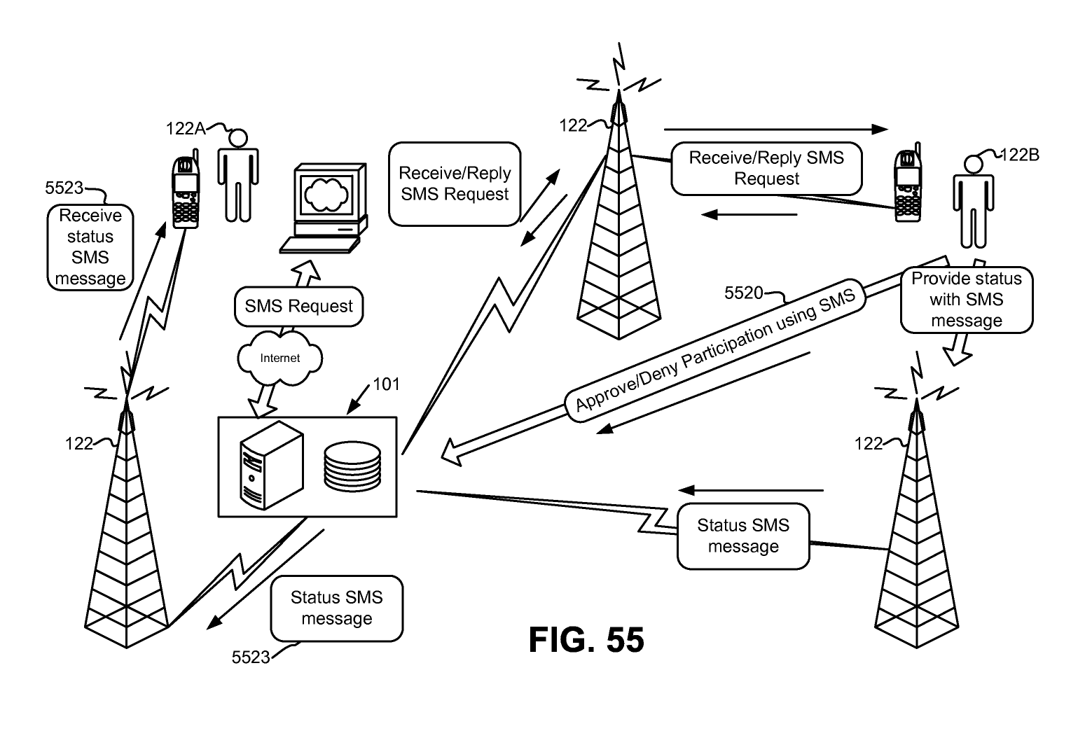

Also shown in FIG. 55, various communication mediums are available for registered users to communicate using Matchmaker website 300. Preferably, registered users 202 of Matchmaker website 300 may use email messaging provided by Matchmaker website 300 or short messaging service (SMS) messaging, also referred to as text messaging, communicatively coupled though Matchmaker website 300 (see FIG. 55).

FIG. 55 shows a simplified diagrammatic overview illustrating, generally, methods of communicating among registered users of matchmaker computer system 101 according to the preferred embodiment of the present invention. As shown in FIG. 55, matchmaker computer system 101 provides a registered user with the ability to send a match request to another registered user matchmaker computer system 101 wherein the match request is delivered to another registered user preferably by SMS messaging (which will typically be delivered to a compatible mobile telephone or other device used by the another registered user), as shown.

In operation, registered user 122A preferably accesses the SMS messaging features of Matchmaker Web site 300 (preferably with a personal computer). FIG. 46 shows a checkbox selection where a registered user may enable sending of Match Requests by email or SMS messaging. To use the mobile phone/SMS messaging features of Matchmaker Web site 300, a registered user must provide the registered user's mobile telephone number. Internet protocol (IP) hardware and software (which may comprises service providers, modems, telecommunication routers, SMS messaging servers, SMS gateways, and related software, etc.) and services provided by telephony companies are set up to enable mobile telephone communication with the at least one database associated with matchmaker computer system 101.

Upon making a proposed match preference or match request, an SMS message may be sent by way of the Internet using matchmaker computer system 101. The SMS message is preferably delivered with an installed IP telecommunications systems or SMS Gateway 5505 (symbolically depicted as a communications tower) so that the SMS message is delivered to a particular registered user, user 122B. Preferably, registered user 122B, the recipient of the SMS message, may respond to, approve or deny participation in a proposed match by replying to the sender of the text message (the SMS messaging system) by typing a particular word and sending a reply SMS message (preferred step 5520). As an illustration, a registered user who wants to join a match request may preferably reply to the SMS message sender with the word “JOIN”.

Preferably, matchmaker web site developer makes arrangements with IP and telecommunications/telephony service providers to have particular SMS message replies activate or update certain data on matchmaker computer system 101 and Matchmaker website 300 or relay a reply messages to the first sender (preferred step 5523).

Preferably, such “JOIN” message will subsequently be delivered through telecommunications systems and matchmaker computer system 101. Preferably, the database associated with matchmaker computer system 101.

Matchmaker website 300 may further provide communication among registered users who are en route to a proposed match location. Further, users may perform this communication in an anonymous fashion. In operation, registered user 122A either using Matchmaker web site 300 (through a desktop computer, laptop computer, or Internet enabled mobile phone) may request that an SMS message be sent to another particular registered user requesting a status update (distance to proposed match location, etc.). The SMS message is preferably delivered over IP telecommunications systems coupled to matchmaker computer system 101. Because communication occurs by way of matchmaker computer system 101, there is no need to disclose personal contact information, such as mobile telephone numbers, to other registered users. In this way registered users may communicate with one another anonymously, until a time when a registered user feels comfortable disclosing personal information.

The above arrangement embodies herein computer interface means for assisting receiving at least one telephone-transmitted signal relating to such at least one proposed multiple-person activity; computer telephone-transmitted-signal-to-user processor means for associating such at least telephone-transmitted signal with at least one registered user; computer telephone-transmitted-signal-interpreter processor means for interpreting such at least one telephone-transmitted signal as a denial to participate or confirmation to participate in such at least one proposed multiple-person activity responsive to such at least one request from at least one such registered user to participate in such at least one multiple-person proposed activity and at least one computer interface structured and arranged to assist receiving at least one telephone-transmitted signal relating to such at least one proposed multiple-person activity; at least one computer telephone-transmitted-signal-to-user processor structured and arranged to associate such at least telephone-transmitted signal with at least one registered user; at least one computer telephone-transmitted-signal-interpreter processor structured and arranged to interpret such at least one telephone-transmitted signal as a denial to participate or confirmation to participate in such at least one proposed multiple-person activity responsive to such at least one request from at least one such registered user to participate in such at least one multiple-person proposed activity.

### Matchmaker Native Application

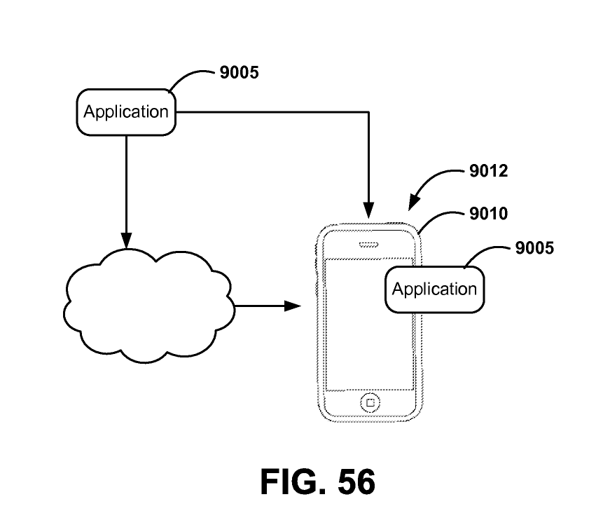

FIG. 56-58 relate to use of the features of the herein disclosed matchmaker systems on a native application installed on a mobile device.

FIG. 56 shows a schematic diagram, illustrating installing mobile native application on mobile device, according to a preferred embodiment of the present invention.

Preferably, a user who wishes to interact with matchmaker computer system 101 on a mobile device, such as a mobile phone, will install at least one native application 9005 onto a desired mobile device (mobile device 9010) of user. Mobile device 9010 is most preferably an iPhone sold by Apple, Inc., having a corporate address in Cupertino, Calif. Upon reading the teaching of this specification, those of ordinary skill in the art will now understand that, under appropriate circumstances, considering such issues as mobile device supplier, mobile device networks available, other mobile devices, such as BlackBerrys, smart phones, iPods, play station portable devices, LG brand mobile devices, etc., may suffice.

Preferably, download of mobile native application 9005 may be initiated through a computer application, such as iTunes managed by Apple Inc., or through the mobile device itself via a mobile device network (such as Verizon's Get It Now service or the Internet). In FIG. 56, the “network” is depicted as a cloud. In both instances, mobile native application 9005 is delivered to mobile device 9010 for installation. Once the application is downloaded and installed on mobile device 9010, the functions of mobile native application 9005 are available to the user so that the user may communicate with matchmaker computer system 101 and user network.

With mobile native application 9005 installed on mobile device 9010, mobile device 9010 becomes service-enabled mobile device 9012, as shown. Preferably, mobile native application 9005 resides on mobile device 9010, as shown. Mobile device 9010 preferably comprises input, output, memory and processor means to carry out the functions of native application 9010. Mobile device 9010 preferably comprises network interface technology (preferably wireless network interface technology). Mobile device 9010 also preferably comprises Global Positioning Technology.

FIG. 57 shows a schematic diagram, illustrating use of sports matchmaking system with a “Push Service”, according to a preferred embodiment of the present invention. Matchmaking system described herein also preferably comprises service-enabled mobile device 9012 that preferably utilizes “Push Service” 9000, as shown. Push Service 9000 preferably comprises a system to establish a persistent background connection between service-enabled mobile device 9012 and database server 9015.

In a preferred embodiment, users may preferably access database server 9015 via mobile device 9010, a computer with an Internet browser (see, e.g., FIG. 2), and/or via SMS text messaging (see FIG. 55). In this preferred arrangement, users of the sports match making system may access the features and functions of the system while virtually anywhere.

Alternatively, but less preferred, database server 9015 may be an offline (not Internet connected) computer that stores at least one matchmaker backend database that will be searched in accord with the SMS and/or Push Service commands that database server 9015 receives from mobile devices of a user via satellite and/or cell phone cellular tower transmissions.

Database server 9015 also preferably collects received data and sends it via SMS or via Push Service 9000 to the mobile device of the user.

As shown in FIG. 57, service-enabled mobile device 9012 may make a request of others in the sports matchmaker network that also have service-enabled mobile devices 9012. The request is preferably communicated to database server 9015 to find other users with service-enabled mobile device 9012 to push the request to those mobile devices. The request is then sent to push service 9000. Lastly, the request is “pushed” down to service-enabled mobile device 9012 to notify users about a request, e.g., a match. Using push service 9000 sports matchmaker network users may communicate with one another without a personal computer.

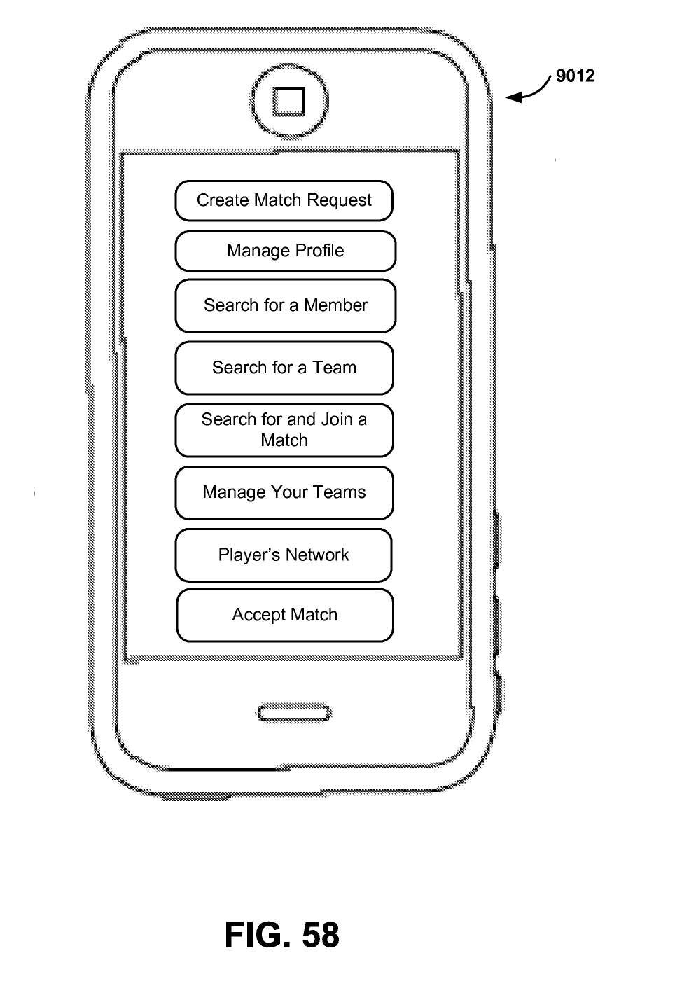

FIG. 58 shows a close up view of a mobile device according to a preferred embodiment of the present invention.

In addition to the above, mobile native application 9005, when installed on mobile device 9010, allows a user to access and perform the functions available via matchmaker computer system 101 and matchmaker Web site 300 (available at http://www.sportsmatchmaker.com). Preferably, a user interface is displayed on service-enabled mobile device 9012 so that a user may perform the appropriate function. Some functions preferably include the following: create match request, manage profile, search for a member, search for a team, search for and join a match, manage your teams, and access to the player's network (all as shown in FIG. 57). Other functions preferably include Match Denying, Match Canceling, Match Deleting, and other management features.

Upon reading the teachings of this specification, those with ordinary skill in the art will now understand that, under appropriate circumstances, considering such issues as features available on matchmaker computer system, matchmaker Web site, etc., other features such as providing historical reports of past matches, displaying other users on a map using global positioning technology, etc., may suffice.

### Expansion of Matchmaker Services

Preferably, matchmaker system and features of matchmaker system may be offered to be used by other web sites offering their own goods or services. In a preferred embodiment of offering the matchmaker features to others, preferably, an arrangement is made between owners of sports matchmaker systems and other web sites wherein, in exchange for compensation (preferably a fee), the owners of matchmaker systems will provide a marketing package comprising social media marketing integration into the other web site.

The marketing package differs from digital advertisements (also known as “banner advertisements”) in that the marketing package provides other web sites with matchmaker system features to drive customers to their websites and their brick and mortar facilities. More particularly, the marketing package provides integration of the matchmaker system features into the web site of another web site.

To illustrate the above paragraph, owners of matchmaker web site preferably offer to an interested party the ability to use matchmaker features (as described above) in the web site of the interested party. When an offer is accepted by an interested party, the interested party and owner of the matchmaker system will work together to implement the marketing package provided by the matchmaker system owner.

Preferably, the marketing packaged includes some of the following:

(1) Electronic banner advertisements advertising the goods and services of the interested party displayed on matchmaker web site 300.

(2) Listings in the Player's Guide of matchmaker web site 300.

(3) Approval to integrate the matchmaker system features within the interested party web site by embedding the matchmaker system features preferably by way of a “plug-in” module. For example, an airline or gym would have sports matchmaker system features on the interested party airline or gym web site. Preferably, the interested party web site navigation and identifying information (preferably the web site header) would preferably be viewable and useable in addition to the embedded features of matchmaker web site. Preferably, matchmaker web site would be displayed in a “frame” on the interested party web site. Alternately preferably, matchmaker web site would be preferably displayed on the interested party web site using a widget (a widget is essentially portable code that can be installed and executed within any separate HTML-based web page). Alternately preferably, matchmaker web site would be preferably displayed on the interested party web site using programming code referred to as an “include”.

In this preferred arrangement, information submitted in the matchmaker web site portion (e.g., profile creation, match creation, match requesting, etc.) will interface with matchmaker computer system 101.

(4) Automated tracking of all referrals (i.e., users who register with matchmaker computer system 101 from the interested party web site or users who register with matchmaker computer system 101 after following a hyperlink from the interested party web site to matchmaker web site 300);

(5) Automated redirect of interested party referrals (registered with matchmaker computer system 101 as described in (4) above) back to the interested party web site if the referral user logs in at the URL of matchmaker web site 300. Put another way, a referral will be redirected from the URL of matchmaker web site 300 to the URL of the interested party web site to access the matchmaker system features.

(6) Ability to sell banner advertisements hosted on the third party web site above the matchmaker system “plug-in” features for added revenue. Preferably, there is no revenue sharing with the matchmaker system since the interested party web site hosts the banner advertisements on the interested party web site.

(7) Automated inclusion of interested party web site referrals into the interested party web site's Player's Network. Preferably, a matchmaker system profile for the interested party will be established. Referrals will be automatically added to the Player's Network of the interested party web site's profile. This is advantageous in that the interested party web site may preferably view their referrals. Further, the interested party web site may preferably communicate with their referrals via the matchmaker system features, including organizing and requesting “matches” or “activities” using the matchmaker system features.

(8) Technical Support for the interested party web site, matchmaker web site profile set up, and consultation on how to best use the above features for promotional purposes.

The above described arrangement at least embodies a method comprising the steps of offering, by at least one social network web site to at least one other web site, integration of at least one social network web site feature of the at least one social network web site for display on such at least one other web site; integrating, upon acceptance of such offering, of at least one social network web site feature of the at least one social network web site for display on such at least one other web site; wherein users of the at least one other web site are permitted to access such at least one social network web site feature while at the at least one other web site.

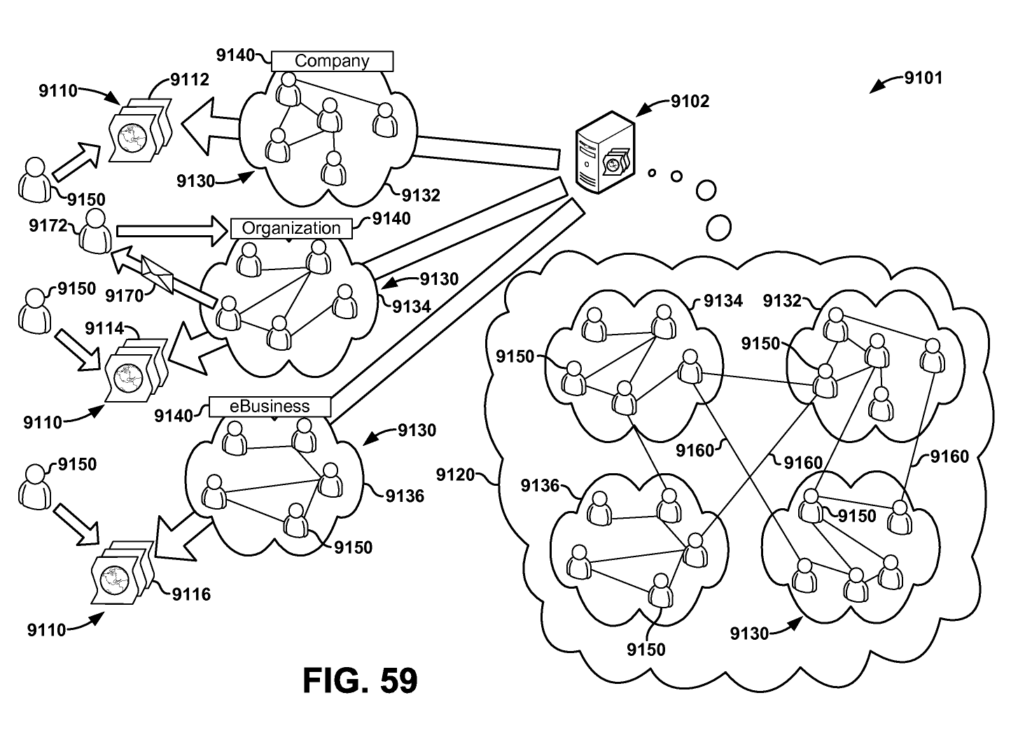

FIG. 59 through FIG. 73 illustrate, through diagrammatic and exemplary screenshot views, details of integration of matchmaker systems into interested party websites. While many of the features of integrated matchmaker system 9101 are carried over from matchmaker computer system 101, it will be understood that integrated matchmaker system 9101 preferably comprises alternate deployment functions, features, and structures to achieve integration of matchmaker computer system 101 into at least one interested party website 9110.

FIG. 59 shows a diagrammatic view illustrating user and website interactions in integrated matchmaker system 9101, according to a preferred embodiment of the present invention.

Integrated matchmaker system 9101 preferably integrates matchmaker computer system 101 into at least one interested party website 9110, as shown. Such integration is preferably through at least one subdomain, alternately preferably through at least one plugin, alternately preferably at least one widget, alternately preferably at least one coding include. Upon reading the teachings of this specification, those skilled in the art will now appreciate that, under appropriate circumstances, considering such issues as cost, future technologies, etc., other integration methods, such as, for example, feeds, masking, datastreams, frames, stand-alone websites (private labeled matching service websites), etc., may suffice.

Integrated matchmaker system 9101 preferably comprises at least one central server 9102, as shown. Central server 9102 preferably serves information for integrated matchmaker system 9101, preferably providing at least one global social network 9120, as shown. Central server 9102 (at least embodying herein at least one central social-network computer server structured and arranged to serve, by at least one computer, the at least one social-network website-service to the at least one website; and at least embodying herein central social-network computer server means for serving, by at least one computer, the at least one social-network website-service to the at least one website) preferably further provides at least one social network 9130 to each interested party website 9110, as shown, preferably as an integrated portion of interested party website 9110 (this arrangement at least embodying herein serving, by at least one computer, the at least one social-network website-service to the at least one website). Each social network 9130 is preferably associated with one interested party website 9110, as shown. In addition, global social network 9120 preferably comprises each social network 9130, as shown. Upon reading the teachings of this specification, those skilled in the art will now appreciate that, under appropriate circumstances, considering such issues as future technologies, cost, etc., other server systems, such as, for example, distributed load servers, virtual servers, peer-to-peer server distribution protocols, etc., may suffice.

Demonstrative of integrated matchmaker system 9101, FIG. 59 illustrates three interested party websites 9110, representative of all interested party websites 9110 in integrated matchmaker system 9101, comprising company website 9112, organization website 9114, and ebusiness website 9116, as shown. Company website 9112, organization website 9114, and ebusiness website 9116 each preferably have integrated one social network 9130 preferably comprising company social network 9132, organization social website 9134 and ebusiness social network 9136, respectively. Therefore, in use, each interested party website 9110 preferably comprises one or more social networks 9130, as shown, through integration of matchmaker computer system 101 into each interested party website 9110. Upon reading the teachings of this specification, those skilled in the art will now appreciate that, under appropriate circumstances, considering such issues as future technologies, website utility, etc., other websites, such as, for example, military websites, government websites, intranet websites, collaborative websites, etc., may suffice.

At least one user 9150 preferably registers for social network 9130 through interested party website 9110. Central server 9102 preferably associates user 9150, upon registration, with social network 9130 and interested party website 9110 through which user 9150 registered, as shown (at least embodying herein associating each of the users with at least one specific social network website of such plurality of the at least one social network websites; and this arrangement at least herein embodying wherein such user-to-network associator computer processor associates the users to such at least one specific social network website through which the users register; and this arrangement at least herein embodying user-to-network associator computer processor means for associating each of the users with at least one specific social network website of such plurality of the at least one social network websites). Therefore, in use, if user 9150 registers through company website 9112, user 9150 preferably becomes a member of company social network 9132, as shown; likewise, if through organization website 9114 or ebusiness website 9116, user 9150 will preferably become a member of organization social network 9134 or ebusiness social network 9136, respectively (this arrangement at least herein embodying wherein such user-to-network associator computer processor means associates the users to such at least one specific social network website through which the users register; and this arrangement at least embodies herein wherein such step of associating associates the users to such at least one specific social network website through which the users register). This arrangement at least embodies herein at least one user-to-network associator computer processor structured and arranged to associate each of the users with at least one specific social network website of such plurality of the at least one social network websites. Upon reading the teachings of this specification, those skilled in the art will now appreciate that, under appropriate circumstances, considering such issues as future technologies, cost, etc., other registration methods, such as, for example, multiple-site registrations, transfer registrations, direct registrations, etc., may suffice.

As part of integration with interested party website 9110, social network 9130 preferably comprises at least one private label 9140, as shown. Central server 9102 preferably applies private label 9140 to social network 9130 upon serving social network 9130 to user 9150 (this arrangement at least embodying herein at least one service integrator computer processor structured and arranged to integrate the at least one social-network website-service into the at least one website as the at least one social network website; and at least embodying herein service integrator computer processor means for integrating the at least one social-network website-service into the at least one website as the at least one social network website). Private label 9140 preferably encapsulates presentation of social network 9130, preferably to carry through the look and feel of interested party website 9110. Further private label 9140 preferably comprises at least one navigation feature for interested party website 9110, preferably permitting user navigation from social network 9130 to other portions of interested party website 9110, thereby preferably driving traffic by use of social network to interested party website 9110. This arrangement at least embodies herein integrating the at least one social-network website-service into the at least one website as the at least one social network website. Upon reading the teachings of this specification, those skilled in the art will now appreciate that, under appropriate circumstances, considering such issues as cost, future technologies, etc., other private labeling, such as, for example, templates, plugins, framing, APIs, etc., may suffice.

Further, due to private label 9140, users 9150 registering and using social network 9130 preferably associate social network 9130 with interested party website 9110. Therefore, user 9150 of company social network 9132 considers it as part of company website 9112, and recognizes company website 9112 as the provider of the service rendered to user 9150 in company social network 9132. Therefore, upon registration, user 9150 understands they are registering with company social network 9132 and owners and administrators of company website 9112 will have access to any information provided by user 9150 for registration. Therefore, social network 9130 preferably provides advertising lead generation for owners and administrators of interested party website 9110.

In addition, social network 9130 preferably permits user 9150 to send at least one invitation 9170 to at least one non-user 9172 of social network 9130, preferably inviting non-user 9172 to join social network 9130. Therefore, in use, user 9150 preferably sends invitation 9170 to non-user 9172. Preferably, non-user 9172 accepts invitation and joins social network 9130. Upon joining, non-user 9172 becomes one of users 9150 of the same social network 9130 as user 9150 who sent invitation 9170. Therefore, as illustrated in FIG. 59, user 9150 of organization social network 9134 invites non-user 9172 to join organization social network 9134. Thus, organization social network 9134 grows in membership from the efforts of users 9150 of organization social network 9134.

Integrated matchmaker system 9101 is preferably arranged not only to provide integration of individual social networks 9130 to interested party websites 9110, but also preferably to permit social interactions 9160 between users of different social networks 9130. Any member of an individual social network 9130 also automatically is a member of global social network 9120 (at least embodying herein at least one cross social-network interaction computer interface structured and arranged to interface social-interactions between users across a plurality of the at least one social network websites of a plurality of the at least one websites; and at least embodying herein cross social-network interaction computer interface means for interfacing social-interaction between users across a plurality of the at least one social network websites of a plurality of the at least one websites; and at least embodying herein interfacing social-interaction between users across a plurality of the at least one social network websites of a plurality of the at least one websites). Since, social network 9130 is part of global social network 9120, each social network 9130, large or small, benefits from the larger membership of combining all members of global social network 9120. Therefore, in use, user 9150 of company social network 9132 preferably may socially interact with user 9150 of organization social network 9134 and/or user 9150 of ebusiness social network 9136, as members of global social network 9120 (at least herein embodying wherein, when integrated, the at least one website comprises the at least one social network website permitting such social interactions between the users at the at least one website). In this way, ebusiness social network 9136, if just starting out, is not confined solely to its small membership to provide social interactions 9160 to user 9150 of ebusiness social network 9136.

Integrated matchmaker system 9101 by design will preferably have multiple access “doors” to global social network 9120 as multiple social networks 9130. Therefore, integrated matchmaker system 9101 preferably tracks memberships within social networks 9130 to always associate user 9150 with a specific social network 1930. Since each user 9150 is associated with a specific social network 9130, when user 9150 utilizes another social network 9130, which is part of global social network 9120, to login, user 9150 is redirected to social network 9130 with which they are associated. Therefore, in use, if user 9150 of company social network 9132 attempts to login at organization website 9114 to organization social network 9134, user 9150 will be redirected to company social network 9132.

In an alternate embodiment, owners and administrators of interested party website 9110 may choose to have a private version of social network 9130. In such private version, social network 9130 is “walled off” and cannot permit social interactions beyond social network 9130, effectively isolating social network 9130 from global social network 9120. Upon reading the teachings of this specification, those skilled in the art will now appreciate that, under appropriate circumstances, considering such issues as cost, future technologies, use environment, etc., other social network interaction arrangements, such as, for example, one-way walled off, multi-level subscription (i.e. walled and open) for users, selectively walled (open with only select other social networks), etc., may suffice.

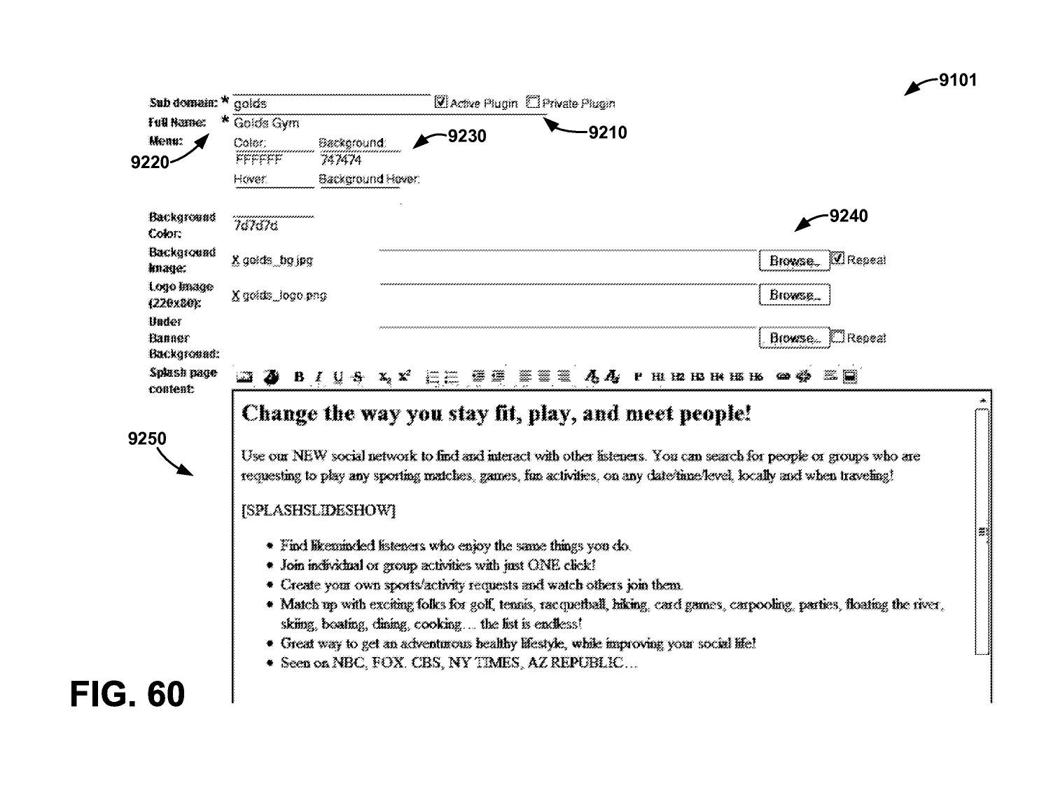

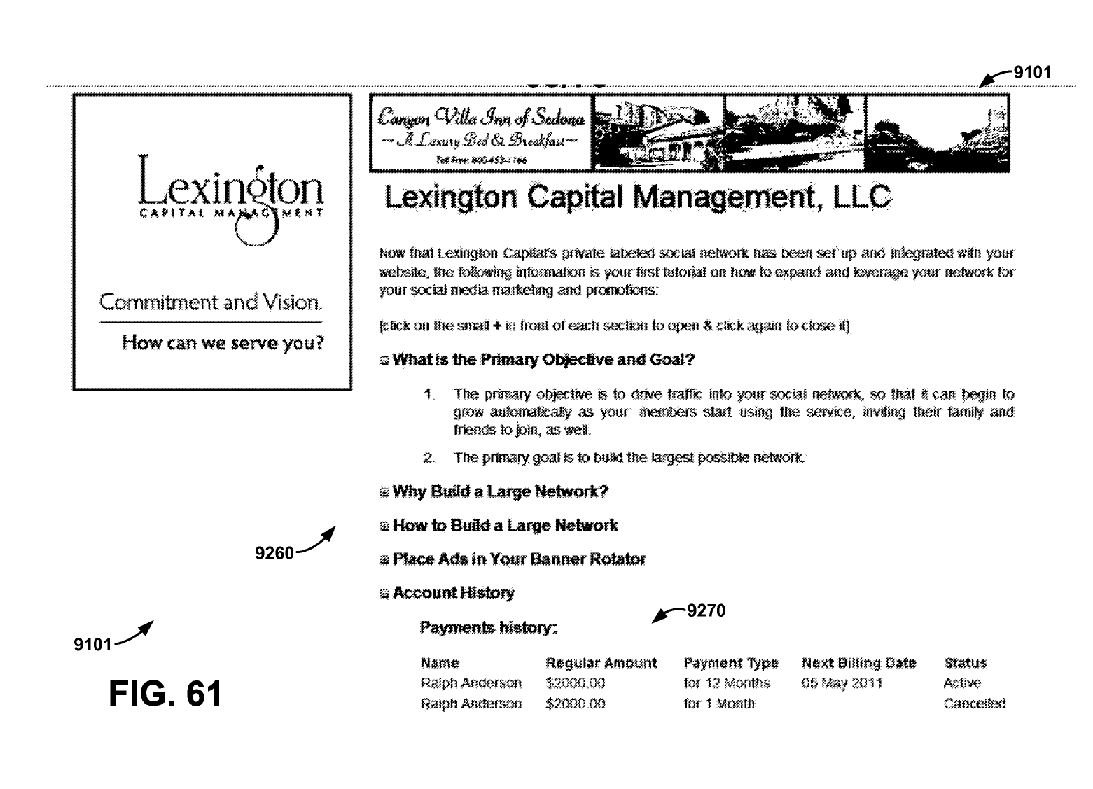

FIG. 60 shows an exemplary screenshot view illustrating administration of an integrated matchmaker system according to the preferred embodiment of FIG. 59. FIG. 61 shows an exemplary screenshot view, illustrating an administrative account screen, according to the preferred embodiment of FIG. 59. Each interested party website 9110 (client) preferably receives an account area where they control their plug-in content, look and feel, banner rotation, payments, account history, tutorial on how to use the tools for social media marketing, etc.

As shown in FIG. 60, clients can choose a “Private Plug-in” or a “Public Plug-in” with at least one selector 9210. Public is preferably the default option. Public means the members of any private Plug-in can search for and interact with the members of any other Public Plug-in. The Private Plug-in is a “walled garden” system, which is a network that is not open to others outside of the specific Plug-in network members.

Clients preferably can adjust color settings 9230 (at least herein embodying wherein such at least one website-theme matcher comprises at least one color-scheme common to both the at least one social network website and the at least one website; and at least herein embodying wherein such service integrator computer processor means comprises website-theme matcher means for matching at least one website-theme of the at least one social network website to at least one website-theme of the at least one website). Color settings 9230 preferably comprise menu color, menu background color, hover color, background color, and background hover color. Clients can also change plugin names 9220. Plugin names 9220 preferably comprise subdomain name and full name. Likewise, clients preferably can select and upload images in image settings 9240. Image settings 9240 preferably comprise removal, upload, and repeat fields, preferably for background images, logo images, and under banner background images. Additionally, clients can preferably create and edit splash page content in content editor 9250. Content editor 9250 preferably is a WYSIWYG (what you see is what you get) text format editor. This arrangement at least herein embodies wherein such step of integrating comprises matching at least one website-theme of the at least one social network website to at least one website-theme of the at least one website. Upon reading the teachings of this specification, those skilled in the art will now appreciate that, under appropriate circumstances, considering such issues as future technologies, cost, etc., other customization features, such as, for example, module relocation, tracking tagging, module addition/removal, etc., may suffice.

In addition, as shown in FIG. 61, clients preferably can access account payments and history through at least one account payments and history interface 9270, as shown. Moreover, clients are preferably provided with guidance with at least one help text 9260. Help text 9260 preferably answers frequently asked questions and provides ideas on how and why to promote and expand social network 9130. This arrangement at least herein embodies wherein such at least one administrator computer interface comprises at least one user-data accessor computer interface structured and arranged to access user-data of the users associated with such at least one specific social network website. Upon reading the teachings of this specification, those skilled in the art will now appreciate that, under appropriate circumstances, considering such issues as future technologies, cost, etc., other guidance tools, such as, for example, video clips, forums, help desks, etc., may suffice.

Clients preferably may also sell advertisement space and upload advertisements through administrative interfaces. Clients preferably keep 100% of top banner slot ad revenue. Additionally, clients can edit the navigation linking social network 9130 with interested party website 9110.

This arrangement at least embodies herein at least one administrator computer interface structured and arranged to permit administration of such at least one specific social network website; and this arrangement at least embodies herein administrator computer interface means for permitting administration of such at least one specific social network website; and this arrangement at least embodies herein permitting administration of such at least one specific social network website.

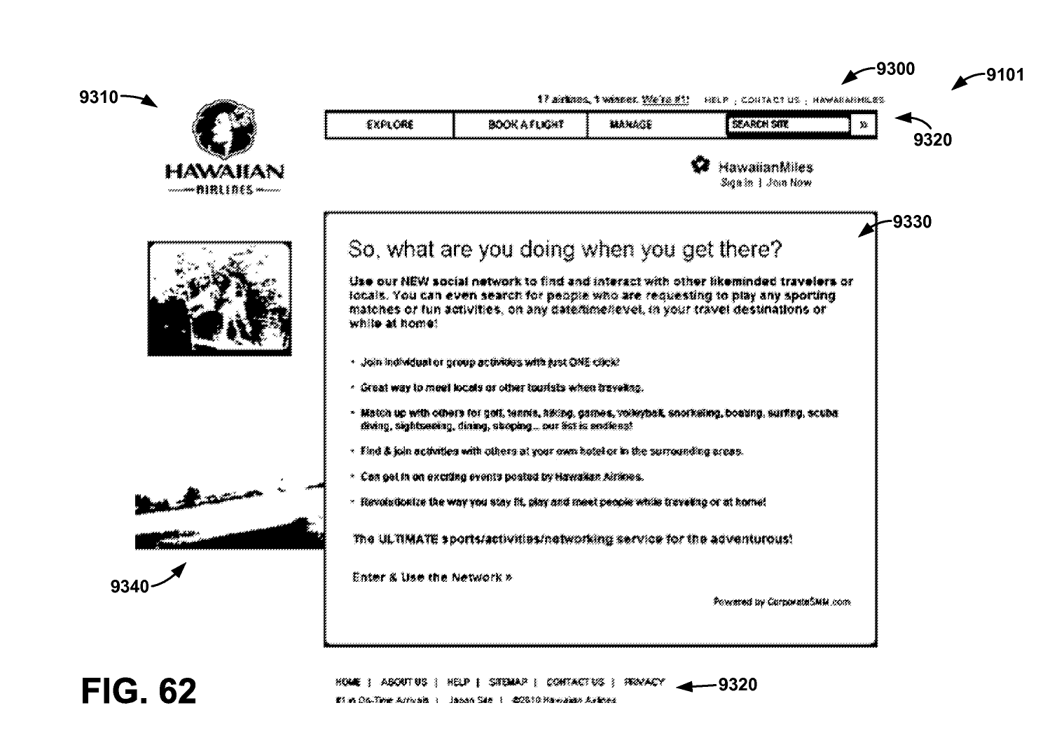

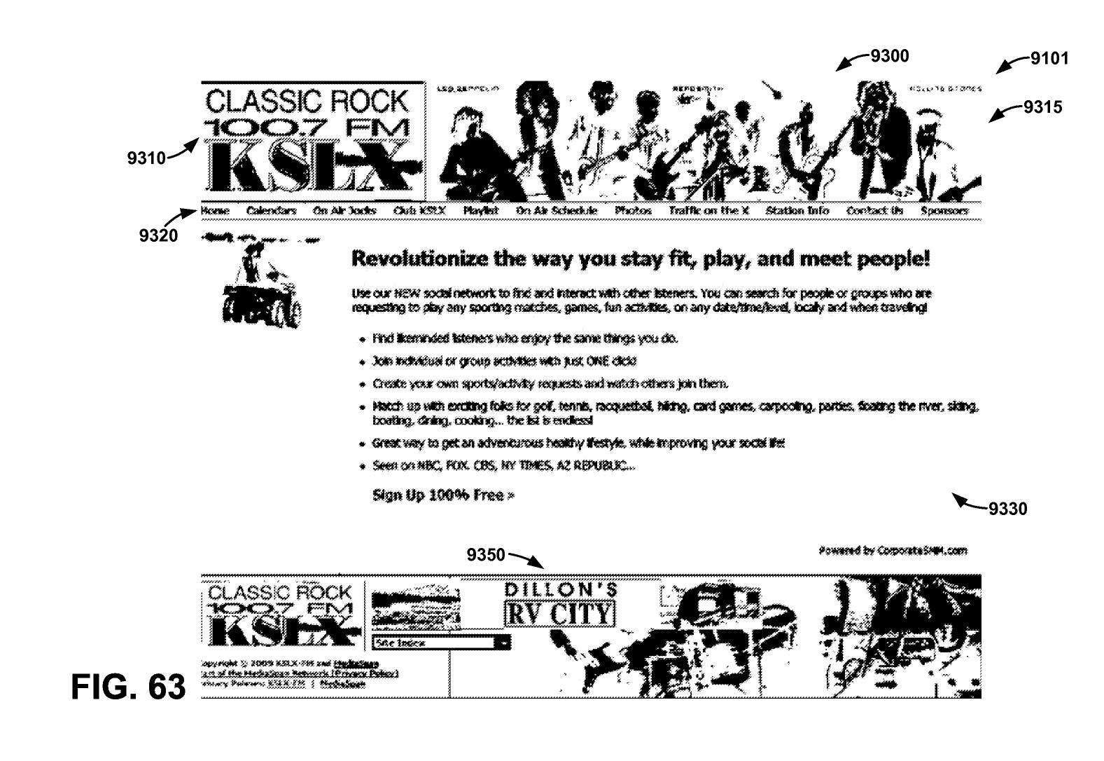

FIG. 62 and FIG. 63 show exemplary screenshot views, illustrating private-labeled user introductory screens, according to the preferred embodiment of FIG. 59.

Introductory screens 9300 preferably comprise private label 9140 preferably comprising at least one logo graphic 9310 (at least herein embodying wherein such at least one website-theme matcher comprises at least one logo common to both the at least one social network website and the at least one website), at least one banner background 9315, at least one navigator 9320 (at least herein embodying wherein such at least one website-theme matcher comprises at least one navigation feature to navigate between the at least one social network website and the at least one website), at least one text content 9330, at least one background 9340, and at least one advertisement 9350, each as appropriate to integrate social network 9130 as part of interested party website 9110, as shown. Layout of introductory screen 9300 is preferably custom designed at initial integration, preferably to maximize seamless integration with interested party website 9110, as shown. Therefore, in use, individual elements are included, excluded, and/or located on introductory screen 9300 to substantially match interested party website 9110, as shown (this arrangement at least herein embodying wherein such at least one service integrator computer processor comprises at least one website-theme matcher structured and arranged to match at least one website-theme of the at least one social network website to at least one website-theme of the at least one website).

Private label 9140 preferably provides integration with interested party website 9110 and navigation from social network 9130 to interested party website 9110, as shown. However, while navigation from interested party website 9110 to social network 9130 may be present with integration, links to social network 9130 may be separated from or buried in interested party website 9110. In use, no link from interested party website 9110 is required. Owners and administrators of interested party website 9110 may preferably choose to provide links or references to social network 9130 through email, advertisements, or receipts. Thereby, social network 9130 may preferably be utilized as a “plug-in” to the marketing methods of the owners and administrators of interested party website 9110, preferably without directly being linked from party website 9110 while still being an integrated part thereof.

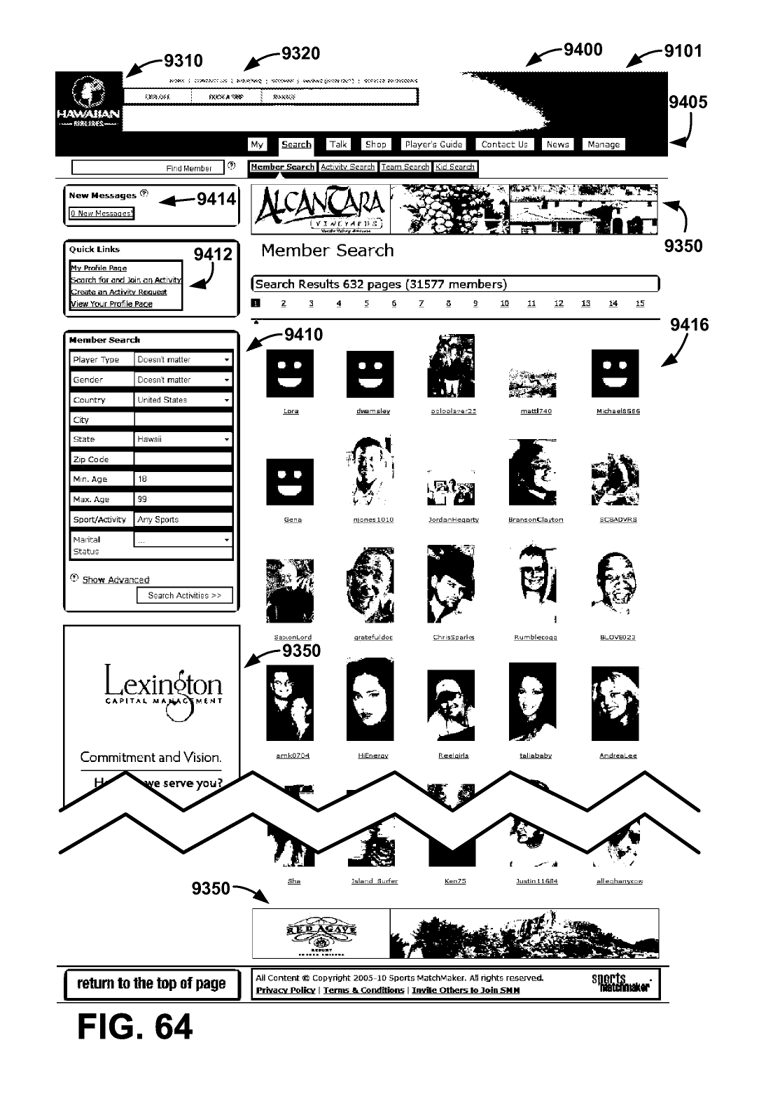

FIG. 64 shows an exemplary screenshot view, illustrating a member search results screen 9400, according to the preferred embodiment of FIG. 59.

Member search results screen 9400 shows the results of member search 306. As part of integrated matchmaker system 9101, representative of all user interface screens, member search results screen 9400 preferably comprises logo graphic 9310, navigator 9320, as shown. Additionally other viewable integration elements of private label 9140 (banner background 9315, background 9340, advertisement 9350, etc.) are preferably utilized to complete integration as part of interested party website 9110, as shown.

Navigation of matchmaker computer system 101 preferably utilizes navigator 9405, separate from navigator 9320 for interested party website 9110, as shown. Additional tools comprising message information 9414, quick links 9412 and search tools 9410 preferably present suitable functionality to user 9150, as shown. Message information 9414 preferably comprises new message counts, as shown. Quick links 9412 preferably comprises commonly used navigation locations, as shown. Search tools 9410 preferably comprise entry fields to conduct a search, similar to member search 306, as shown. Results of searches preferably are displayed in search results area 9416, preferably with appropriate pagination, as shown.

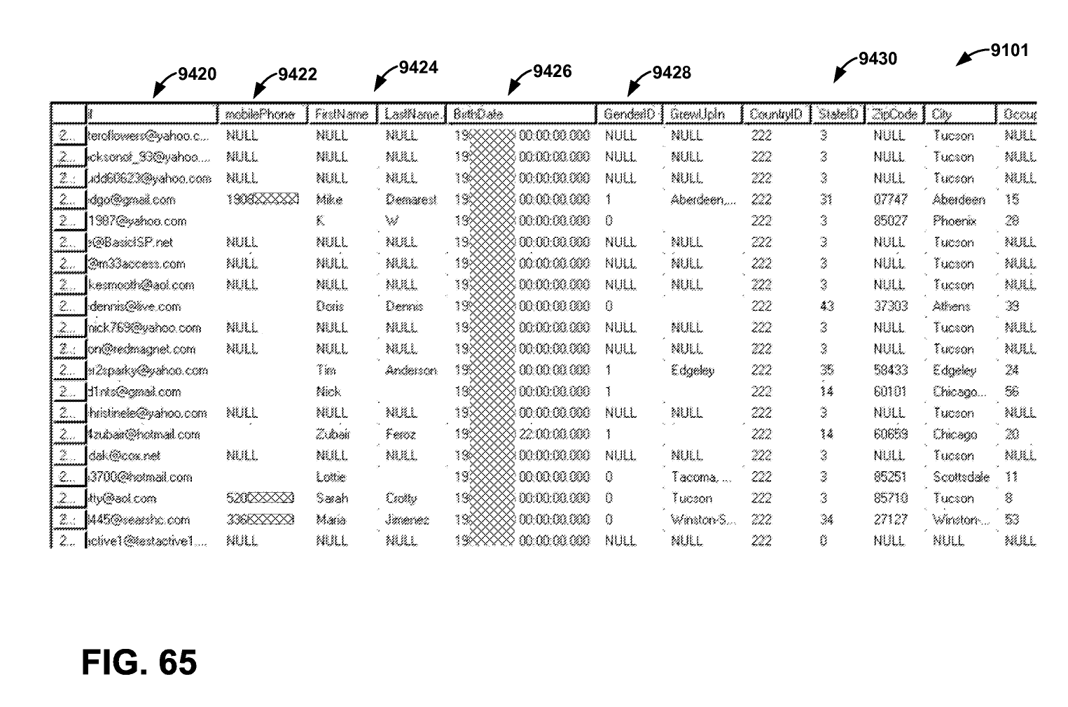

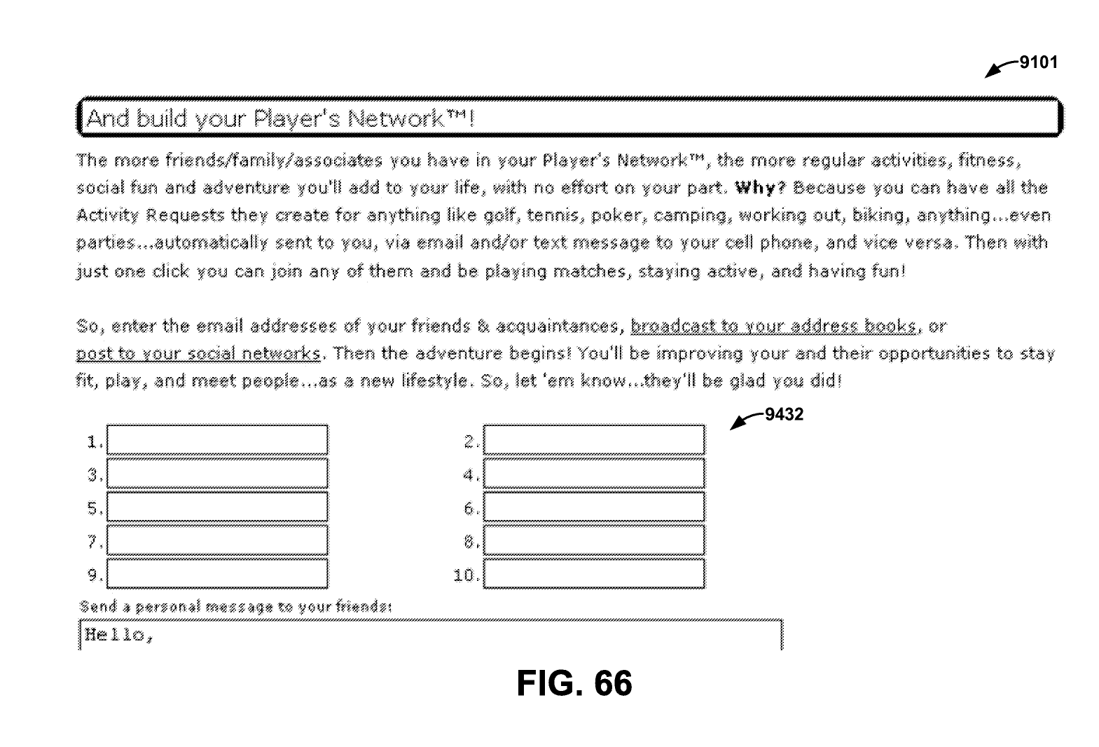

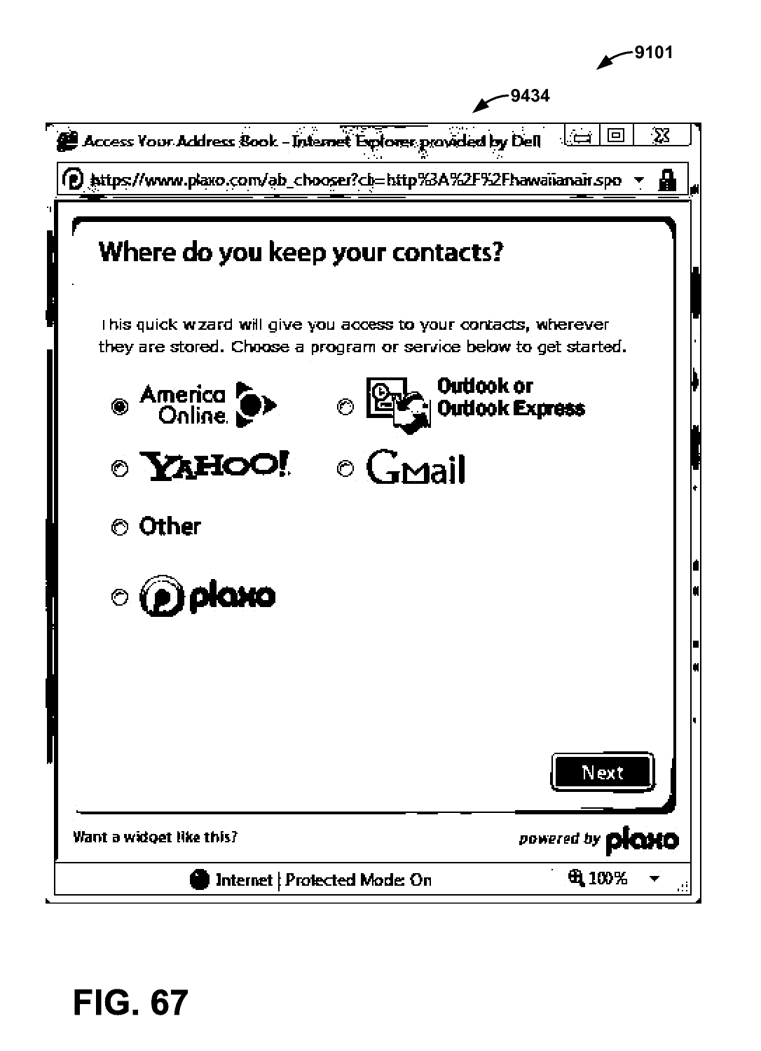

FIG. 65 shows an exemplary screenshot view, illustrating a member database content screen, according to the preferred embodiment of FIG. 59.

As members of social network 9130, users 9150 agree to permit interested party website 9110 access to membership information. Such membership information, as shown, preferably comprises email addresses 9420, phone numbers 9422, names 9424, birth dates 9426, gender 9428, and location information 9430. Since FIG. 65 is a screenshot containing information from the user database of integrated matchmaker system 9101, to protect privacy and prevent use of identifying information, applicant has intentionally obscured some of the data shown in FIG. 65. This arrangement at least herein embodies wherein such step of permitting administration comprises accessing user-data of the users associated with such at least one specific social network website; and this arrangement at least herein embodies wherein such administrator computer interface means comprises user-data accessor computer interface means for accessing user-data of the users associated with such at least one specific social network website.

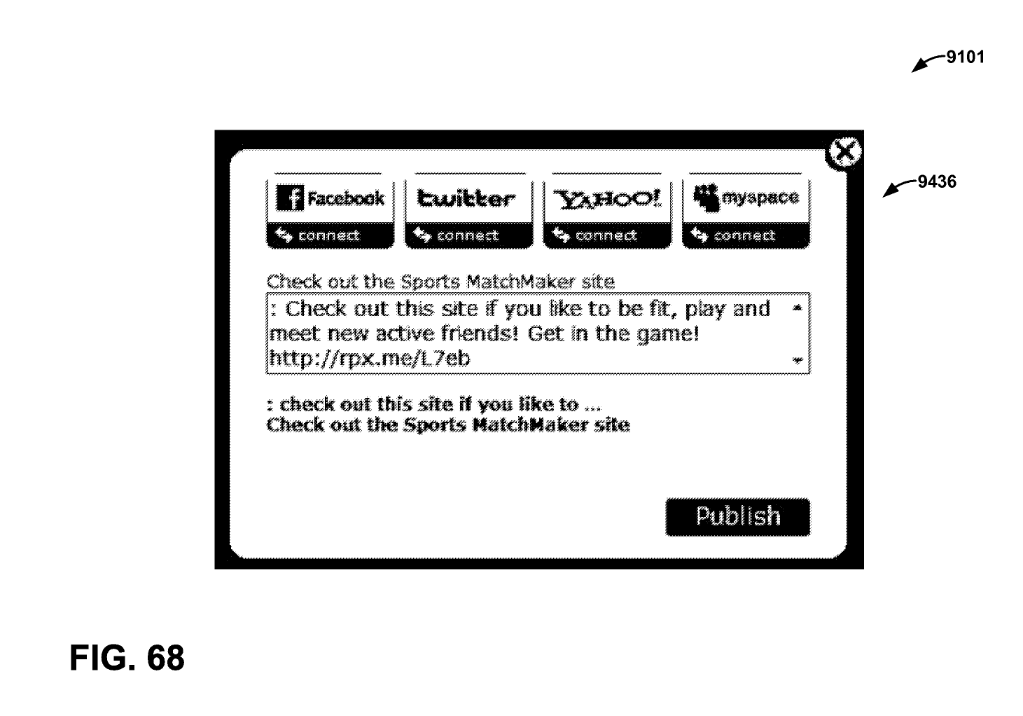

FIG. 66, FIG. 67, and FIG. 68 show exemplary screenshot views, illustrating user referral screens, according to the preferred embodiment of FIG. 59.

FIG. 66 illustrates at least one email entry 9432 to send out invitations 9170. FIG. 67 illustrates a contacts list import interface 9434 to send out invitations 9170. FIG. 68 illustrates a social network sharing interface 9436 to post invitations 9170. As discussed previously, invitations 9170 preferably are linked to the specific social network 9130 that user 9150 sending the invitation 9170 is a member of.

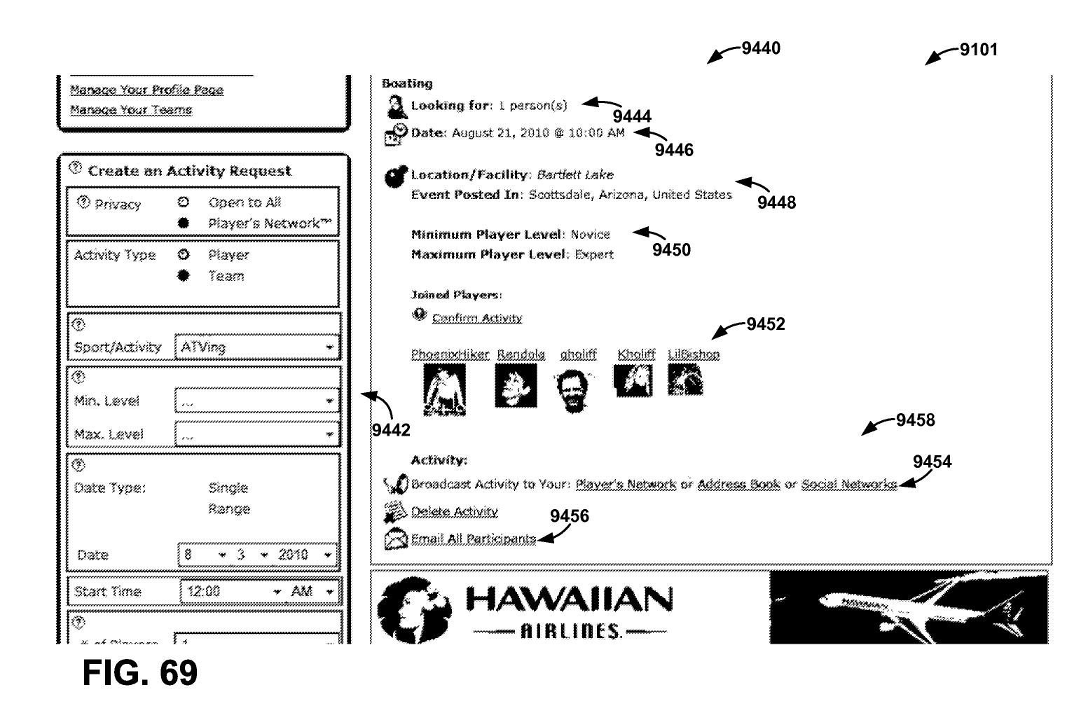

FIG. 69 shows an exemplary screenshot view, illustrating an activity request screen 9440, according to the preferred embodiment of FIG. 59.

Activity request screen 9440 is illustrated from the view of user 9150 who made the activity request. Activity request screen 9440 illustrates a posting for an activity or event in matchmaker computer system 101. Such posting indicates participants sought 9444 (particularly the number of participants, date(s) 9446 of the activity, location 9448, and requested participant skill levels 9450, as shown. Additionally, activity request screen 9440 preferably provides an interface to display and confirm join requests 9452, as shown.

Activity request screen 9440 further provides communication tools 9458, as shown. Communication tools 9458 preferably comprise broadcasting tools 9454 and participant email tools 9456, as shown. Broadcasting tools 9454 preferably permit user 9150 to broadcast invitations 9170, preferably through email, alternately preferably through other social networks, alternately preferably through Player's Networks (internal to social network 9130 and global social network 9120). Participant email tools 9456 preferably permits user 9150 to email all participants of activity. Upon reading the teachings of this specification, those skilled in the art will now appreciate that, under appropriate circumstances, considering such issues as future technologies, cost, etc., other communication methods, such as, for example, instant messaging, text messaging, voice messaging, etc., may suffice.

Additionally, activity request screen 9440 preferably comprises at least one new activity request interface 9442, as shown. New activity request interface 9442 permits entry of information to create a new activity request, as shown. Such information preferably comprises dates, times, types, skill levels, privacy, participant numbers, etc., as disclosed with matchmaker computer system 101.

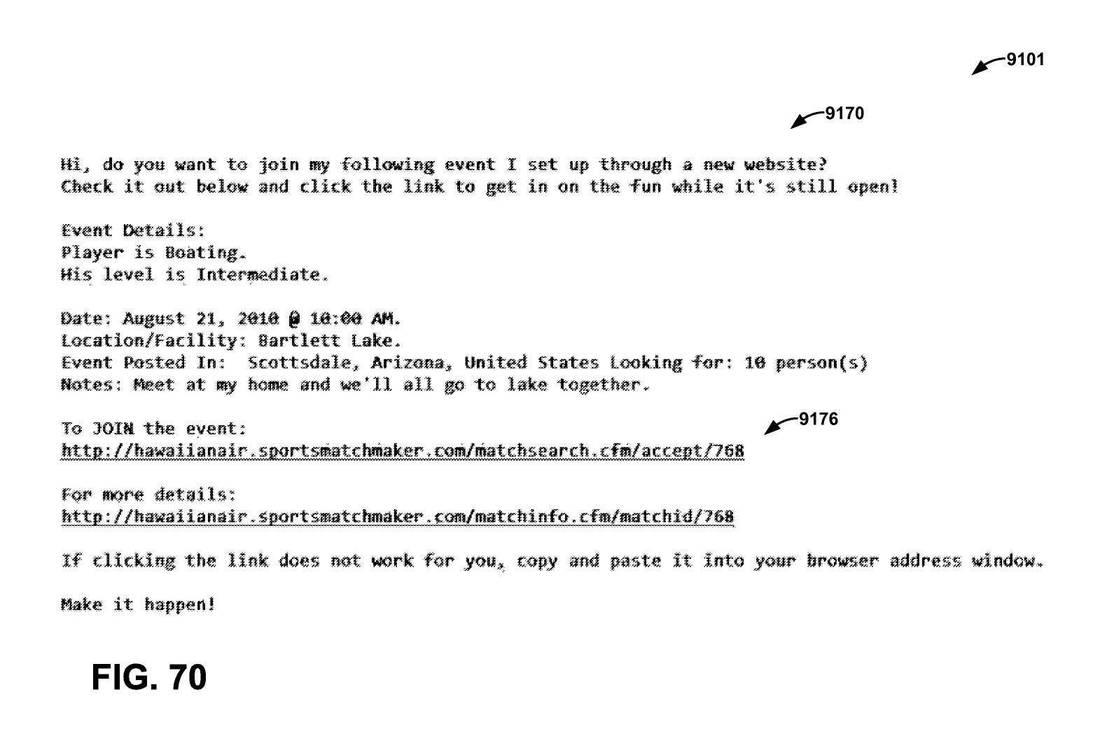

FIG. 70 shows an exemplary screenshot view, illustrating an activity invitation, according to the preferred embodiment of FIG. 59. Invitation 9170 preferably comprises at least one URL link, preferably at least one trackable URL link 9176, as shown. Trackable URL link 9176 preferably directs recipient to the specific social network 9130 from which invitation 9170 was sent.

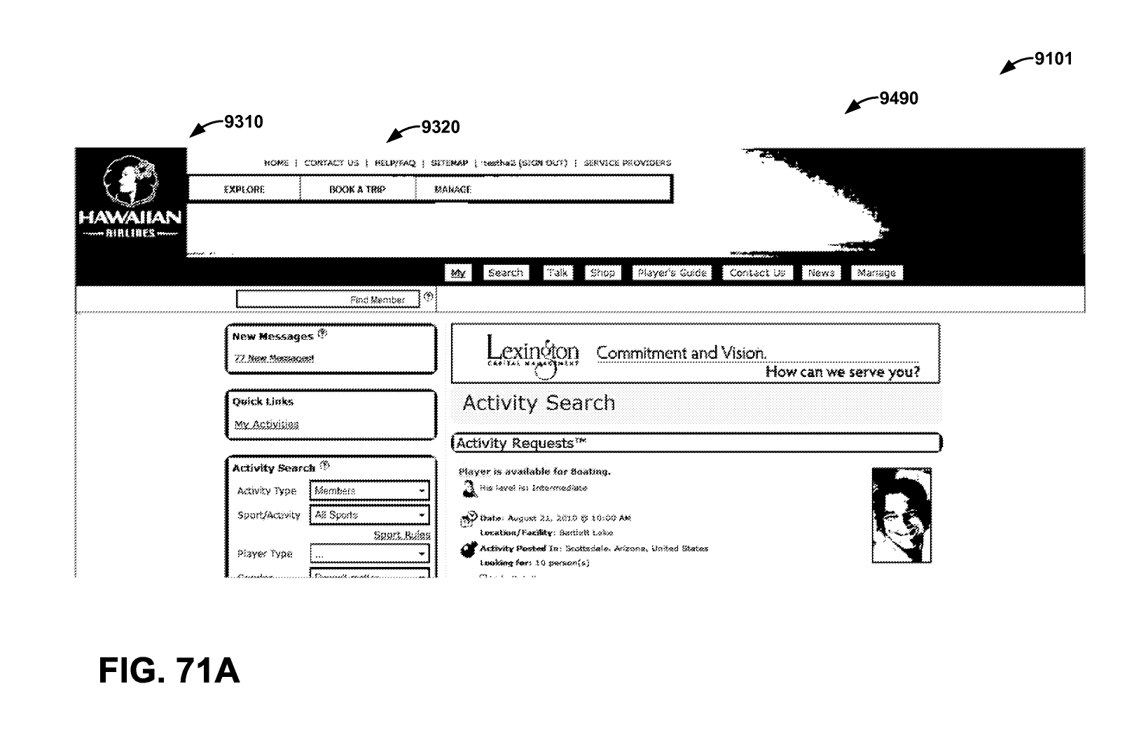

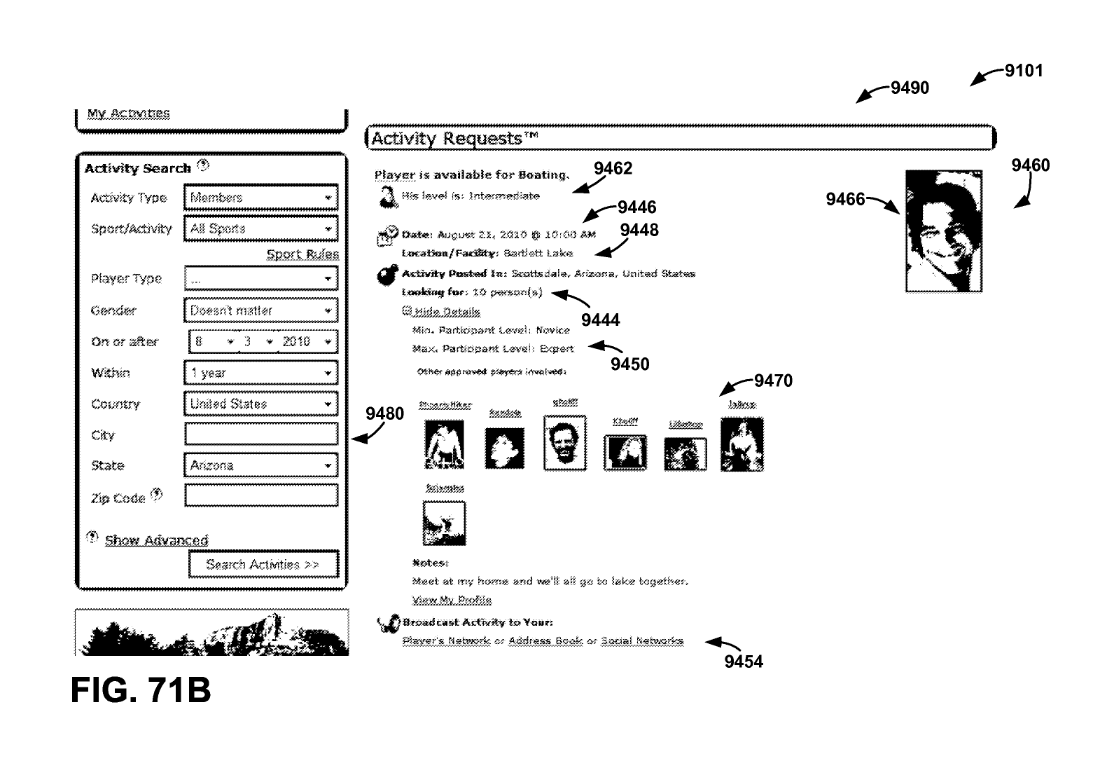

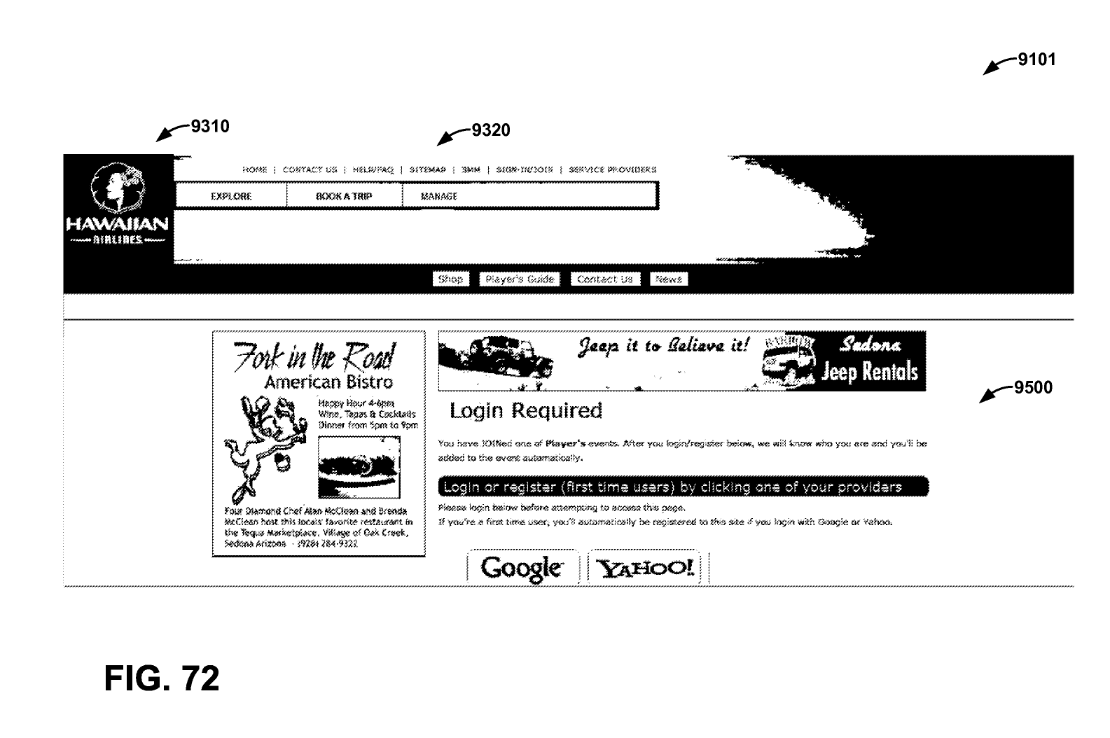

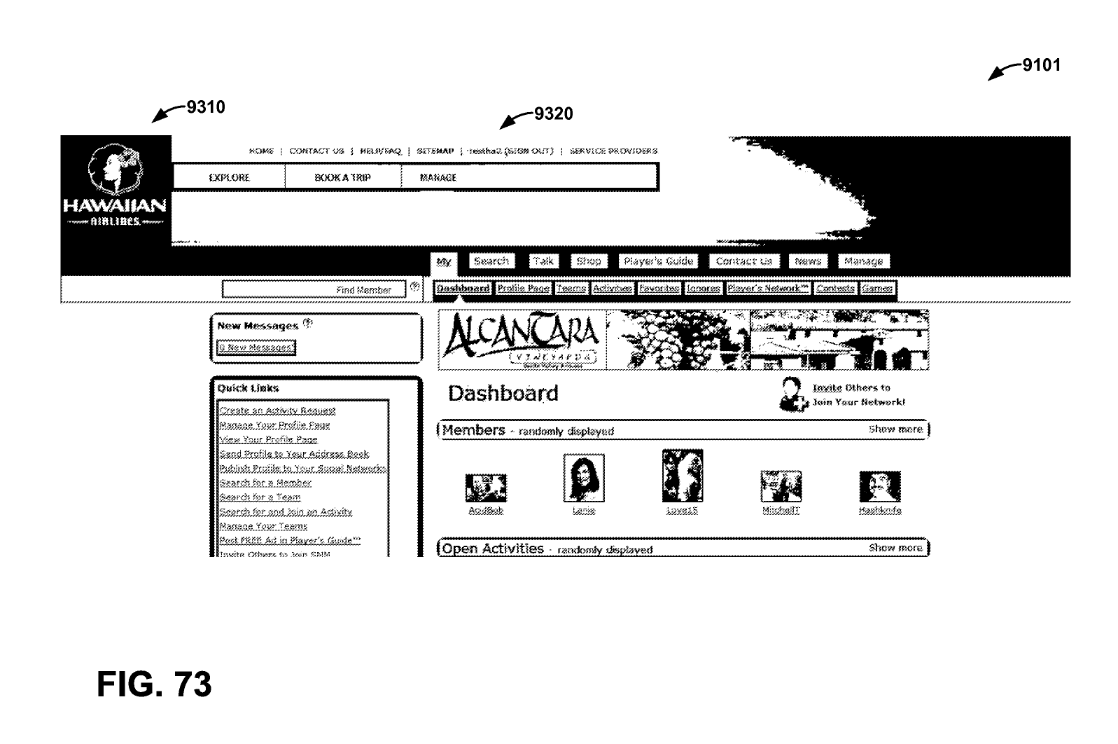

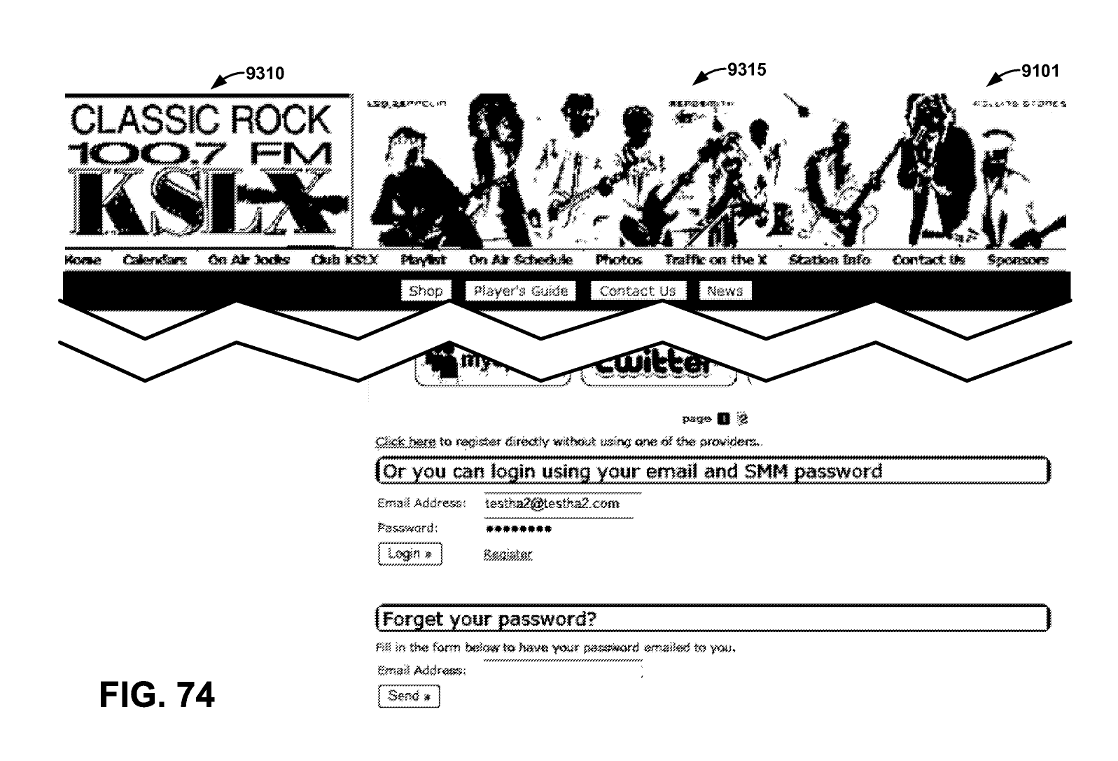

FIG. 71A and FIG. 71B show exemplary screenshot views, illustrating an activity detail screen 9490, according to the preferred embodiment of FIG. 59.

As with all pages in integrated matchmaker system 9101, activity detail screen 9490 preferably comprises private label 9140 (logo graphic 9310 and navigator 9320 as shown in FIG. 71A). Activity detail screen 9490 is representative of the view of user 9150 who did not post the shown activity request.

FIG. 71B best shows details of activity detail screen 9490. Activity detail screen 9490 preferably comprises at least one activity search interface 9480, as shown, preferably to provide user 9150 a tool to conduct match search 305. Activity detail area 9460 preferably shows details of a specific activity request, as shown. Each activity request comprises type of activity 9462, participants sought 9444, date(s) 9446 of the activity, location 9448, broadcasting tools 9454, and requested participant skill levels 9450, as shown. In addition, activity detail screen 9490 associates the posting user to such activity request, preferably via at least one profile link 9466, as shown. Moreover, activity detail screen 9490 preferably comprises at least one profile link for each participating user, preferably in at least one participant display 9470, as shown. By linking profiles of each participating user (including posting user), user 9150, who is searching for an activity, may examine all participants prior to requesting to join the activity.

FIG. 72, FIG. 73 and FIG. 74 show exemplary screenshot views, illustrating referral handling, according to the preferred embodiment of FIG. 59.

When a user clicks on a link in invitation 9170, a login request screen 9500 is preferably presented to such user, as shown. Login request screen 9500 (at least embodying herein at least one user-authentication computer interface structured and arranged to permit user-authentication from each of such plurality of the at least one social network websites, by any of the users, to such at least one specific social network website; and at least embodying herein user-authentication computer interface means for permitting user-authentication from each of such plurality of the at least one social network websites, by any of the users, to such at least one specific social network website) preferably bears private label 9140 (i.e. logo graphic 9310 and navigator 9320) as appropriate to the specific social network 9130 of user 9150 who sent invitation 9170, as shown in FIG. 72. If the accepting user is either a member of the same specific social network 9130 or a new member, once authenticated, the accepting user will be presented with a screen similar to FIG. 73 showing the same integration elements as the login screen.

When the accepting user is not yet a member of any social network 9130 a registration screen, similar to that described at least in FIG. 8, additionally comprising private label 9140 of the specific social network 9130 of user 9150 who sent invitation 9170 will be presented to allow the accepting user to register (this arrangement at least embodying herein at least one user registration computer interface structured and arranged to permit registration of the users through each of such plurality of the at least one social network websites; and this arrangement at least embodying herein user registration computer interface means for permitting registration of the users through each of such plurality of the at least one social network websites; and at least embodying herein permitting registration of the users through each of such plurality of the at least one social network websites). Upon the registration of the accepting user, central server 9102 preferably associates the new user with the specific social network 9130 (of user 9150 who sent invitation 9170), since that is the specific social network 9130 through which the new user registered.

With regard to FIG. 74, if a user logs in, either directly or through an invitation, on social network 9130 to which they do not belong, as shown, integrated matchmaker system 9101 will preferably redirect the now authenticated user to the specific social network 9130 to which they are now a member. Central server 9102 preferably processes authentication of user 9150 and preferably directs user 9150 to the specific social network 9130 (this arrangement at least embodying herein at least one user redirector computer processor structured and arranged to redirect the users from any of such plurality of the at least one social network websites to such at least one specific social network website; and this arrangement at least embodying herein user redirector computer processor means for redirecting the users from any of such plurality of the at least one social network websites to such at least one specific social network website; and at least embodying herein redirecting the users from any of such plurality of the at least one social network websites to such at least one specific social network website). Therefore, in use, a user logging in on the specific social network 9130 depicted in FIG. 74, if they are a member of the specific social network depicted in FIG. 72 and FIG. 73, they will be redirected to a screen similar to FIG. 73 in the specific social network 9130 where they are a member. This arrangement at least herein embodies wherein each of the users, upon authentication, is automatically directed to such at least one specific social network website, with which each of the users is respectively associated, regardless of which of such plurality of the at least one social network websites the users authenticated through; and this arrangement at least embodies herein permitting user-authentication from each of such plurality of the at least one social network websites, by any of the users. Upon reading the teachings of this specification, those skilled in the art will now appreciate that, under appropriate circumstances, considering such issues as future technologies, cost, etc., other redirecting systems, such as, for example, user selected redirection, regional redirection systems, language redirection systems, etc., may suffice.

To assist understanding of the preferred embodiments of FIG. 59 through FIG. 74 the following analogy is presented.

Integrated matchmaker system 9101 is like one big swimming pool with an unlimited number of doors leading into the pool. The doors (portals) are plug-in clients (social networks 9130). There is, therefore, no one centralized door, such as in facebook.com. A tracking system tracks everyone who enters the pool via a specific door and all the people they invite into the pool are directed into the pool through the same door they joined through, ad infinitum. Once inside the pool, all people, regardless what door they entered through, can swim and play together. As an option, each specific door owner can “wall off” a section of the pool, so only people who enter the pool through his/her/its door can see, swim and play together; this system is called “Private Social Networks” and is, in essence, miniature “centralized” (must enter through one door) social networks (miniature Facebooks).

Each specific door owner is building a virally growing network as member/users create events, invite others to join the events, and all who JOIN are directed through each specific door owner's door resulting in user-generated marketing. Each door owner pays for the right to have a door into the pool, which affords him a virally growing network, due to the tracking technology. Each person that enters through the door owner's door is automatically included into the door owner's network of users, and vice versa. Additionally, each door owner may count and interact with the people entering the owner's door.

Each door owner is also given an interface to upload rotating banner ads on the top banner position on every page of his social network 9130, and keeps 100% of that ad revenue, offsetting the fee for having a door. The ad system displays targeted ads on the door owner's network pages. For example, users who registered through a golf club's plug-in, will see more golf related ads when they are using social network 9130.

Integrated matchmaker system 9101 also allows one network member (joined through plug-in A) to switch his/her membership to another network (plug-in B), to take advantage of any deals offered by plug-in B owner (e.g. “our members get a 20% discount on greens fees”). Integrated matchmaker system 9101 does not mandate that the plug-in is linked with an existing website (no link to the plug-in from “Entity A” website is necessary). Entity A can still use its private-labeled service (it resides on central server 9102, accessed by a link) to create its events and broadcast them, and all who join are directed to the private-labeled service provided to Entity A. Entity A's navigation menu can still be at the top, so users can click into Entity A's website, but no link back need be found on Entity A's website.

Although applicant has described applicant's preferred embodiments of this invention, it will be understood that the broadest scope of this invention includes modifications. Such scope is limited only by the below claims as read in connection with the above specification.

Further, many other advantages of applicant's invention will be apparent to those skilled in the art from the above descriptions and the below claims.

What is claimed is:

1) A computer system, relating to integrating at least one social-network website-service into at least one website providing at least one social network website as a portion of the at least one website permitting social interactions between users of the at least one website, comprising:
a) at least one central social-network computer server structured and arranged to serve, by at least one computer, the at least one social-network website-service to the at least one website;
b) at least one service integrator computer processor structured and arranged to integrate the at least one social-network website-service into the at least one website as the at least one social network website; and
c) at least one cross social-network interaction computer interface structured and arranged to interface social-interactions between users across a plurality of the at least one social network websites of a plurality of the at least one websites;
d) wherein, when integrated, the at least one website comprises the at least one social network website permitting such social interactions between the users at the at least one website.

2) The computer system, according to claim 1, wherein said at least one service integrator computer processor comprises at least one website-theme matcher structured and arranged to match at least one website-theme of the at least one social network website to at least one website-theme of the at least one website.

3) The computer system, according to claim 1, further comprising at least one user-to-network associator computer processor structured and arranged to associate each of the users with at least one specific social network website of such plurality of the at least one social network websites.

4) The computer system, according to claim 3, further comprising at least one user-authentication computer interface structured and arranged to permit user-authentication from each of such plurality of the at least one social network websites, by any of the users, to such at least one specific social network website.

5) The computer system, according to claim 4, further comprising:
a) at least one user redirector computer processor structured and arranged to redirect the users from any of such plurality of the at least one social network websites to such at least one specific social network website;
b) wherein each of the users, upon authentication, is automatically directed to such at least one specific social network website, with which each of the users is respectively associated, regardless of which of such plurality of the at least one social network websites the users authenticated through.

6) The computer system, according to claim 5, further comprising:
a) at least one user registration computer interface structured and arranged to permit registration of the users through each of such plurality of the at least one social network websites;
b) wherein said user-to-network associator computer processor associates the users to such at least one specific social network website through which the users register.

7) The computer system, according to claim 3, further comprising:
a) at least one administrator computer interface structured and arranged to permit administration of such at least one specific social network website;
b) wherein said at least one administrator computer interface comprises at least one user-data accessor computer interface structured and arranged to access user-data of the users associated with such at least one specific social network website.

8) A computer system, relating to integrating at least one social-network website-service into at least one website providing at least one social network website as a portion of the at least one website permitting social interactions between users of the at least one website, comprising:
a) central social-network computer server means for serving, by at least one computer, the at least one social-network website-service to the at least one website;
b) service integrator computer processor means for integrating the at least one social-network website-service into the at least one website as the at least one social network website; and
c) cross social-network interaction computer interface means for interfacing social-interaction between users across a plurality of the at least one social network websites of a plurality of the at least one websites;
d) wherein, when integrated, the at least one website comprises the at least one social network website permitting social interactions between the users at the at least one website.

9) The computer system, according to claim 8, wherein said service integrator computer processor means comprises website-theme matcher means for matching at least one website-theme of the at least one social network website to at least one website-theme of the at least one website.

10) The computer system, according to claim 8, further comprising user-to-network associator computer processor means for associating each of the users with at least one specific social network website of such plurality of the at least one social network websites.

11) The computer system, according to claim 10, further comprising user-authentication computer interface means for permitting user-authentication from each of such plurality of the at least one social network websites, by any of the users, to such at least one specific social network website.

12) The computer system, according to claim 11, further comprising:
a) user redirector computer processor means for redirecting the users from any of such plurality of the at least one social network websites to such at least one specific social network website;
b) wherein each of the users, upon authentication, is automatically directed to such at least one specific social network website, with which each of the users is respectively associated, regardless of which of such plurality of the at least one social network websites the users authenticated through.

13) The computer system, according to claim 12, further comprising:
a) user registration computer interface means for permitting registration of the users through each of such plurality of the at least one social network websites;
b) wherein said user-to-network associator computer processor means associates the users to such at least one specific social network website through which the users register.

14) The computer system according to claim 10 further comprising:
a) administrator computer interface means for permitting administration of such at least one specific social network website;
b) wherein said administrator computer interface means comprises user-data accessor computer interface means for accessing user-data of the users associated with such at least one specific social network website.

15) A computer method, relating to integrating at least one social-network website-service into at least one website providing at least one social network website as a portion of the at least one website permitting social interactions between users of the at least one website, comprising:
a) serving, by at least one computer, the at least one social-network website-service to the at least one website;
b) integrating the at least one social-network website-service into the at least one website as the at least one social network website; and
c) interfacing social-interaction between users across a plurality of the at least one social network websites of a plurality of the at least one websites;
d) wherein, when integrated, the at least one website comprises the at least one social network website permitting social interactions between the users at the at least one website.

16) The computer method, according to claim 15, wherein said step of integrating comprises matching at least one website-theme of the at least one social network website to at least one website-theme of the at least one website.

17) The computer method, according to claim 15, further comprising the step of associating each of the users with at least one specific social network website of such plurality of the at least one social network websites.

18) The computer method, according to claim 17, further comprising the step of permitting user-authentication from each of such plurality of the at least one social network websites, by any of the users.

19) The computer method, according to claim 18, further comprising the step of:
a) redirecting the users from any of such plurality of the at least one social network websites to such at least one specific social network website;
b) wherein each of the users, upon authentication, is automatically directed to such at least one specific social network website, with which each of the users is respectively associated, regardless of which of such plurality of the at least one social network websites the users authenticated through.

20) The computer method, according to claim 19, further comprising the step of:
a) permitting registration of the users through each of such plurality of the at least one social network websites;
b) wherein said step of associating associates the users to such at least one specific social network website through which the users register.
